(19) United States
(12) Patent Application Publication
(10) Pub. No.: US 2008/0165661 A1
(43) Pub. Date: Jul. 10, 2008

(54) OPTICAL DISC APPARATUS, OPTICAL DISC DETERMINATION METHOD, PROGRAM, AND INTEGRATED CIRCUIT

(76) Inventors: Tooru MARUYAMA, Osaka (JP); Kenji FUJIUNE, Osaka (JP); Motoshi ITO, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/968,746

(22) Filed: Jan. 3, 2008

Related U.S. Application Data
(60) Provisional application No. 60/878,384, filed on Jan. 4, 2007.

(30) Foreign Application Priority Data
Nov. 6, 2007 (JP) 2007-288143

(51) Int. Cl. G11B 7/00

(52) U.S. Cl. 369/112.23

(57) ABSTRACT

An optical disc drive apparatus determines which one of a plurality of discs with different specifications has been mounted on the apparatus in a short time as well as in a safe manner without damaging information recorded on the disc. An optical disc apparatus 100 illuminates an optical disc 1 simultaneously with a first laser beam and a second laser beam that have been mixed by a laser beam mixing and separating unit. The second laser beam has a shorter wavelength than the first laser beam. An objective lens 29 focuses the first laser beam and the second laser beam in a manner that the first laser beam has a greater focal length than the second laser beam. An information recording surface of the optical disc 1 is first illuminated with the first laser beam having a long wavelength. This eliminates the risk of damaging the information recording surface of the optical disc 1.

### BACKGROUND OF THE INVENTION

1. Field of the Invention

The present invention relates to an optical disc apparatus for consumer use.

2. Description of the Related Art

An apparatus designed to record and reproduce on a plurality of discs including a CD (compact disc) and a DVD (digital versatile disc), for which lasers with different wavelengths are used, is required to determine the type of a disc that has been mounted on the apparatus.

An infrared laser beam having a wavelength of about 780 nm is used to record and reproduce on a CD, whereas a red laser beam having a wavelength of about 650 nm is used to record and reproduce on a DVD. If a CD is illuminated with the laser beam to be used for a DVD, which has a shorter wavelength than the laser beam to be used for a CD, the laser beam will be absorbed in a recording layer of the CD and damage information recorded on the CD.

To prevent the above problem, a conventional apparatus for example first illuminates a disc mounted on the apparatus with an infrared laser beam having the longest wavelength and determines whether the disc is a CD while executing neither focus control nor tracking control, and when determining that the disc is not a CD, the apparatus next illuminates the disc with a red laser beam having a shorter wavelength and determines whether the disc is a DVD while executing neither focus control nor tracking control. The conventional apparatus determines the type of the disc in this manner to prevent recorded information from being damaged by a short-wavelength laser beam (see for example Patent Document 1).

The operation of the conventional optical disc apparatus will now be described with reference to FIGS. 21 to 23.

FIG. 21 is a block diagram showing the structure for the conventional disc determination.

An optical head 1610 is mainly made of an infrared-laser beam source 11, an infrared-laser beam splitter 13, an infrared-laser front light monitor 15, a red-laser beam source 12, a red-laser beam splitter 14, a red-laser front light monitor 16, an illumination beam splitter 20, an objective lens 29, a focus actuator 34, a detector beam splitter 21, an infrared-laser beam detector 23, and a red-laser beam detector 24.

The infrared-laser beam source 11 emits an infrared laser beam having a wavelength of about 780 nm. The infrared-laser beam splitter 13 splits the infrared laser beam toward the illumination beam splitter 20 and the infrared-laser front light monitor 15. The infrared-laser front light monitor 15 detects the output power of the infrared laser beam that has entered the infrared-laser front light monitor 15.

The red-laser beam source 12 emits a red laser beam having a wavelength of about 650 nm. The red-laser beam splitter 14 splits the red laser beam toward the illumination beam splitter 20 and the red-laser front light monitor 16. The red-laser front light monitor 16 detects the output power of the red laser beam that has entered the red-laser front light monitor 16.

The red laser beam and the infrared laser beam that have been split toward the illumination beam splitter 20 are reflected by the illumination beam splitter 20 in the direction of the objective lens 29. The beams are then focused by the objective lens 29 onto an information recording surface of the optical disc 1. The red laser beam and the infrared laser beam are reflected by the optical disc 1, and the reflected beams pass through the illumination beam splitter 20. The red laser beam and the infrared laser beam then pass through the detector beam splitter 21. Through the detector beam splitter 21, the red laser beam enters the red-laser beam detector 24, whereas the infrared laser beam enters the infrared-laser beam detector 23.

The laser controller (laser control unit) 53 outputs, to an LDD (laser diode driver) 40, a reproduction-illumination drive signal that causes the output level of the red laser beam detected by the red-laser front light monitor 16 and the output level of the infrared laser beam detected by the infrared-laser front light monitor 15 to be a predetermined output level for reproduction laser beams. In other words, the output level of the red laser beam and the output level of the infrared laser beam are controlled to be the predetermined output level for reproduction laser beams based on the reproduction-illumination drive signal, which is output from the laser controller (laser control unit) 53.

The LDD 40 is mainly made of a reproduction-illumination drive signal gain amplifier 42 and an illumination laser selector SW41.

The reproduction-illumination drive signal gain amplifier 42 amplifies a reproduction-illumination drive signal. The LDD 40 outputs a signal for laser driving, which is the signal amplified by the reproduction-illumination drive signal gain amplifier 42, to the infrared-laser beam source 11 or to the red-laser beam source 12.

A disc determination controller (disc determination unit) 50 outputs a switch control signal, which is used by the LDD 40 to determine whether to output the laser driving signal to the infrared-laser beam source 11 or to the red-laser beam source 12. The illumination laser selector SW41 of the LDD 40 outputs the laser driving signal, which is output from the reproduction-illumination drive signal gain amplifier 42, to the infrared-laser beam source 11 or to the red-laser beam source 12 based on the switch control signal, which is output from the disc determination unit 50. More specifically, the output destination of the laser driving signal, which is output from the reproduction-illumination drive signal gain amplifier 42, is switched between the infrared-laser beam source 11 and the red-laser beam source 12 based on the switch control signal, which is output from the disc determination unit 50.

The disc determination controller (disc determination unit) 50 further outputs a drive signal for driving the objective lens 29 up and down. The expression of “driving up and down” herein refers to driving the objective lens 29 in a direction in which that the distance between the objective lens 29 and the optical disc 1 decreases or increases when the optical axis direction of the objective lens 29 and the direction of the normal to the information recording surface of the optical disc 1 substantially coincide with each other. This expression should not be particularly limited to such driving that causes the “up and down” movement of the objective lens 29. The same applies to the same expression used throughout this specification.

A servo signal generation circuit (servo signal generation unit) 56 generates a servo signal based on the output of the infrared-laser beam detector 23 or the red-laser beam detector 24 and outputs the generated servo signal. The disc determination controller (disc determination unit) 50 determines the type of the disc that has been mounted on an optical disc apparatus 900 based on the servo signal, which is generated by the servo signal generation circuit (servo signal generation unit) 56.

A disc determination process for determining that a CD has been mounted will now be described with reference to FIG. 22.

FIG. 22 shows the position of the objective lens 29 and the state of a focus error signal when the objective lens 29 is driven while a CD is being illuminated with an infrared laser beam.

In FIG. 22, line (1) shows the position of the objective lens 29 as a function of time, where the horizontal axis indicates time and the vertical axis indicates the objective lens position. More specifically, line (1) in FIG. 22 represents signals showing the position of the objective lens 29 when the objective lens 29 is moved toward the CD while the CD is being illuminated with an infrared laser beam.

In FIG. 22, line (2) shows the level of a focus error signal as a function of time, where the horizontal axis indicates time and the vertical axis indicates the focus error signal level. More specifically, line (2) in FIG. 22 represents focus error signals, which are generated by the servo signal generation circuit (servo signal generation unit) 56 based on the output of the infrared-laser beam detector 23 when the objective lens 29 is moved toward the CD while the CD is being illuminated with an infrared laser beam.

At timing T37 to start disc determination, the disc determination controller (disc determination unit) 50 starts its disc determination operation. To prevent information recorded on an information recording surface of a CD from being damaged by a red laser beam, the disc determination controller (disc determination unit) 50 first controls the LDD 40 to output a laser driving to the infrared-laser beam source 11 by switching the illumination laser selector SW41 of the LDD 40 so that the disc is first illuminated with an infrared laser beam. Further, the disc determination controller (disc determination unit) 50 drives the focus actuator 34 to raise the objective lens 29. More specifically, the focus actuator 34 is driven to raise the objective lens 29 (to reduce the distance between the objective lens and the optical disc 1) based on a control signal output from the disc determination controller (disc determination unit) 50.

At timing T38, the focal point of the infrared laser beam passes through a surface of the CD (surface of the CD facing the objective lens 29). When the beam passes through the surface, a focus error signal is obtained based on a signal output from the infrared-laser beam detector 23. More specifically, a focus error signal having a waveform indicated by W221 in FIG. 22 is output at around timing T38.

At timing T39, the focal point of the infrared laser beam passes through an information recording surface of the CD (surface on which information is recorded). When the beam passes through the surface, a focus error signal is obtained based on a signal output from the infrared-laser beam detector 23. More specifically, a focus error signal having a waveform indicated by W222 in FIG. 22 is output at around timing T39. When the amplitude of this focus error signal exceeds a predetermined level L11, the disc determination controller (disc determination unit) 50 determines that the disc that has been mounted on the optical disc apparatus 900 is a CD.

When determining that the disc mounted is a CD, the disc determination controller (disc determination unit) 50 ends the disc determination operation.

A disc determination process for determining that a DVD has been mounted will now be described with reference to FIG. 23.

FIG. 23 shows the position of the objective lens 29 and the output state of a focus error signal when the objective lens 29 is driven while a DVD is being illuminated with an infrared laser beam, and also shows the position of the objective lens 29 and the output state of a focus error signal when the objective lens 29 is driven while the DVD is being illuminated with a red laser beam.

In FIG. 23, line (1) shows the position of the objective lens 29 as a function of time, where the horizontal axis indicates time and the vertical axis indicates the objective lens position. More specifically, line (1) in FIG. 23 represents signals showing the position of the objective lens 29 (position signals at and before timing T43) when the objective lens 29 is moved toward the DVD while the DVD is being illuminated with an infrared laser beam, and signals showing the position of the objective lens 29 (position signals after timing T43) when the objective lens 29 is moved toward the DVD while the DVD is being illuminated with a red laser beam.

In FIG. 23, line (2) shows the level of a focus error signal as a function of time, where the horizontal axis indicates time and the vertical axis indicates the focus error signal level. More specifically, line (2) in FIG. 23 represents focus error signals, which are generated by the servo signal generation circuit (servo signal generation unit) 56 based on the output of the infrared-laser beam detector 23 when the objective lens 29 is moved toward the DVD while the DVD is being illuminated with an infrared laser beam.

In FIG. 23, line (3) shows the level of a focus error signal as a function of time, where the horizontal axis indicates time and the vertical axis indicates the focus error signal level. More specifically, line (3) in FIG. 23 represents focus error signals, which are generated by the servo signal generation circuit (servo signal generation unit) 56 based on the output of the red-laser beam detector 24 when the objective lens 29 is moved toward the DVD while the DVD is being illuminated with a red laser beam.

In FIG. 23, line (4) indicates either the infrared laser beam or the red laser beam that is illuminating the DVD, as a function of time.

At timing T40 to start disc determination, the disc determination controller (disc determination unit) 50 starts its disc determination operation. To prevent information recorded on an information recording surface of a CD from being damaged by a red laser beam, the disc determination controller (disc determination unit) 50 first controls the LDD 40 to output a laser driving signal to the infrared-laser beam source 11 by switching the illumination laser selector SW41 of the LDD 40 so that the disc is first illuminated with an infrared laser beam from the infrared-laser beam source. Further, the disc determination controller (disc determination unit) 50 provides the focus actuator 34 with a drive signal to raise the objective lens 29 (move the objective lens 29 in a direction in which the distance between the objective lens 29 and the optical disc 1 decreases).

At timing T41, the focal point of the infrared laser beam passes through a surface of the DVD (surface of the DVD facing the objective lens 29). When the beam passes through the surface, a focus error signal is obtained based on a signal output from the infrared-laser beam detector 23. More specifically, a focus error signal having a waveform indicated by W231 in FIG. 23 is output at around timing T41.

At timing T42, the focal point of the infrared laser beam passes through an information recording surface of the DVD (surface on which information is recorded). When the beam passes through the surface, a focus error signal is obtained based on a signal output from the infrared-laser beam detector 23. More specifically, a focus error signal having a waveform indicated by W232 in FIG. 23 is output at around timing T42. The amplitude of this focus error signal does not exceed the predetermined level L11. Thus, the disc determination controller (disc determination unit) 50 continues the disc determination operation.

The disc determination controller (disc determination unit) 50 continues raising the objective lens 29 (continues moving the objective lens 29 in the direction in which the distance between the objective lens 29 and the optical disc 1 decreases). At timing T43, the objective lens 29 reaches its preset positional limit. The disc determination controller (disc determination unit) 50 stops raising the objective lens 29, and lowers the objective lens 29 (moves the objective lens 29 in a direction in which the distance between the objective lens 29 and the optical disc 1 increases) until the objective lens 29 returns to its reset position (the position corresponding to timing T40 on line (1) in FIG. 23).

The disc determination controller (disc determination unit) 50 determines that the optical disc 1 that has been mounted on the optical disc apparatus 900 is not a CD. This determination result eliminates the possibility that information recorded on an information recording surface of a CD can be damaged by a red laser beam. The disc determination controller (disc determination unit) 50 next controls the LDD 40 to output a laser driving signal to the red-laser beam source 12 by switching the illumination laser selector SW41 of the LDD 40. As a result, the red-laser beam source 12 emits a red laser beam. The optical disc 1 mounted on the optical disc apparatus 900 has been determined to be an optical disc other than a CD. In this state, illuminating the optical disc 1 with a red laser beam will not damage information recorded on the optical disc 1. Further, the disc determination controller (disc determination unit) 50 provides the focus actuator 34 with a drive signal to raise the objective lens 29 (move the objective lens 29 in the direction in which the distance between the objective lens 29 and the optical disc 1 decreases).

At timing T44, the focal point of the red laser beam passes through the surface of the DVD (surface facing the objective lens 29). When the beam passes through the surface, a focus error signal is obtained based on a signal output from the red-laser beam detector 24. More specifically, a focus error signal having a waveform indicated by W233 in FIG. 23 is output at around timing T44.

At timing T45, the focal point of the red laser beam passes through an information recording surface of the DVD. When the beam passes through the surface, a focus error signal is obtained based on a signal output from the red-laser beam detector 24. More specifically, a focus error signal having a waveform indicated by W234 in FIG. 23 is output at around timing T45. When the amplitude of this focus error signal exceeds a predetermined level L12, the disc determination controller (disc determination unit) 50 determines that the disc that has been mounted on the optical disc apparatus 900 is a DVD.

When determining that the disc mounted is a DVD, the disc determination controller (disc determination unit) 50 ends the disc determination operation.

Patent Document 1: Japanese Unexamined Patent Publication No. H11-176073

However, this apparatus will require a longer time to determine the type of a disc if the apparatus is designed to record and reproduce on more types of discs and accordingly uses more lasers with different wavelengths (laser beams with different wavelengths).

For example, an apparatus may be designed to record and reproduce on a BD (blu-ray disc), an HD-DVD (high-definition DVD), a DVD, and a CD. This apparatus uses a blue laser beam having a wavelength of about 405 nm to record and reproduce on a BD and an HD-DVD. To prevent an information recording surface of an optical disc from being damaged, this apparatus illuminates the optical disc sequentially with one laser beam after another in the order of longer wavelengths of the laser beams. More specifically, the apparatus first illuminates the optical disc with an infrared laser beam and determines whether the optical disc is a CD. The apparatus next illuminates the optical disc with a red laser beam and determines whether the optical disc is a DVD. The apparatus finally illuminates the optical disc with a blue laser beam and determines whether the optical disc is a BD or an HD-DVD.

This apparatus performs the disc determination process as many as three times in the worst case before determining the type of the disc mounted on the apparatus. The apparatus requires a long time before starting to record or reproduce after the disc is mounted on the apparatus.

The present invention has been made to solve the problem described above. It is an object of the present invention to provide an optical disc apparatus that determines which one of a plurality of discs with different specifications has been mounted on the apparatus in a short time as well as in a safe manner without damaging information recorded on the disc.

An optical disc apparatus of the present invention includes an LDD that has a switch function for switching to use a recording illumination drive signal, which is used to cause recording laser illumination, to cause reproduction laser illumination and in which the gain with which the recording illumination drive signal is amplified has the resolution equivalent to the resolution of the gain with which a reproduction illumination drive signal is amplified.

Further, the apparatus freely selects the wavelength of a laser beam illuminating through the same objective lens.

Further, the apparatus uses three of more laser beams with different wavelengths illuminating through the same objective lens.

Further, the apparatus determines the type of each information recording surface of the disc instead of determining the type of the disc when the single disc has a plurality of information recording surfaces that are substantially identical to one another in the thickness of a substrate between the surface of the optical disc 1 and each information recording surface and that differ from one another in the corresponding laser wavelength.

Further, the apparatus sets the output of a laser (output level of a laser beam) at a low output (low output level).

Further, the apparatus superimposes a high-frequency element on a recording illumination drive signal when the recording illumination drive signal is used to cause reproduction illumination.

Further, the apparatus freely selects combinations of illumination drive signals and laser beam sources that are controlled based on the drive signals.

Further, the apparatus uses an objective lens that focuses a red laser beam and a blue laser beam in a manner that the red laser beam is focused at a more distant position in the direction of the normal to the objective lens (in the optical axis direction of the objective lens), and moves the objective lens toward the vicinity of a surface of the optical disc (surface of the optical disc facing the objective lens) in the disc determination operation.

Further, the apparatus uses an objective lens that focuses a red laser beam and a blue laser beam in a manner that the red laser beam is focused at a nearer position in the direction of the normal to the objective lens (in the optical axis direction of the objective lens), and moves the objective lens away from the vicinity of a surface of the optical disc (surface of the optical disc facing the objective lens) in the disc determination operation.

Further, the apparatus freely selects the wavelength of a laser beam illuminating through the same objective lens.

Further, the apparatus uses three or more laser beams with different wavelengths illuminating through the same objective lens.

Further, the apparatus determines the type of an information recording surface of the disc instead of determining the type of the disc.

Further, the apparatus sets the output of a laser (output level of a laser beam) at a low output (low output level).

Further, the apparatus superimposes a high-frequency element on a recording illumination drive signal when the recording illumination drive signal is used to cause reproduction illumination.

Further, the apparatus freely selects combinations of illumination drive signals and laser beam sources that are controlled based on the drive signals.

Further, the apparatus uses an objective lens that focuses a red laser beam and an objective lens that focuses a blue laser beam, and drives the two objective lenses with a drive difference that causes the red laser beam to be focused at a more distant position in the directions of the normals to the objective lenses (in the optical axis directions of the objective lenses).

Further, the apparatus freely selects the wavelength of a laser beam illuminating through each of the two objective lenses.

Further, the apparatus uses three or more laser beams with different wavelengths illuminating through the two objective lenses.

Further, the apparatus uses separate objective lenses that focus a red laser beam and a blue laser beam, and drives the objective lenses with a drive difference that causes the red laser beam to be focused at a nearer position in the directions of the normals to the objective lenses (in the optical axis directions of the objective lenses), and moves the objective lenses away from the vicinity of a surface of the optical disc (surface of the optical disc facing the objective lenses) in the disc determination operation.

Further, the apparatus determines the type of an information recording surface of the disc instead of determining the type of the disc.

Further, the apparatus sets the output of a laser (output level of a laser beam) at a low output (low output level).

Further, the apparatus superimposes a high-frequency element on a recording illumination drive signal when the recording illumination drive signal is used to cause reproduction illumination.

Further, the apparatus freely selects combinations of illumination drive signals and laser beam sources that are controlled based on the drive signals.

Further, the apparatus uses a low-NA (numerical aperture) objective lens that focuses an infrared laser beam at a more distant position than a red laser beam in the direction of the normal to the objective lens (in the optical axis direction of the objective lens), and first performs a determination process for determining whether the disc is a BD, a DVD, or a CD, and then performs a determination process for determining whether the disc is an HD-DVD.

Further, the apparatus uses a low-NA objective lens that focuses an infrared laser beam at a nearer position than a red laser beam in the direction of the normal to the objective lens (in the optical axis direction of the objective lens), and moves the low-NA objective lens away from the vicinity of a surface of the optical disc (surface of the optical disc facing the objective lens) in the disc determination process.

Further, the apparatus includes an LDD that can freely select combinations of illumination drive signals and laser beam sources that are controlled based on the drive signals.

Further, the apparatus determines the type of an information recording surface of the disc instead of determining the type of the disc.

Further, the apparatus sets the output of a laser (output level of a laser beam) at a low output (low output level).

Further, the apparatus superimposes a high-frequency element on a recording illumination drive signal when the recording illumination drive signal is used to cause reproduction illumination.

### SUMMARY OF THE INVENTION

A first aspect of the present invention provides an optical disc apparatus including a first laser beam source, a second laser beam source, a laser beam mixing and separating unit, an objective lens, an objective lens drive unit, a first laser beam detection unit, a second laser beam detection unit, a servo signal generation unit, and a disc determination unit.

The first laser beam source emits a first laser beam. The second laser beam source emits a second laser beam that has a shorter wavelength than the first laser beam. The laser beam mixing and separating unit mixes and separates the first laser beam and the second laser beam. The objective lens illuminates an optical disc simultaneously with the first laser beam and the second laser beam that have been mixed by the laser beam mixing and separating unit. The objective lens driving unit changes a distance between the objective lens and the optical disc by driving the objective lens toward and away from the optical disc. The first laser beam detection unit detects an intensity of the first laser beam that has been reflected from the optical disc. The second laser beam detection unit detects an intensity of the second laser beam that has been reflected from the optical disc. The servo signal generation unit generates a first laser beam detection signal corresponding to a result of detection of the first laser beam detection unit and a second laser beam detection signal corresponding to a result of detection of the second laser beam detection unit. The disc determination unit determines a type of the optical disc based on the first laser beam detection signal and the second laser beam detection signal.

This optical disc apparatus illuminates the optical disc simultaneously with the first laser beam and the second laser beam that have been mixed and separated by the laser beam mixing and separating unit, and promptly determines the type of a disc that has been mounted on the optical disc apparatus.

A second aspect of the present invention provides the optical disc apparatus of the first aspect of the present invention in which the objective lens focuses the first laser beam and the second laser beam in a manner that a focal length of the first laser beam is longer than a focal length of the second laser beam, and the objective lens is arranged at an initial position at which a distance between the objective lens and a surface of the optical disc facing the objective lens is longer than the focal length of the first laser beam in an initial state of an operation for determining the type of the optical disc. The objective lens drive unit drives the objective lens from the initial position in a direction in which the distance between the objective lens and the optical disc decreases. The disc determination unit determines the type of the optical disc by comparing a signal level of the first laser beam detection signal and a signal level of the second laser beam detection signal with a predetermined threshold while the objective lens is being driven by the objective lens drive unit from the initial position in the direction in which the distance between the objective lens and the optical disc decreases.

In this optical disc apparatus, the objective lens focuses the first laser beam and the second laser beam in a manner that the first laser beam has a greater focal length than the second laser beam. Thus, an information recording surface of the optical disc is first illuminated with the first laser beam having a long wavelength. This eliminates the risk of damaging the information recording surface of the optical disc. In other words, the information recording surface of the optical disc is not illuminated first with the second laser beam having a short wavelength (in other words having high energy). This eliminates the risk of damaging the information recording surface of the optical disc.

A third aspect of the present invention provides an optical disc apparatus that includes a first laser beam source, a second laser beam source, a first laser beam objective lens, a second laser beam objective lens, a first laser beam objective lens drive unit, a second laser beam objective lens drive unit, a first laser beam detection unit, a second laser beam detection unit, a servo signal generation unit, a disc determination unit, and a drive difference addition unit.

The first laser beam source emits a first laser beam. The second laser beam source emits a second laser beam that has a shorter wavelength than the first laser beam. The first laser beam objective lens illuminates an optical disc with the first laser beam. The second laser beam objective lens illuminates the optical disc with the second laser beam. The first laser beam objective lens drive unit changes a distance between the first laser beam objective lens and the optical disc by driving the first laser beam objective lens toward and away from the optical disc. The second laser beam objective lens drive unit changes a distance between the second laser beam objective lens and the optical disc by driving the second laser beam objective lens toward and away from the optical disc. The first laser beam detection unit detects an intensity of the first laser beam that has been reflected from the optical disc. The second laser beam detection unit detects an intensity of the second laser beam that has been reflected from the optical disc. The servo signal generation unit generates a first laser beam detection signal corresponding to a result of detection of the first laser beam detection unit and the second laser beam detection signal corresponding to a result of detection of the second laser beam detection unit. The disc determination unit outputs a second laser beam objective lens drive control signal for driving the second laser beam objective lens and determines a type of the optical disc based on the first laser beam detection signal and the second laser beam detection signal. The drive difference addition unit generates a first laser beam objective lens drive control signal for driving the first laser beam objective lens by adding an offset value to the second laser beam objective lens drive control signal.

The first laser beam objective lens drive unit drives the first laser beam objective lens based on the first laser beam objective lens drive control signal. The second laser beam objective lens drive unit drives the second laser beam objective lens based on the second laser beam objective lens drive control signal.

This optical disc apparatus has independent structures for illuminating the optical disc with the first laser beam and for illuminating the optical disc with the second laser beam, and can illuminate the optical disc simultaneously with the first laser beam and the second laser beam. Thus, the optical disc apparatus promptly determines the type of an optical disc that has been mounted on the optical disc apparatus. Further, this optical disc apparatus drives the first laser beam objective lens by the drive difference addition unit adding an offset value to the second laser beam objective lens drive control signal. Thus, the information recording surface of the optical disc is illuminated first with the first laser beam having a long wavelength (having low energy). This eliminates the risk of damaging the information recording surface of the optical disc.

A fourth aspect of the present invention provides the optical disc apparatus of the third aspect of the present invention in which the first laser beam objective lens is arranged at an initial position of the first laser beam objective lens at which a distance between the first laser beam objective lens and a surface of the optical disc facing the first laser beam objective lens is longer than a focal length with which the first laser beam objective lens focuses the first laser beam in an initial state of an operation for determining the type of the optical disc. The first laser beam objective lens drive unit drives the first laser beam objective lens from the initial position of the first laser beam objective lens in a direction in which the distance between the first laser beam objective lens and the optical disc decreases. The second laser beam objective lens drive unit drives the second laser beam objective lens from an initial position of the second laser beam objective lens in a direction in which the distance between the second laser beam objective lens and the optical disc decreases at a speed that is identical to a speed at which the first laser beam objective lens drive unit drives the first laser beam objective lens. The initial position of the second laser beam objective lens is a position of the second laser beam objective lens when the first laser beam objective lens is at the initial position of the first laser beam objective lens. The disc determination unit determines the type of the optical disc by comparing a signal level of the first laser beam detection signal and a signal level of the second laser beam detection signal with a predetermined threshold while the first laser beam objective lens and the second laser beam objective lens are being driven by the first laser beam objective lens drive unit and the second laser beam objective lens drive unit from the initial position of the first laser beam objective lens and the initial position of the second laser beam objective lens in a direction in which the distance between the first laser beam objective lens and the optical disc and the distance between the second laser beam objective lens and the optical disc decrease.

A fifth aspect of the present invention provides an optical disc apparatus including a first laser beam source, a second laser beam source, a third laser beam source, a laser control unit, a laser beam mixing and separating unit, an optical path switch unit, a low-NA objective lens, a high-NA objective lens, a low-NA objective lens drive unit, a high-NA objective lens drive unit, a first laser beam detection unit, a second laser beam detection unit, a third laser beam detection unit, a servo signal generation unit, a disc determination unit, and a drive difference addition unit. The first laser beam source emits a first laser beam. The second laser beam source emits a second laser beam that has a shorter wavelength than the first laser beam. The third laser beam source emits a third laser beam that has a shorter wavelength than the second laser beam. The laser control unit controls driving of the first laser beam source, the second laser beam source, and the third laser beam source. The laser beam mixing and separating unit mixes and separates the first laser beam and the second laser beam. The optical path switch unit sets an optical path that directs the third laser beam to the high-NA objective lens when the optical path switch unit is on, and sets an optical path that directs the third laser beam to the low-NA objective lens when the optical path switch unit is off. The low-NA objective lens illuminates an optical disc simultaneously with the first laser beam and the second laser beam that have been mixed by the laser beam mixing and separating unit. The high-NA objective lens illuminates the optical disc with the third laser beam when the optical path switch unit is on, and has a higher numerical aperture than the low-NA objective lens. The low-NA objective lens drive unit changes a distance between the low-NA objective lens and the optical disc by driving the low-NA objective lens toward and away from the optical disc. The high-NA objective lens drive unit changes a distance between the high-NA objective lens and the optical disc by driving the high-NA objective lens toward and away from the optical disc. The first laser beam detection unit detects an intensity of the first laser beam that has been reflected from the optical disc. The second laser beam detection unit detects an intensity of the second laser beam that has been reflected from the optical disc. The third laser beam detection unit detects an intensity of the third laser beam that has been reflected from the optical disc. The servo signal generation unit generates a first laser beam detection signal corresponding to a result of detection of the first laser beam detection unit, a second laser beam detection signal corresponding to a result of detection of the second laser beam detection unit, and a third laser beam detection signal corresponding to a result of detection of the third laser beam detection unit. The disc determination unit outputs a high-NA objective lens drive control signal for driving the high-NA objective lens and determines a type of the optical disc based on the first laser beam detection signal, the second laser beam detection signal, and the third laser beam detection signal. The drive difference addition unit generates a low-NA objective lens drive control signal for driving the low-NA objective lens by adding an offset value to the high-NA objective lens drive control signal.

The low-NA objective lens drive unit drives the low-NA objective lens based on the low-NA objective lens drive control signal, and the high-NA objective lens drive unit drives the high-NA objective lens based on the high-NA objective lens drive control signal.

This optical disc apparatus illuminates the optical disc simultaneously with the first laser beam and the second laser beam that have been mixed by the laser beam mixing and separating unit through the low-NA objective lens and illuminates the optical disc with the third laser beam through the high-NA objective lens when the optical path switch unit is on. Thus, the optical disc apparatus promptly determines which one of a large number of types of discs has been mounted. When the optical path switch unit is off, the optical disc apparatus illuminates the optical disc with the third laser beam through the low-NA objective lens. Thus, the optical disc apparatus promptly and reliably determines which one of a large number of types of discs has been mounted without damaging an information recording surface of an optical disc. Further, the optical disc apparatus reduces the third laser illumination, which requires greater power consumption. As a result, the optical disc apparatus consumes less power.

A sixth aspect of the present invention provides the optical disc apparatus of the fifth aspect of the present invention in which the low-NA objective lens is arranged at an initial position of the low-NA objective lens at which a distance between the low-NA objective lens and a surface of the optical disc facing the low-NA objective lens is longer than a focal length with which the low-NA objective lens focuses the first laser beam in an initial state of an operation for determining the type of the optical disc. The low-NA objective lens drive unit drives the low-NA objective lens from the initial position of the low-NA objective lens in a direction in which the distance between the low-NA objective lens and the optical disc decreases. The high-NA objective lens drive unit drives the high-NA objective lens from an initial position of the high-NA objective lens in a direction in which the distance between the high-NA objective lens and the optical disc decreases at a speed that is identical to a speed at which the low-NA objective lens drive unit drives the low-NA objective lens. The initial position of the high-NA objective lens is a position of the high-NA objective lens when the low-NA objective lens is at the initial position of the low-NA objective lens. The disc determination unit determines the type of the optical disc by comparing a signal level of the first laser beam detection signal, a signal level of the second laser beam detection signal, and a signal level of the third laser beam detection signal with a predetermined threshold while the low-NA objective lens and the high-NA objective lens are being driven by the low-NA objective lens drive unit and the high-NA objective lens drive unit from the initial position of the low-NA objective lens and the initial position of the high-NA objective lens in a direction in which the distance between the low-NA objective lens and the optical disc and the distance between the high-NA objective lens and the optical disc decrease.

A seventh aspect of the present invention provides the optical disc apparatus of the fifth or sixth aspect of the present invention in which the drive control unit controls driving in a first stage in a manner that the first laser beam is emitted from the first laser beam source, the second laser beam is emitted from the second laser beam source, and the third laser beam is emitted from the third laser beam source, and controls driving in a second stage in a manner that only the third laser beam is emitted from the third laser beam source. The optical path switch unit is on in the first stage and is off in the second stage. The high-NA objective lens drive unit drives the high-NA objective lens from the initial position of the high-NA objective lens in the direction in which the distance between the high-NA objective lens and the optical disc decreases in the first stage, and does not drive the high-NA objective lens in the second stage. The low-NA objective lens drive unit drives the low-NA objective lens from the initial position of the low-NA objective lens in the direction in which the distance between the low-NA objective lens and the optical disc decreases in the first stage at the speed that is identical to the speed at which the high-NA objective lens drive unit drives the high-NA objective lens, and drives the low-NA objective lens from the initial position of the low-NA objective lens in the direction in which the distance between the low-NA objective lens and the optical disc decreases in the second stage. The disc determination unit determines the type of the optical disc based on the first laser beam detection signal, the second laser beam detection signal, and the third laser beam detection signal in the first stage, and determines the type of the optical disc based on the third laser beam detection signal in the second stage.

An eighth aspect of the present invention provides the optical disc apparatus of the seventh aspect of the present invention in which the disc determination unit determines the type of the optical disc by comparing a signal level of the first laser beam detection signal, a signal level of the second laser beam detection signal, and a signal level of the third laser beam detection signal with a predetermined threshold while the low-NA objective lens and the high-NA objective lens are being driven by the low-NA objective lens drive unit and the high-NA objective lens drive unit from the initial position of the low-NA objective lens and the initial position of the high-NA objective lens in the direction in which the distance between the low-NA objective lens and the optical disc and the distance between the high-NA objective lens and the optical disc decrease in the first stage. The disc determination unit determines the type of the optical disc by comparing the signal level of the third laser beam detection signal with the predetermined threshold while the low-NA objective lens is being driven by the low-NA objective lens drive unit from the initial position of the low-NA objective lens in the direction in which the distance between the low-NA objective lens and the optical disc decreases in the second stage.

A ninth aspect of the present invention provides the optical disc apparatus including a first laser beam source, a second laser beam source, a third laser beam source, a laser control unit, a laser beam mixing and separating unit, an optical path switch unit, a low-NA objective lens, a high-NA objective lens, a low-NA objective lens, a high-NA objective lens, a multiple laser beam detection unit, a third laser beam detection unit, a servo signal generation unit, a disc determination unit, and a drive difference addition unit. The first laser beam source emits a first laser beam. The second laser beam source emits a second laser beam that has a shorter wavelength than the first laser beam. The third laser beam source emits a third laser beam that has a shorter wavelength than the second laser beam. The laser control unit controls driving of the first laser beam source, the second laser beam source, and the third laser beam source. The laser beam mixing and separating unit mixes and separates the first laser beam and the second laser beam. The optical path switch unit sets an optical path that directs the third laser beam to the high-NA objective lens when the optical path switch unit is on, and set an optical path that directs the third laser beam to the low-NA objective lens when the optical path switch unit is off. The low-NA objective lens illuminates an optical disc simultaneously with the first laser beam and the second laser beam that have been mixed by the laser beam mixing and separating unit. The high-NA objective lens has a higher numerical aperture than the low-NA objective lens, and illuminates the optical disc with the third laser beam when the optical path switch unit is on. The low-NA objective lens drive unit changes a distance between the low-NA objective lens and the optical disc by driving the low-NA objective lens toward and away from the optical disc. The high-NA objective lens drive unit changes a distance between the high-NA objective lens and the optical disc by driving the high-NA objective lens toward and away from the optical disc. The multiple laser beam detection unit detects an intensity of the first laser beam that has been reflected from the optical disc and an intensity of the second laser beam that has been reflected from the optical disc. The third laser beam detection unit detects an intensity of the third laser beam that has been reflected from the optical disc. The servo signal generation unit generates a multiple laser beam detection signal corresponding to a result of detection of the multiple laser beam detection unit and generate a third laser beam detection signal corresponding to a result of detection of the third laser beam detection unit. The disc determination unit outputs a low-NA objective lens drive control signal for driving the low-NA objective lens and determine a type of the optical disc based on the multiple laser beam detection signal and the third laser beam detection signal. The drive difference addition unit generates a high-NA objective lens drive control signal for driving the high-NA objective lens by adding an offset value to the low-NA objective lens drive control signal.

The low-NA objective lens drive unit drives the low-NA objective lens based on the low-NA objective lens drive control signal. The high-NA objective lens drive unit drives the high-NA objective lens based on the high-NA objective lens drive control signal.

This optical disc apparatus has the same advantageous effects as the fifth aspects of the present invention. Moreover in this optical disc apparatus, the multiple laser beam detection unit detects an intensity of the first laser beam and an intensity of the second laser beam. Therefore it is not necessary for this optical disc apparatus to have a plurality of laser beam detection units. As a result, the configuration of this optical disc apparatus becomes simple, and this optical disc apparatus is achieved at low cost.

A tenth aspect of the present invention provides the optical disc apparatus of the ninth aspect of the present invention in which the low-NA objective lens is arranged at an initial position of the low-NA objective lens at which a distance between the low-NA objective lens and a first disc surface of the optical disc facing the low-NA objective lens is longer than a focal length with which the low-NA objective lens focuses the first laser beam in an initial state of an operation for determining the type of the optical disc, and the initial position of the low-NA objective lens is a position distant from the first disc surface by a distance LEN0 in a direction of the low-NA objective lens. The high-NA objective lens is at an initial position of the high-NA objective lens that is a position distant from the first disc surface by a value obtained by subtracting the offset value Offset from the distance LEN0, where Offset>0, in the initial state of the operation for determining the type of the optical disc. The low-NA objective lens drive unit drives the low-NA objective lens from the initial position of the low-NA objective lens in a direction in which the distance between the low-NA objective lens and the optical disc decreases. The high-NA objective lens drive unit drives the high-NA objective lens from the initial position of the high-NA objective lens in a direction in which the distance between the high-NA objective lens and the optical disc decreases at a speed that is identical to a speed at which the low-NA objective lens drive unit drives the low-NA objective lens. The disc determination unit determines the type of the optical disc by comparing a signal level of the multiple laser beam detection signal and a signal level of the third laser beam detection signal with a predetermined threshold while the low-NA objective lens and the high-NA objective lens are being driven by the low-NA objective lens drive unit and the high-NA objective lens drive unit from the initial position of the low-NA objective lens and the initial position of the high-NA objective lens in a direction in which the distance between the low-NA objective lens and the optical disc and the distance between the high-NA objective lens and the optical disc decrease.

An eleventh aspect of the present invention provides the optical disc apparatus of the ninth aspect of the present invention in which the high-NA objective lens is arranged in the initial state at the initial position of the high-NA objective lens that is a position distant from the first disc surface by a value obtained by subtracting the offset value Offset from the distance LEN0, where Offset>0, and the offset value Offset is determined to satisfy

LEN1>LEN2>LEN3,

where LEN1 is a distance between a focal point position of the first laser beam that is focused by the low-NA objective lens and the first disc surface, LEN2 is a distance between a focal point position of the second laser beam that is focused by the low-NA objective lens and the first disc surface, and LEN3 is a distance between a focal point position of the third laser beam that is focused by the high-NA objective lens and the first disc surface.

A twelfth aspect of the present invention provides the optical disc apparatus of the ninth aspect of the present invention in which the drive control unit controls driving in a first stage in a manner that the first laser beam is emitted from the first laser beam source, the second laser beam is emitted from the second laser beam source, and the third laser beam is emitted from the third laser beam source, and controls driving in a second stage in a manner that only the third laser beam is emitted from the third laser beam source. The optical path switch unit is on in the first stage and is off in the second stage. The low-NA objective lens drive unit drives the low-NA objective lens from the initial position of the low-NA objective lens in the direction in which the distance between the low-NA objective lens and the optical disc decreases in the first stage, and drives the low-NA objective lens from the initial position of the low-NA objective lens in the direction in which the distance between the low-NA objective lens and the optical disc decreases in the second stage. The high-NA objective lens drive unit drives the high-NA objective lens from the initial position of the high-NA objective lens in the direction in which the distance between the high-NA objective lens and the optical disc decreases at a speed that is identical to a speed at which the low-NA objective lens drive unit drives the low-NA objective lens in the first stage, and does not drive the high-NA objective lens in the second stage. The disc determination unit determines the type of the optical disc based on the multiple laser beam detection signal and the third laser beam detection signal in the first stage, and determines the type of the optical disc based on the third laser beam detection signal in the second stage.

A thirteenth aspect of the present invention provides the optical disc apparatus of the tenth aspect of the present invention in which the disc determination unit determines the type of the optical disc by comparing the signal level of the multiple laser beam detection signal and the signal level of the third laser beam detection signal with the predetermined threshold while the low-NA objective lens and the high-NA objective lens are being driven by the low-NA objective lens drive unit and the high-NA objective lens drive unit from the initial position of the low-NA objective lens and the initial position of the high-NA objective lens in the direction in which the distance between the low-NA objective lens and the optical disc and the distance between the high-NA objective lens and the optical disc decrease in the first stage. The disc determination unit determines the type of the optical disc by comparing the signal level of the multiple laser beam detection signal with the predetermined threshold while the low-NA objective lens is being driven by the low-NA objective lens drive unit from the initial position of the low-NA objective lens in the direction in which the distance between the low-NA objective lens and the optical disc decreases in the second stage.

Fourteenth to seventeenth aspects of the present invention each provide a method that is used in an optical disc apparatus and has the same advantageous effects as the first, third, fifth, and ninth aspects of the present invention.

Eighteenth to twenty first aspects of the present invention each provide a program that is used in an optical disc apparatus and has the same advantageous effects as the first, third, fifth, and ninth aspects of the present invention.

Twenty second to twenty fifth aspects of the present invention each provide an integrated circuit that is used in an optical disc apparatus and has the same advantageous effects as the first, third, fifth, and ninth aspects of the present invention.

### Advantageous Effects

The optical disc apparatus of the present invention includes an LDD that has a switch function for switching to use a recording illumination drive signal, which is used to cause recording laser illumination, to cause reproduction laser illumination and in which the gain with which the recording illumination drive signal is amplified has the resolution equivalent to the resolution of the gain with which a reproduction illumination drive signal is amplified. Thus, the optical disc apparatus can illuminate an optical disc simultaneously with a plurality of laser beams simply by changing the internal structure of the LDD. When the optical disc apparatus records or reproduces on two types of discs that differ from each other in the thickness of a substrate between the surface of the optical disc and the information recording surface of the optical disc and also differ from each other in the corresponding laser wavelength, the optical disc apparatus requires only a shorter time for its disc determination.

Further, the apparatus may freely select the wavelength of a laser beam illuminating through the same objective lens. This structure also has the same advantageous effects as described above.

Further, the apparatus may use three of more laser beams with different wavelengths illuminating through the same objective lens. This structure also has the same advantageous effects as described above.

Further, the apparatus may determine the type of each information recording surface of the disc instead of determining the type of the disc when the single disc has a plurality of information recording surfaces that are substantially identical to one another in the thickness of a substrate between the surface of the optical disc and each information recording surface and that differ from one another in the corresponding laser wavelength. This structure also has the same advantageous effects as described above.

Further, the apparatus may set the output of a laser (output level of a laser beam) at a low output (low output level). This structure does not increase the number of laser front-light monitors, and has the same advantageous effects as described above.

Further, the apparatus may superimpose a high-frequency element on a recording illumination drive signal when the recording illumination drive signal is used to cause reproduction illumination. This structure also has the same advantageous effects as described above.

Further, the apparatus may freely select combinations of illumination drive signals and laser beam sources that are controlled based on the drive signals. This structure also has the same advantageous effects as described above.

When the optical disc apparatus uses an objective lens that focuses a red laser beam and a blue laser beam in a manner that the red laser beam is focused at a more distant position in the direction of the normal to the objective lens (in the optical axis direction of the objective lens) and records or reproduces on a plurality of types of discs including an HD-DVD and a DVD that are substantially identical to one another in the thickness of a substrate between the surface of the optical disc and the information recording surface of the optical disc even if the objective lens is moved toward a surface of the optical disc (surface of the optical disc facing the objective lens) in the disc determination operation, the optical disc apparatus prevents information recorded on an information recording surface of the DVD from being damaged by a blue laser beam, which is a laser beam to be used for an HD-DVD.

Further, the optical disc apparatus may use an objective lens that focuses a red laser beam and a blue laser beam in a manner that the red laser beam is focused at a nearer position in the direction of the normal to the objective lens (in the optical axis direction of the objective lens) and may move the objective lens away from the vicinity of a surface of the optical disc (surface of the optical disc facing the objective lens) in the disc determination operation. This structure also has the same advantageous effects as described above.

Further, the apparatus may freely select the wavelength of a laser beam illuminating through the same objective lens. This structure also has the same advantageous effects as described above.

Further, the apparatus may use three or more laser beams with different wavelengths illuminating through the same objective lens. This structure also has the same advantageous effects as described above.

Further, the apparatus may determine the type of each information recording surface of the disc instead of determining the type of the disc when the single disc has a plurality of information recording surfaces that are substantially identical to one another in the thickness of a substrate between the surface of the optical disc and each information recording surface and that differ from one another in the corresponding laser wavelength. This structure also has the same advantageous effects as described above.

Further, the apparatus may set the output of a laser (output level of a laser beam) at a low output (low output level). This structure does not increase the number of laser front-light monitors, and has the same advantageous effects as described above.

Further, the apparatus may use an objective lens that focuses a red laser beam at a nearer position than a blue laser beam in the direction of the normal to the objective lens (in the optical axis direction of the objective lens) and may move the objective lens away from the vicinity of a surface of the optical disc (surface of the optical disc facing the objective lens) in the disc determination operation. This structure also has the same advantageous effects as described above.

Further, the apparatus may superimpose a high-frequency element on a recording illumination drive signal when the recording illumination drive signal is used to cause reproduction illumination. This structure also has the same advantageous effects as described above.

Further, the apparatus may freely select combinations of illumination drive signals and laser beam sources that are controlled based on the drive signals. This structure also has the same advantageous effects as described above.

When the apparatus uses an objective lens that focuses a red laser beam and an objective lens that focuses a blue laser beam and drives the two objective lenses with a drive difference that causes the red laser beam to be focused at a more distant position in the directions of the normals to the objective lenses (in the optical axis directions of the objective lenses), the apparatus prevents information recorded on an information recording surface of a DVD from being damaged by a blue laser beam, which is a laser beam to be used for an HD-DVD, in a more safe manner than the structure including only a single objective lens.

Further, the apparatus may freely select the wavelength of a laser beam illuminating through each of the two objective lenses. This structure also has the same advantageous effects as described above.

Further, the apparatus may use three or more laser beams with different wavelengths illuminating through the two objective lenses. This structure also has the same advantageous effects as described above.

Further, the apparatus may use separate objective lenses that focus a red laser beam and a blue laser beam and drive the objective lenses with a drive difference that causes the red laser beam to be focused at a nearer position in the directions of the normals to the objective lenses (in the optical axis directions of the objective lenses), and move the objective lens away from the vicinity of a surface of the optical disc (surface of the optical disc facing the objective lens). This structure also has the same advantageous effects as described above.

Further, the apparatus may determine the type of each information recording surface of the disc instead of determining the type of the disc when the single disc has a plurality of information recording surfaces that are substantially identical to one another in the thickness of a substrate between the surface of the optical disc and each information recording surface and that differ from one another in the corresponding laser wavelength. This structure also has the same advantageous effects as described above.

Further, the apparatus may set the output of a laser (output level of a laser beam) at a low output (low output level). This structure does not increase the number of laser front-light monitors, and has the same advantageous effects as described above.

Further, the apparatus may superimpose a high-frequency element on a recording illumination drive signal when the recording illumination drive signal is used to cause reproduction illumination. This structure also has the same advantageous effects as described above.

Further, the apparatus may freely select combinations of illumination drive signals and the laser beam sources that are controlled based on the drive signals. This structure also has the same advantageous effects as described above.

Further, the apparatus may use a low-NA objective lens that focuses an infrared laser beam at a more distant position than a red laser beam in the direction of the normal to the objective lens (in the optical axis direction of the objective lens), and first perform a determination process for determining whether the disc is a BD, a DVD, or a CD, and then perform a determination process for determining whether the disc is an HD-DVD. When the apparatus with this structure records or reproduces on a plurality of discs including an HD-DVD and a DVD that are substantially identical to one another in the thickness of a substrate between the surface of the optical disc and the information recording surface of the optical disc, the apparatus prevents information recorded on an information recording surface of the DVD from being damaged by a blue laser beam, which is a laser beam to be used for an HD-DVD.

Further, the apparatus may use a low-NA objective lens that focuses an infrared laser beam at a nearer position than a red laser beam in the direction of the normal to the objective lens (in the optical axis direction of the objective lens), and move the low-NA objective lens away from the vicinity of a surface of the optical disc (surface of the optical disc facing the objective lens) in the disc determination operation. This structure also has the same advantageous effects as described above.

Further, the apparatus may freely select combinations of illumination drive signals and laser beam sources that are controlled based on the drive signals. This structure also has the same advantageous effects as described above.

Further, the apparatus may determine the type of each information recording surface of the disc instead of determining the type of the disc when the single disc has a plurality of information recording surfaces that differ from one another in the recording density or in the corresponding laser wavelength. This structure also has the same advantageous effects as described above.

Further, the apparatus may set the output of a laser (output level of a laser beam) at a low output (low output level). This structure does not increase the number of laser front-light monitors, and has the same advantageous effects as described above.

Further, the apparatus may superimpose a high-frequency element on a recording illumination drive signal when the recording illumination drive signal is used to cause reproduction illumination. This structure also has the same advantageous effects as described above.

### BRIEF DESCRIPTION OF THE DRAWINGS

FIG. 1 is a block diagram showing the structure of an optical disc apparatus according to a first embodiment of the present invention;

FIG. 2 is a schematic diagram describing a disc determination operation using simultaneous illumination of a plurality of lasers for determining that a CD or a DVD has been mounted on the optical disc apparatus according to the first embodiment;

FIG. 3 is a timing chart describing a disc determination operation using simultaneous illumination of a plurality of lasers for determining that a CD has been mounted on the optical disc apparatus according to the first embodiment;

FIG. 4 is a timing chart describing a disc determination operation using simultaneous illumination of a plurality of lasers for determining that a DVD has been mounted on the optical disc apparatus according to the first embodiment;

FIG. 5 is a block diagram showing the structure of an optical disc apparatus according to a second embodiment of the present invention;

FIG. 6 is a schematic diagram describing a disc determination operation using simultaneous illumination of a plurality of lasers for determining that a DVD or an HD-DVD has been mounted on the optical disc apparatus according to the second embodiment;

FIG. 7 is a timing chart describing a disc determination operation using simultaneous illumination of a plurality of lasers for determining that a DVD has been mounted on the optical disc apparatus according to the second embodiment;

FIG. 8 is a timing chart describing a disc determination operation using simultaneous illumination of a plurality of lasers for determining that an HD-DVD has been mounted on the optical disc apparatus according to the second embodiment;

FIG. 9 is a block diagram showing the structure of an optical disc apparatus according to a third embodiment of the present invention;

FIG. 10 is a schematic diagram describing a disc determination operation using simultaneous illumination of a plurality of lasers for determining that a DVD or an HD-DVD has been mounted on the optical disc apparatus according to the third embodiment;

FIG. 11 is a timing chart describing a disc determination operation using simultaneous illumination of a plurality of lasers for determining that a DVD has been mounted on the optical disc apparatus according to the third embodiment;

FIG. 12 is a timing chart describing a disc determination operation using simultaneous illumination of a plurality of lasers for determining that an HD-DVD has been mounted on the optical disc apparatus according to the third embodiment;

FIG. 13 is a block diagram showing the structure of an optical disc apparatus according to a fourth embodiment of the present invention;

FIG. 14 is a schematic diagram describing a disc determination operation using simultaneous illumination of a plurality of lasers for determining that an HD-DVD has been mounted on the optical disc apparatus according to the fourth embodiment;

FIG. 15 is a timing chart describing a disc determination operation using simultaneous illumination of a plurality of lasers for determining that an HD-DVD has been mounted on the optical disc apparatus according to the fourth embodiment;

FIG. 16 is a timing chart describing a disc determination operation using simultaneous illumination of a plurality of lasers for determining that a BD has been mounted on the optical disc apparatus according to the fourth embodiment;

FIG. 17 is a block diagram showing the structure of an optical disc apparatus according to a fifth embodiment of the present invention;

FIG. 18 is a timing chart describing a disc determination operation using simultaneous illumination of a plurality of lasers for determining that an HD-DVD has been mounted on the optical disc apparatus according to the fifth embodiment;

FIG. 19 is a timing chart describing a disc determination operation using simultaneous illumination of a plurality of lasers for determining that a BD has been mounted on the optical disc apparatus according to the fifth embodiment;

FIG. 20 is a diagram describing driving control of a low-NA objective lens 33 and a high-NA objective lens 32 included in an optical disc apparatus according to another embodiment of the present invention;

FIG. 21 is a block diagram showing the structure of a conventional optical disc apparatus;

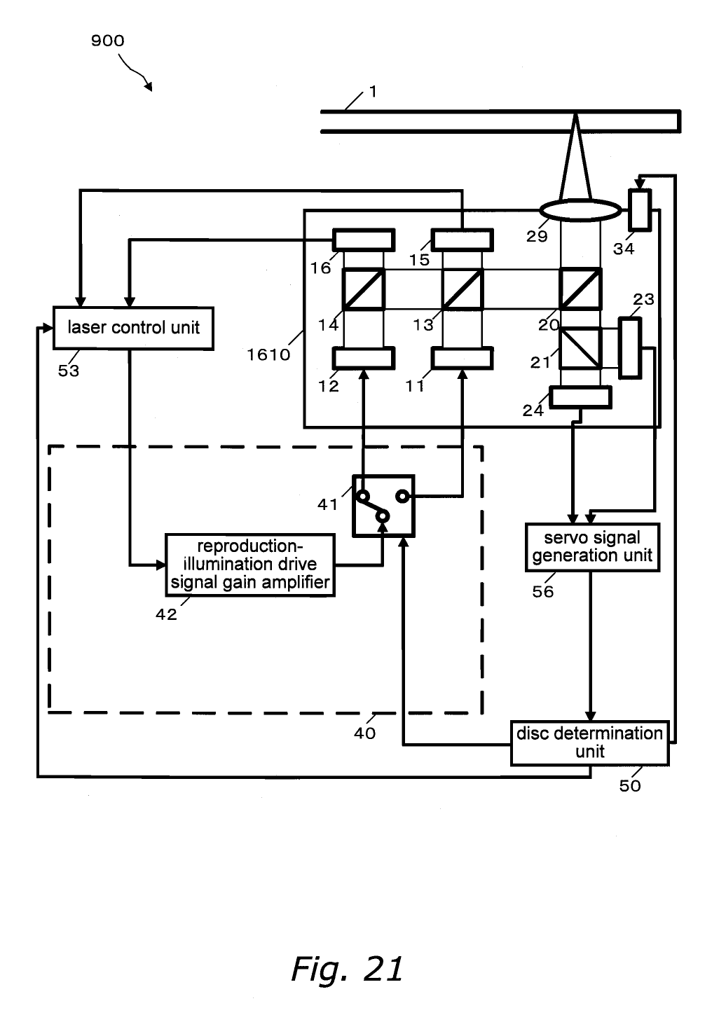

FIG. 22 is a timing chart describing a disc determination operation for determining that a CD has been mounted on the conventional optical disc apparatus; and

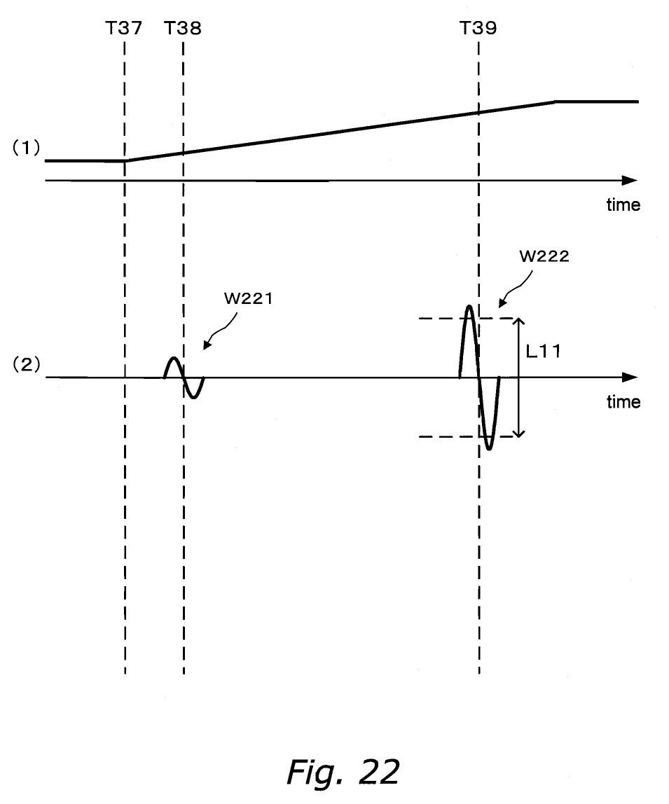

FIG. 23 is a timing chart describing a disc determination operation for determining that a DVD has been mounted on the conventional optical disc apparatus.

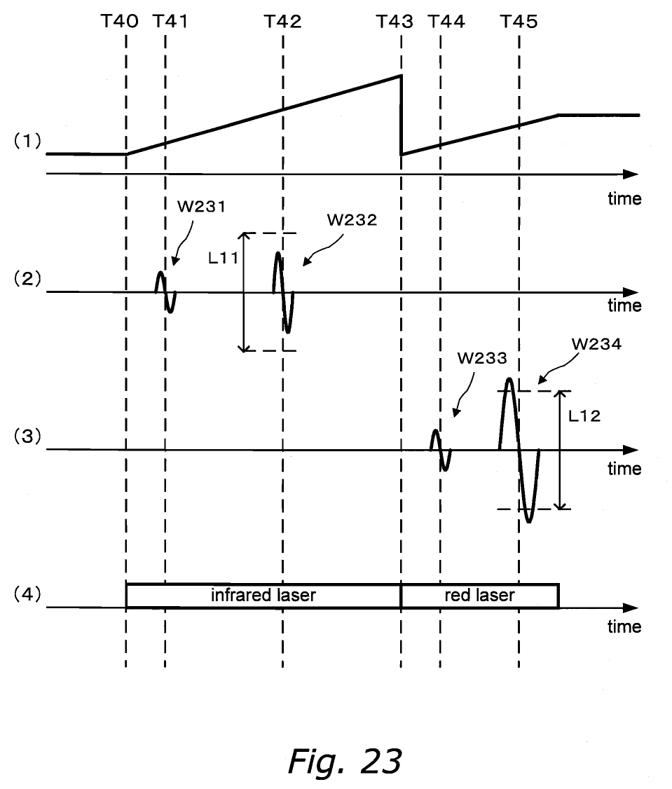

### DETAILED DESCRIPTION OF THE INVENTION

Embodiments of the present invention will now be described.

### First Embodiment

### 1.1 Structure of the Optical Disc Apparatus

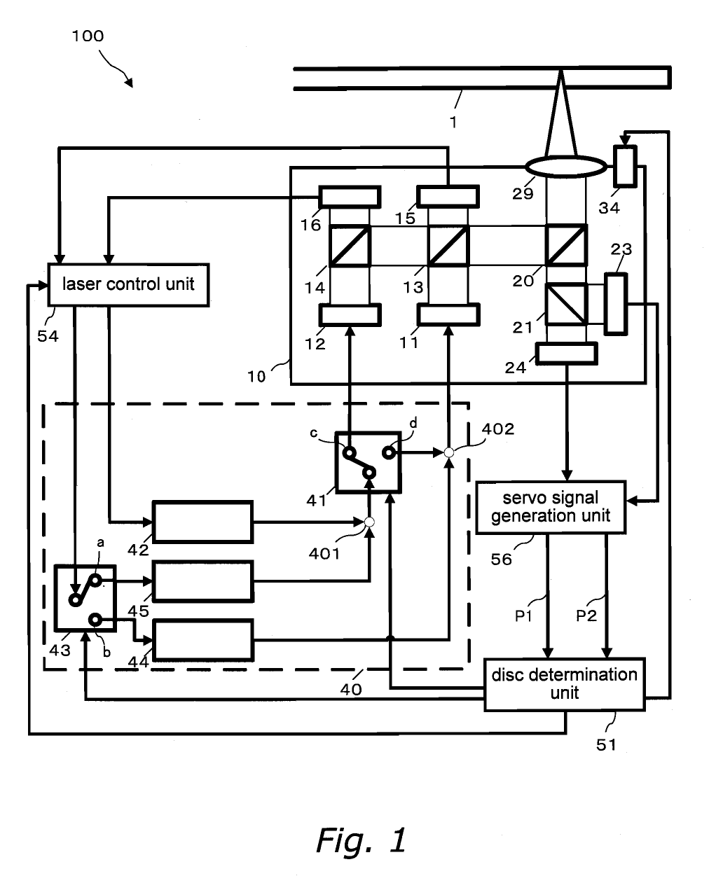

A first embodiment of the present invention will now be described with reference to FIGS. 1 to 4.

FIG. 1 is a block diagram showing the structure of an optical disc apparatus 100 according to the first embodiment of the present invention.

The optical disc apparatus 100 includes an infrared-laser beam source 11, an infrared-laser beam splitter 13, an infrared-laser front light monitor 15, a red-laser beam source 12, a red-laser beam splitter 14, a red-laser front light monitor 16, an illumination beam splitter 20, an objective lens 29, a focus actuator 34, a detector beam splitter 21, an infrared-laser beam detector 23, a red-laser beam detector 24, a servo signal generation circuit (servo signal generation unit) 56, an illumination laser selector SW41, and a reproduction-illumination drive signal gain amplifier 42.

The optical disc apparatus 100 further includes a laser controller (laser control unit) 54, a disc determination controller (disc determination unit) 51, a recording-illumination drive signal switch SW43, a simultaneous illumination gain amplifier 44, and a recording-illumination drive signal gain amplifier 45.

In FIG. 1, an optical disc 1, the infrared-laser beam source 11, the infrared-laser beam splitter 13, the infrared-laser front light monitor 15, the red-laser beam source 12, the red-laser beam splitter 14, the red-laser front light monitor 16, the illumination beam splitter 20, the objective lens 29, the focus actuator 34, the detector beam splitter 21, the infrared-laser beam detector 23, the infrared-laser beam detector 23, the servo signal generation circuit (servo signal generation unit) 56, the illumination laser selector SW41, and the reproduction-illumination drive signal gain amplifier 42 have the same functions as the corresponding components of the conventional optical disc apparatus 900 and will not be described in detail in the present embodiment.

The optical disc apparatus 100 differs from the conventional optical disc apparatus in its use of the laser controller (laser control unit) 54, the disc determination controller (disc determination unit) 51, the recording-illumination drive signal switch SW43, the simultaneous illumination gain amplifier 44, and the recording-illumination drive signal gain amplifier 45. The optical disc apparatus 100 determines, in a short time, the type of the optical disc 1 that has been mounted on the optical disc apparatus 100 to be one of a plurality of disc types through an objective lens operation performed only once (operation of moving the objective lens 29 toward or away from the optical disc 1) while illuminating the optical disc 1 simultaneously with a plurality of laser beams with different wavelengths.

The infrared-laser beam source 11 shown in FIG. 1 emits an infrared laser beam having a wavelength of about 780 nm. The infrared-laser beam splitter 13 splits the infrared laser beam toward the illumination beam splitter 20 and the infrared-laser front light monitor 15. The infrared-laser front light monitor 15 detects the output power of the infrared laser beam that has entered the infrared-laser front light monitor 15. The output of the infrared-laser front light monitor 15 is input into the laser control unit 54.

The red-laser beam source 12 emits a red laser beam having a wavelength of about 650 nm. The red-laser beam splitter 14 splits the red laser beam toward the illumination beam splitter 20 and the red-laser front light monitor 16. The red-laser front light monitor 16 detects the output power of the red laser beam that has entered the red-laser front light monitor 16. The output of the red-laser front light monitor 16 is input into the laser control unit 54.

The red laser beam and the infrared laser beam that have been split toward the illumination beam splitter 20 are reflected by the illumination beam splitter 20 in the direction of the objective lens 29. The beams are then focused by the objective lens 29 onto an information recording surface of the optical disc 1. The red laser beam and the infrared laser beam are reflected by the optical disc 1, and the reflected beams pass through the illumination beam splitter 20. The red laser beam and the infrared laser beam then pass through the detector beam splitter 21. Through the detector beam splitter 21, the red laser beam enters the red-laser beam detector 24, whereas the infrared laser beam enters the infrared-laser beam detector 23. The output of the red-laser beam detector 24 and the output of the infrared-laser beam detector 23 are input into the servo signal generation unit 56.

During reproduction, the laser controller (laser control unit) 54 outputs, to the LDD 40, a reproduction-illumination drive signal that causes the output level of the red laser beam detected by the red-laser front light monitor 16 (the level of the output power of the red laser beam) and the output level of the infrared laser beam detected by the infrared-laser front light monitor 15 (the level of the output power of the infrared laser beam) to be a predetermined output level for reproduction laser beams. During recording, the laser controller (laser control unit) 54 outputs, to the LDD 40, a reproduction-illumination drive signal and a recording illumination drive signal that cause the output level of the red laser beam detected by the red-laser front light monitor 16 (the level of the output power of the red laser beam) and the output level of the infrared laser beam detected by the infrared-laser front light monitor 15 (the level of the output power of the infrared laser beam) to be a predetermined output level for recording laser beams.

The LDD 40 is mainly made of the illumination laser selector SW41, the reproduction-illumination drive signal gain amplifier 42, the recording-illumination drive signal switch SW43, the simultaneous illumination gain amplifier 44, the recording-illumination drive signal gain amplifier 45, a first adder 401, and a second adder 402.

The recording-illumination drive signal gain amplifier 45 amplifies a recording-illumination drive signal. More specifically, the recording-illumination drive signal gain amplifier 45 amplifies a recording-illumination drive signal, which is output from the recording-illumination drive signal switch SW43, with a predetermined gain, and outputs the amplified signal to the first adder 401. The recording-illumination drive signal gain amplifier 45 has a lower resolution and a higher amplification factor than the reproduction-illumination drive signal gain amplifier 42.

During reproduction, the LDD 40 outputs a signal for laser driving, which is a signal obtained by the reproduction-illumination drive signal gain amplifier 42 amplifying the reproduction-illumination drive signal (signal obtained by amplifying the reproduction-illumination drive signal with the gain (amplification factor) of the reproduction-illumination drive signal gain amplifier 42), to the infrared-laser beam source 11 or to the red-laser beam source 12. During recording, the LDD 40 outputs a signal for laser driving, which is a signal resulting from addition of a laser driving signal obtained by the reproduction-illumination drive signal gain amplifier 42 amplifying the reproduction-illumination drive signal and a laser driving signal obtained by the recording-illumination drive signal gain amplifier 45 amplifying the recording-illumination drive signal (a signal obtained by amplifying the recording-illumination drive signal with the gain (amplification factor) of the recording-illumination drive signal gain amplifier 45), to the infrared-laser beam source 11 or to the red-laser beam source 12.

The recording-illumination drive signal switch SW43 of the LDD 40 is normally set in a manner that the recording-illumination drive signal is provided to the recording-illumination drive signal gain amplifier 45. The recording-illumination drive signal switch SW43 receives, as its input, the output of the laser control unit 54, and outputs the received input to the recording-illumination drive signal gain amplifier 45 or to the simultaneous illumination gain amplifier 44 based on a control signal (signal indicating whether the disc determination operation is being performed) output from the disc determination unit 51. More specifically, the recording-illumination drive signal switch SW43 outputs the received input to the simultaneous illumination gain amplifier 44 only while the operation for determining the type of the optical disc 1 that has been mounted on the optical disc apparatus 100 (hereafter referred to as the “disc determination operation”) is being performed, and outputs the received input to the recording-illumination drive signal gain amplifier 45 in periods other than while the disc determination operation is being performed.

The disc determination controller (disc determination unit) 51 switches the illumination laser selector SW41 of the LDD 40 in a manner that the LDD 40 outputs a signal for laser driving, which is a signal obtained by the reproduction-illumination drive signal gain amplifier 42 amplifying the reproduction-illumination drive signal (a laser driving signal obtained by amplifying the reproduction-illumination drive signal with the gain of the reproduction-illumination drive signal gain amplifier 42), to the red-laser beam source 12, and switches the recording-illumination drive signal switch SW43 of the LDD 40 in a manner that the LDD 40 outputs a signal for laser driving, which is a signal obtained by the simultaneous illumination gain amplifier 44 amplifying the recording-illumination drive signal (a laser driving signal obtained by amplifying the recording-illumination drive signal with the gain of the simultaneous illumination gain amplifier 44), to the infrared-laser beam source 11.

To perform the disc determination operation, the disc determination controller (disc determination unit) 51 switches the illumination laser selector SW41 in a manner that the LDD 40 outputs the reproduction-illumination drive signal that has been amplified by the reproduction-illumination drive signal gain amplifier 42 to the red-laser beam source 12 (switches the illumination laser selector SW41 to the c-side), and switches the recording-illumination drive signal switch SW43 in a manner that the LDD 40 outputs the recording-illumination drive signal that has been amplified by the simultaneous illumination gain amplifier 44 to the infrared-laser beam source 11 (switches the recording-illumination drive signal switch SW43 to the b-side). This enables the optical disc apparatus 100 to illuminate the optical disc 1 simultaneously with a red laser beam and an infrared laser beam.

The disc determination controller (disc determination unit) 51 further outputs a laser control mode switch signal for controlling the output of the red-laser beam source 12 and the output of the infrared-laser beam source 11 to the laser controller (laser control unit) 54. When receiving the laser control mode switch signal from the disc determination controller (disc determination unit) 51, the laser controller (laser control unit) 54 outputs, to the LDD 40, a reproduction-illumination drive signal that causes the output level of the red-laser beam source 12 to be a predetermined output level for reproduction laser beams, and outputs, to the LDD 40, a recording-illumination drive signal that causes the output level of the infrared-laser beam source 11 to be a predetermined output level for reproduction laser beams. As a result, the optical disc 1 is illuminated simultaneously with a red laser beam and an infrared laser beam.

Further, the disc determination controller (disc determination unit) 51 outputs a drive signal for driving the objective lens 29 up and down (driving the objective lens 29 toward and away from the optical disc 1) to the focus actuator 34.

The servo signal generation circuit (servo signal generation unit) 56 generates a servo signal based on the output of the red-laser beam detector 24 and the infrared-laser beam detector 23 and outputs the generated servo signal to the disc determination unit 51. The disc determination controller (disc determination unit) 51 determines the type of the disc that has been mounted on the optical disc apparatus 100 based on the servo signal, which is generated by the servo signal generation circuit (servo signal generation unit) 56.

The first adder 401 adds the output of the reproduction-illumination drive signal gain amplifier 42 and the output of the recording-illumination drive signal gain amplifier 45, and outputs the resulting signal to the illumination laser selector SW41. Although FIG. 1 shows the first adder 401 as a simple adder for ease of explanation, the first adder 401 has the function of controlling whether to perform addition processing of the two inputs according to the write strategy for the optical disc apparatus 100. This function enables the first adder 401 to output signals including a multi-pulse signal, a recording power signal, a reproduction power signal, and an erasure power signal.

The second adder 402 adds the output from the d-side of the illumination laser selector SW41 and the output of the simultaneous illumination gain amplifier 44, and outputs the resulting signal to the infrared-laser beam source 11.

The recording-illumination drive signal switch SW43 receives, as its input, the output of the laser control unit 54, and switches (selects) its output destination between the recording-illumination drive signal gain amplifier 45 and the simultaneous illumination gain amplifier 44 based on a control signal output from the disc determination unit 51. The b-side of the recording-illumination drive signal switch SW43 is selected while the disc determination operation is being performed, and the a-side of the recording-illumination drive signal switch SW43 is selected in periods other than while the disc determination operation is being performed.

The illumination laser selector SW41 receives, as its input, the output of the first adder, and switches (selects) its output destination between the red-laser beam source 12 and the infrared-laser beam source 11 based on a control signal output from the disc determination unit 51. The c-side of the illumination laser selector SW41 is normally selected when the optical disc 1 is to be illuminated with a red laser beam, and the d-side of the illumination laser selector SW41 is normally selected when the optical disc 1 is to be illuminated with an infrared laser beam. However, the c-side of the illumination laser selector SW41 is selected as described above while the disc determination operation is being performed.

The recording-illumination drive signal gain amplifier 45 of the LDD 40 has the amplification factor that is too high and the resolution that is too low for reproduction laser illumination. Thus, the simultaneous illumination gain amplifier 44 of the LDD 40 is used to amplify the recording and reproduction drive signals. In other words, the recording and reproduction drive signals are amplified by the simultaneous illumination gain amplifier 44, which has the amplification factor suitable for reproduction laser illumination, and the amplified recording and reproduction drive signals are then used to drive the infrared-laser beam source 11.

### 1.2 Operation of the Optical Disc Apparatus

### 1.2.1 Disc Determination Operation (CD)

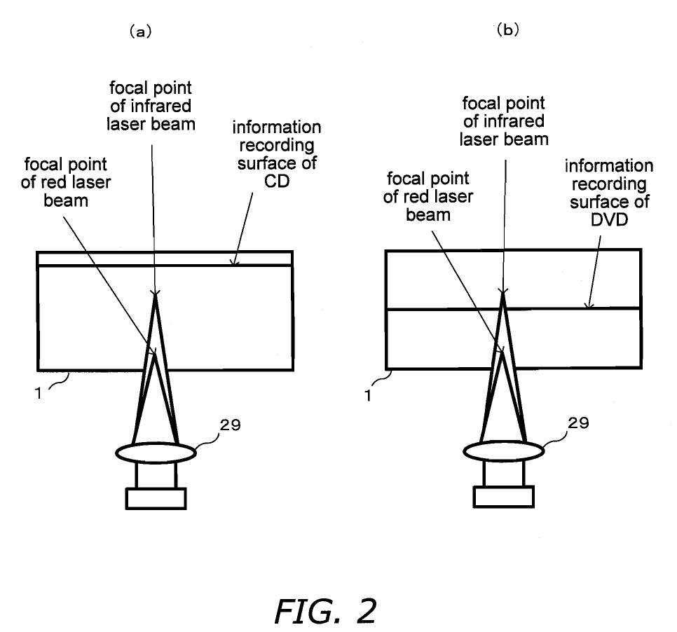

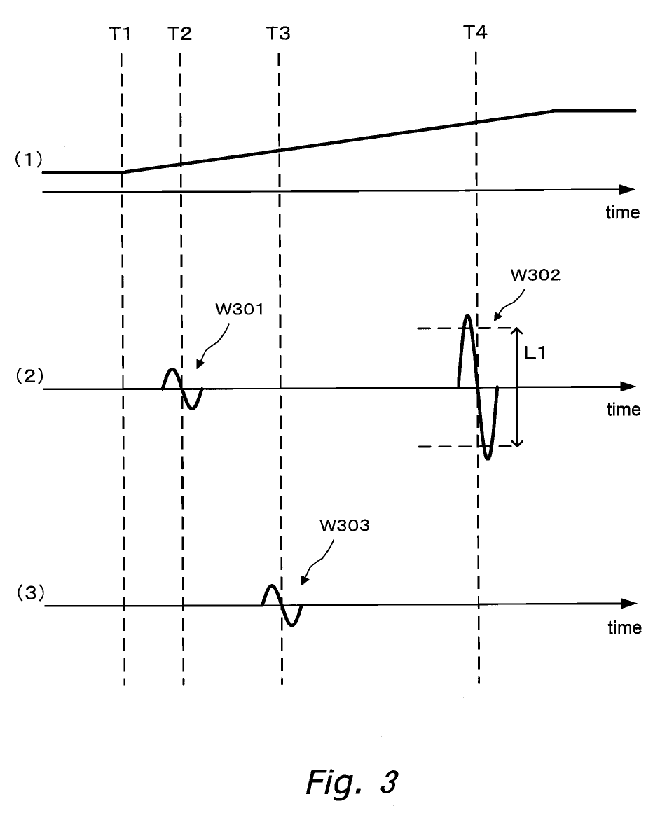

A disc determination operation using simultaneous illumination of a plurality of lasers for determining that a CD has been mounted on the optical disc apparatus 100 will now be described in detail with reference to FIGS. 2 and 3.

FIG. 2(a) is a schematic view showing an optical disc 1 that is illuminated simultaneously with an infrared laser beam and a red laser beam, which are focused on the optical disc 1. The optical disc 1 is a CD and has an information recording surface at about 1.2 mm from its surface (surface of the optical disc 1 facing the objective lens 29).

FIG. 3 shows the position of the objective lens 29 and the state of a focus error signal in the optical disc apparatus 100 when the objective lens 29 is driven while the CD is being illuminated simultaneously with an infrared laser beam and a red laser beam.

In FIG. 3, line (1) shows the position of the objective lens 29 as a function of time, where the horizontal axis indicates time and the vertical axis indicates the objective lens position. More specifically, line (1) in FIG. 3 represents signals showing the position of the objective lens 29 when the objective lens 29 is moved toward the CD while the CD is being illuminated simultaneously with a red laser beam and an infrared laser beam.

In FIG. 3, line (2) shows the level of a focus error signal as a function of time, where the horizontal axis indicates time and the vertical axis indicates the focus error signal level. More specifically, line (2) in FIG. 3 represents focus error signals (corresponding to signals transmitted on a signal line P1 in FIG. 1), which are generated by the servo signal generation circuit (servo signal generation unit) 56 based on the output of the infrared-laser beam detector 23 when the objective lens 29 is moved toward the CD while the CD is being illuminated simultaneously with a red laser beam and an infrared laser beam.

In FIG. 3, line (3) shows the level of a focus error signal as a function of time, where the horizontal axis indicates time and the vertical axis indicates the focus error signal level. More specifically, line (3) in FIG. 3 represents focus error signals (corresponding to signals transmitted on a signal line P2 in FIG. 1), which are generated by the servo signal generation circuit (servo signal generation unit) 56 based on the output of the red-laser beam detector 24 when the objective lens 29 is moved toward the CD while the CD is being illuminated simultaneously with a red laser beam and an infrared laser beam.

At timing T1 to start disc determination, the disc determination controller (disc determination unit) 51 starts its disc determination operation. The disc determination controller (disc determination unit) 51 switches the illumination laser selector SW41 of the LDD 40 in a manner that the LDD 40 outputs a signal for laser driving, which is a signal obtained by amplifying the reproduction-illumination drive signal with the gain of the reproduction-illumination drive signal gain amplifier 42, to the red-laser beam source 12 (switches the illumination laser selector SW41 to the c-side), and switches the recording-illumination drive signal switch SW43 of the LDD 40 in a manner that the LDD 40 outputs a signal for laser driving, which is a signal obtained by amplifying the recording-illumination drive signal with the gain of the simultaneous illumination gain amplifier 44, to the infrared-laser beam source 11 (switches the recording-illumination drive signal switch SW43 to the b-side). Here, the disc determination controller 51 selects the b-side of the recording-illumination drive signal switch SW43. Thus, no signal is output from the recording-illumination drive signal gain amplifier 45. As a result, the first adder 401 directly outputs the output of the reproduction-illumination drive signal gain amplifier 42. This is equivalent to the state in which the output of the reproduction-illumination drive signal gain amplifier 42 is directly the input of the illumination laser selector SW41.

The disc determination controller (disc determination unit) 51 further outputs a laser control mode switch signal to the laser controller (laser control unit) 54. When receiving the laser control mode switch signal from the disc determination controller (disc determination unit) 51, the laser controller (laser control unit) 54 outputs, to the LDD 40 (more specifically to the reproduction-illumination drive signal gain amplifier 42 of the LDD 40), a reproduction-illumination drive signal that causes the output level of the red-laser beam source 12 to be a predetermined output level for reproduction laser beams, and outputs, to the LDD 40 (more specifically to the simultaneous illumination gain amplifier 44 via the recording-illumination drive signal switch SW43 of the LDD 40), a recording-illumination drive signal that causes the output level of the infrared-laser beam source 11 to be the predetermined output level for reproduction laser beams. As a result, the optical disc 1 is illuminated simultaneously with a red laser beam and an infrared laser beam. Further, the disc determination controller (disc determination unit) 51 provides the focus actuator 34 with a drive signal to raise the objective lens 29 (move the objective lens 29 in a direction in which the distance between the objective lens 29 and the optical disc 1 decreases).

As shown in FIG. 2, the objective lens 29 has such optical characteristics that the infrared laser beam has a greater focal length than the red laser beam.

At timing T2, the focal point of the infrared laser beam passes through a surface of the CD (surface of the optical disc 1 facing the objective lens 29). When the beam passes through the surface, a focus error signal is obtained based on a signal output from the infrared-laser beam detector 23. More specifically, a focus error signal having a waveform indicated by W301 in FIG. 3 is output at around timing T2.

As shown in FIG. 2(a), the optical disc apparatus 100 uses the objective lens 29 that focuses the infrared laser beam at a more distant position than the red laser beam in the direction of the normal to the objective lens 29 (in the optical axis direction of the objective lens 29). Thus, the focal point of the red laser beam passes through the surface of the CD (surface of the optical disc 1 facing the objective lens 29) at timing T3. When the beam passes through the surface, a focus error signal is obtained based on a signal output from the red-laser beam detector 24. More specifically, a focus error signal having a waveform indicated by W303 in FIG. 3 is output at around timing T3.

At timing T4, the focal point of the infrared laser beam passes through an information recording surface of the CD (surface on which information is recorded). When the beam passes through the surface, a focus error signal is obtained based on a signal output from the infrared-laser beam detector 23. More specifically, a focus error signal having a waveform indicated by W302 in FIG. 3 is output at around timing T4. When the amplitude of this focus error signal exceeds a predetermined level L1, the disc determination controller (disc determination unit) 51 determines that the disc that has been mounted on the optical disc apparatus 100 is a CD.

When determining that the disc mounted is a CD, the disc determination controller (disc determination unit) 51 ends the disc determination operation.

### 1.2.2 Disc Determination Operation (DVD)

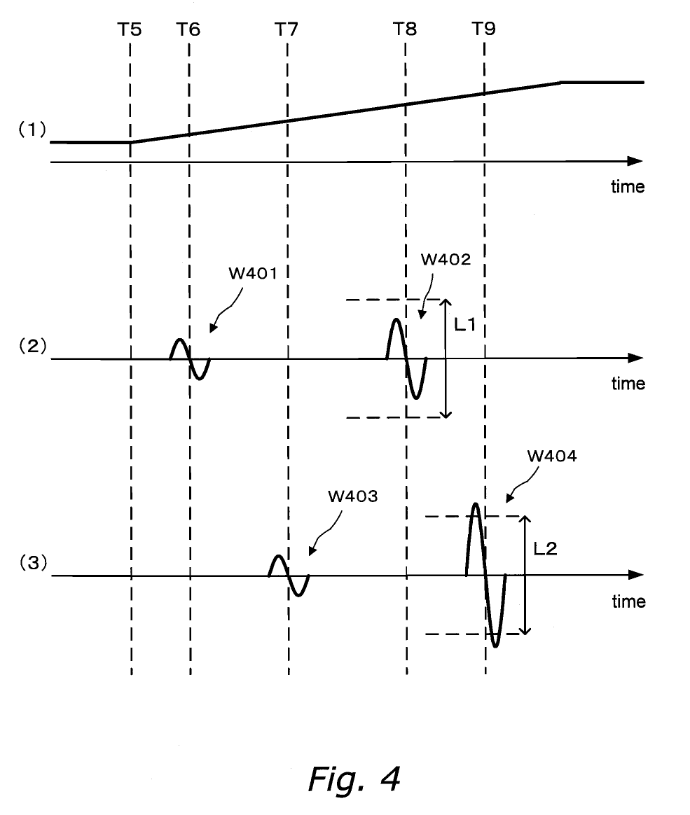

A disc determination operation using simultaneous illumination of a plurality of lasers for determining that a DVD has been mounted on the optical disc apparatus 100 will now be described in detail with reference to FIGS. 2 and 4.

FIG. 2(b) is a schematic view showing an optical disc 1 that is illuminated simultaneously with an infrared laser beam and a red laser beam, which are focused on the optical disc 1. The optical disc 1 is a DVD and has an information recording surface at about 0.6 mm from its surface (surface of the optical disc 1 facing the objective lens 29).

FIG. 4 shows the position of the objective lens 29 and the state of a focus error signal when the objective lens 29 is driven while the DVD is being illuminated simultaneously with an infrared laser beam and a red laser beam.

In FIG. 4, line (1) shows the position of the objective lens 29 as a function of time, where the horizontal axis indicates time and the vertical axis indicates the objective lens position. More specifically, line (1) in FIG. 4 represents signals showing the position of the objective lens 29 when the objective lens 29 is moved toward the DVD while the DVD is being illuminated simultaneously with a red laser beam and an infrared laser beam.

In FIG. 4, line (2) shows the level of a focus error signal as a function of time, where the horizontal axis indicates time and the vertical axis indicates the focus error signal level. More specifically, line (2) in FIG. 4 represents focus error signals (corresponding to signals transmitted on the signal line P1 in FIG. 1), which are generated by the servo signal generation circuit (servo signal generation unit) 56 based on the output of the infrared-laser beam detector 23 when the objective lens 29 is moved toward the DVD while the DVD is being illuminated simultaneously with a red laser beam and an infrared laser beam.

In FIG. 4, line (3) shows the level of a focus error signal as a function of time, where the horizontal axis indicates time and the vertical axis indicates the focus error signal level. More specifically, line (3) in FIG. 4 represents focus error signals (corresponding to signals transmitted on the signal line P2 in FIG. 1), which are generated by the servo signal generation circuit (servo signal generation unit) 56 based on the output of the red-laser beam detector 24 when the objective lens 29 is moved toward the DVD while the DVD is being illuminated simultaneously with a red laser beam and an infrared laser beam.

At timing T5 to start disc determination, the disc determination controller (disc determination unit) 51 starts its disc determination operation. The disc determination controller (disc determination unit) 51 switches the illumination laser selector SW41 of the LDD 40 in a manner that the LDD 40 outputs a signal for laser driving, which is a signal obtained by amplifying the reproduction-illumination drive signal with the gain of the reproduction-illumination drive signal gain amplifier 42, to the red-laser beam source 12 (switches the illumination laser selector SW41 to the c-side), and switches the recording-illumination drive signal switch SW43 of the LDD 40 in a manner that the LDD 40 outputs a signal for laser driving, which is a signal obtained by amplifying the recording-illumination drive signal with the gain of the simultaneous illumination gain amplifier 44, to the infrared-laser beam source 11 (switches the recording-illumination drive signal switch SW43 to the b-side). Here, the disc determination controller 51 selects the b-side of the recording-illumination drive signal switch SW43. Thus, no signal is output from the recording-illumination drive signal gain amplifier 45. As a result, the first adder 401 directly outputs the output of the reproduction-illumination drive signal gain amplifier 42. This is equivalent to the state in which the output of the reproduction-illumination drive signal gain amplifier 42 is directly the input of the illumination laser selector SW41.

The disc determination controller (disc determination unit) 51 further outputs a laser control mode switch signal to the laser controller (laser control unit) 54. When receiving the laser control mode switch signal from the disc determination controller (disc determination unit) 51, the laser controller (laser control unit) 54 outputs, to the LDD 40 (more specifically to the reproduction-illumination drive signal gain amplifier 42 of the LDD 40), a reproduction-illumination drive signal that causes the output level of the red-laser beam source 12 to be a predetermined output level for reproduction laser beams, and outputs, to the LDD 40 (more specifically to the simultaneous illumination gain amplifier 44 via the recording-illumination drive signal switch SW43 of the LDD 40), a recording-illumination drive signal that causes the output level of the infrared-laser beam source 11 to be the predetermined output level for reproduction laser beams. As a result, the optical disc 1 is illuminated simultaneously with a red laser beam and an infrared laser beam. Further, the disc determination controller (disc determination unit) 51 provides the focus actuator 34 with a drive signal to raise the objective lens 29 (move the objective lens 29 in a direction in which the distance between the objective lens 29 and the optical disc 1 decreases).

At timing T6, the focal point of the infrared laser beam passes through a surface of the DVD (surface of the optical disc 1 facing the objective lens 29). When the beam passes through the surface, a focus error signal is obtained based on a signal output from the infrared-laser beam detector 23. More specifically, a focus error signal having a waveform indicated by W401 in FIG. 4 is output at around timing T6.

As shown in FIG. 2(a), the optical disc apparatus 100 uses the objective lens 29 that focuses the infrared laser beam at a more distant position than the red laser beam in the direction of the normal to the objective lens 29 (in the optical axis direction of the objective lens 29). Thus, the focal point of the red laser beam passes through the surface of the DVD at timing T7. When the beam passes through the surface, a focus error signal is obtained based on a signal output from the red-laser beam detector 24. More specifically, a focus error signal having a waveform indicated by W403 in FIG. 4 is output at around timing T7.

At timing T8, the focal point of the infrared laser beam passes through an information recording surface of the DVD. When the beam passes through the surface, a focus error signal is obtained based on a signal output from the infrared-laser beam detector 23. More specifically, a focus error signal having a waveform indicated by W402 in FIG. 4 is output at around timing T8. The amplitude of this focus error signal does not exceed the predetermined level L1. Thus, the disc determination controller (disc determination unit) 51 continues the disc determination operation.

At timing T9, the focal point of the red laser beam passes through the information recording surface of the DVD. When the beam passes through the surface, a focus error signal is obtained based on a signal output from the red-laser beam detector 24. More specifically, a focus error signal having a waveform indicated by W404 in FIG. 4 is output at around timing T9. When the amplitude of this focus error signal exceeds a predetermined level L2, the disc determination controller (disc determination unit) 51 determines that the disc that has been mounted on the optical disc apparatus 100 is a DVD.

When determining that the disc mounted is a DVD, the disc determination controller (disc determination unit) 51 ends the disc determination operation.

As described above, the optical disc apparatus records or reproduces on a plurality of types of discs that differ from one another in the thickness of a substrate between the surface of the optical disc 1 (the surface of the optical disc 1 facing the objective lens 29) and the information recording surface of the optical disc 1 and that differ from one another in the corresponding laser wavelength. The optical disc apparatus determines the type of the optical disc to be one of a plurality of disc types through an objective lens operation performed only once while illuminating the optical disc simultaneously with a plurality of laser beams with different wavelengths. This optical disc apparatus requires only a shorter time for its disc type determination.

The recording-illumination drive signal used to cause recording laser illumination is used for reproduction. Thus, the simultaneous illumination is achieved simply by changing the internal structure of the LDD. This enables the optical disc apparatus 100 of the present invention to be formed without requiring any changes in circuits other than the LDD.

The laser beams used should not be limited to a red laser beam and an infrared laser beam, and any two laser beams with different wavelengths may be used.

Alternatively, three or more laser beams with different wavelengths may be used.

Although the present embodiment describes the case in which the optical disc apparatus 100 determines the type of a disc that has been mounted on the optical disc apparatus 100, the optical disc apparatus 100 may determine the type of each information recording surface included in the disc when the single disc has a plurality of information recording surfaces that differ from one another in the recording density or in the corresponding laser wavelength.

Although a different front light monitor is used to detect each laser beam with a different wavelength in the present embodiment, one front light monitor may be used commonly for the plurality of laser beams with different wavelengths. In this case, the apparatus may set the output of each laser at a low output.

When the recording-illumination drive signal is used to cause laser illumination in the disc determination operation, a high-frequency element may be superimposed on the recording-illumination drive signal.

Although the laser beam sources that are controlled based on the reproduction-illumination drive signal and the recording-illumination drive signal are fixed for these signals in the disc determination operation in the present embodiment, the laser beam sources to be controlled based on these signals may be selected freely.

### Second Embodiment

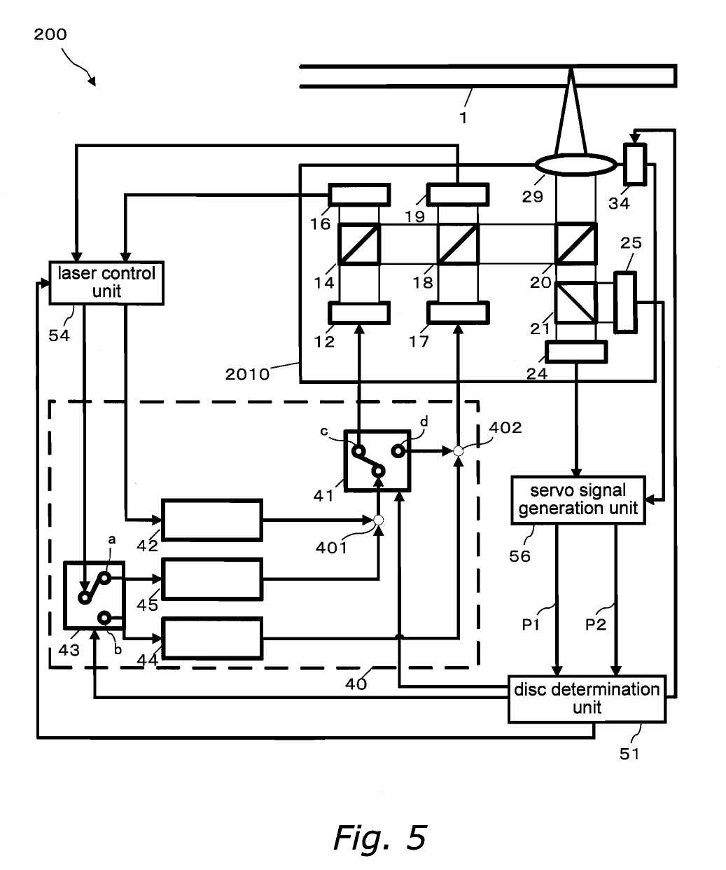

A second embodiment of the present invention will now be described with reference to FIGS. 5 to 8.

### 2.1 Structure of the Optical Disc Apparatus

FIG. 5 is a block diagram showing the structure of an optical disc apparatus 200 according to the second embodiment of the present invention.

The optical disc apparatus 200 includes a red-laser beam source 12, a red-laser beam splitter 14, a red-laser front light monitor 16, an illumination beam splitter 20, an objective lens 29, a focus actuator 34, a detector beam splitter 21, a red-laser beam detector 24, a servo signal generation circuit (servo signal generation unit) 56, an illumination laser selector SW41, a reproduction-illumination drive signal gain laser controller (laser control unit) 54, a disc determination controller (disc determination unit) 51, a recording-illumination drive signal switch SW43, a simultaneous illumination gain amplifier 44, and a recording-illumination drive signal gain amplifier 45.

The optical disc apparatus 200 further includes a blue-laser beam source 17, a blue-laser beam splitter 18, a blue-laser front light monitor 19, and a blue-laser beam detector 25.

In FIG. 5, an optical disc 1, the red-laser beam source 12, the red-laser beam splitter 14, the red-laser front light monitor 16, the illumination beam splitter 20, the objective lens 29, the focus actuator 34, the detector beam splitter 21, the red-laser beam detector 24, the servo signal generation circuit (servo signal generation unit) 56, the illumination laser selector SW41, and the reproduction-illumination drive signal gain laser controller (laser control unit) 54, the disc determination controller (disc determination unit) 51, the recording-illumination drive signal switch SW43, the simultaneous illumination gain amplifier 44, and the recording-illumination drive signal gain amplifier 45 have the same functions as the corresponding components of the conventional optical disc apparatus and the optical disc apparatus of the first embodiment and will not be described in detail in the present embodiment.

The optical disc apparatus 200 differs from the conventional optical disc apparatus and the optical disc apparatus of the first embodiment in its use of the blue-laser beam source 17, the blue-laser beam splitter 18, the blue-laser front light monitor 19, and the blue-laser beam detector. The optical disc apparatus 200 determines, in a short time, the type of the optical disc 1 that has been mounted on the optical disc apparatus 100 to be one of a plurality of disc types through an objective lens operation performed only once (operation for moving the objective lens 29 toward or away from the optical disc 1) while illuminating the optical disc 1 simultaneously with a plurality of laser beams with different wavelengths, and prevents information recorded on an information recording surface of the optical disc from being damaged.

The blue-laser beam source 17 emits a blue laser beam having a wavelength of about 405 nm. The blue-laser beam splitter 18 splits the blue laser beam toward the illumination beam splitter 20 and the blue-laser front light monitor 19. The blue-laser front light monitor 19 detects the output power of the blue laser beam that has entered the blue-laser front light monitor 19. The output of the blue-laser front light monitor 19 is input into the laser control unit 54.

The red-laser beam source 12 emits a red laser beam having a wavelength of about 650 nm. The red-laser beam splitter 14 splits the red laser beam toward the illumination beam splitter 20 and the red-laser front light monitor 16. The red-laser front light monitor 16 detects the output power of the red laser beam that has entered the red-laser front light monitor 16. The output of the red-laser front light monitor 16 is input into the laser control unit 54.

The red laser beam and the blue laser beam that have been split toward the illumination beam splitter 20 are reflected by the illumination beam splitter 20 in the direction of the objective lens 29. The beams are then focused by the objective lens 29 onto an information recording surface of the optical disc 1. The red laser beam and the blue laser beam are reflected by the optical disc 1, and the reflected beams pass through the illumination beam splitter 20. The red laser beam and the blue laser beam then pass through the detector beam splitter 21. Through the detector beam splitter 21, the red laser beam enters the red-laser beam detector 24, whereas the blue laser beam enters the blue-laser beam detector 25. The positional relationship between the red-laser beam detector 24 and the blue-laser beam detector 25 is determined by the optical characteristics of the detector beam splitter 21. In other words, the optical characteristics of the detector beam splitter 21 may be adjusted to reverse the positions of the red-laser beam detector 24 and the blue-laser beam detector 25 with respect to the positional relationship shown in FIG. 5.

During reproduction, the laser controller (laser control unit) 54 outputs, to the LDD 40, a reproduction-illumination drive signal that causes the output level of the red laser beam detected by the red-laser front light monitor 16 (the level of the output power of the red laser beam) and the output level of the blue laser beam detected by the blue-laser front light monitor 19 (the level of the output power of the blue laser beam) to be a predetermined output level for reproduction laser beams. During recording, the laser controller (laser control unit) 54 outputs, to the LDD 40, a reproduction-illumination drive signal and a recording-illumination drive signal that cause the output level of the red laser beam detected by the red-laser front light monitor 16 (the level of the output power of the red laser beam) and the output level of the blue laser beam detected by the blue-laser front light monitor 19 (the level of the output power of the blue laser beam) to be a predetermined output level for recording laser beams.

During reproduction, the LDD 40 outputs a signal for laser driving, which is a signal obtained by amplifying the reproduction-illumination drive signal with the gain of the reproduction-illumination drive signal gain amplifier 42, to the blue-laser beam source 17 or to the red-laser beam source 12. During recording, the LDD 40 outputs a signal for laser driving, which is a signal resulting from addition of a laser driving signal obtained by amplifying the reproduction-illumination drive signal with the gain of the reproduction-illumination drive signal gain amplifier 42 and a laser driving signal obtained by amplifying the recording-illumination drive signal with the gain of the recording-illumination drive signal gain amplifier 45, to the blue-laser beam source 17 or to the red-laser beam source 12.

The recording-illumination drive signal switch SW43 of the LDD 40 is normally set in a manner that the recording-illumination drive signal is provided to the recording-illumination drive signal gain amplifier 45. The recording-illumination drive signal switch SW43 receives, as its input, the output of the laser control unit 54, and outputs the received input to the recording-illumination drive signal gain amplifier 45 or to the simultaneous illumination gain amplifier 44 based on a control signal (signal indicating whether the disc determination operation is being performed) output from the disc determination unit 51. More specifically, the recording-illumination drive signal switch SW43 outputs the received input to the simultaneous illumination gain amplifier 44 while the disc determination operation is being performed and outputs the received input to the recording-illumination drive signal gain amplifier 45 in periods other than while the disc determination operation is being performed.

The disc determination controller (disc determination unit) 51 switches the illumination laser selector SW41 of the LDD 40 in a manner that the LDD 40 outputs a signal for laser driving, which is a signal obtained by amplifying the reproduction-illumination drive signal with the gain of the reproduction-illumination drive signal gain amplifier 42, to the red-laser beam source 12, and switches the recording-illumination drive signal switch SW43 of the LDD 40 in a manner that the LDD 40 outputs a signal for laser driving, which is a signal obtained by amplifying the recording-illumination drive signal with the gain of the simultaneous illumination gain amplifier 44, to the blue-laser beam source 17.

To perform the disc determination operation, the disc determination controller (disc determination unit) 51 switches the illumination laser selector SW41 in a manner that the LDD 40 outputs the reproduction-illumination drive signal that has been amplified by the reproduction-illumination drive signal gain amplifier 42 to the red-laser beam source 12 (switches the illumination laser selector SW41 to the c-side), and switches the recording-illumination drive signal switch SW43 in a manner that the LDD 40 outputs the recording-illumination drive signal that has been amplified by the simultaneous illumination gain amplifier 44 to the blue-laser beam source 17 (switches the recording-illumination drive signal switch SW43 to the b-side). This enables the optical disc apparatus 200 to illuminate the optical disc 1 simultaneously with a red laser beam and a blue laser beam.

The disc determination controller (disc determination unit) 51 further outputs a laser control mode switch signal for controlling the output of the red-laser beam source 12 and the output of the blue-laser beam source 17 to the laser controller (laser control unit) 54. When receiving the laser control mode switch signal from the disc determination controller (disc determination unit) 51, the laser controller (laser control unit) 54 outputs, to the LDD 40, a reproduction-illumination drive signal that causes the output level of the red-laser beam source 12 to be a predetermined output level for reproduction laser beams, and outputs, to the LDD 40, a recording-illumination drive signal that causes the output level of the blue-laser beam source 17 to be the predetermined output level for reproduction laser beams. As a result, the optical disc 1 is illuminated simultaneously with a red laser beam and a blue laser beam.

Further, the disc determination controller (disc determination unit) 51 outputs a drive signal for driving the objective lens 29 up and down (driving the objective lens 29 toward and away from the optical disc 1) to the focus actuator 34.

The servo signal generation circuit (servo signal generation unit) 56 generates a servo signal based on the output of the red-laser beam detector 24 and the blue-laser beam detector 25 and outputs the generated servo signal to the disc determination unit 51. The disc determination controller (disc determination unit) 51 determines the type of the disc that has been mounted on the optical disc apparatus 100 based on the servo signal, which is generated by the servo signal generation circuit (servo signal generation unit) 56.

The recording-illumination drive signal gain amplifier 45 of the LDD 40 has the amplification factor that is too high and the resolution that is too low for reproduction laser illumination. Thus, the simultaneous illumination gain amplifier 44 of the LDD 40 is used to amplify the recording and reproduction drive signals. In other words, the recording and reproduction drive signals are amplified by the simultaneous illumination gain amplifier 44, which has the amplification factor suitable for reproduction laser illumination, and the amplified recording and reproduction drive signals are then used to drive the blue-laser beam source 17.

The first adder 401, the second adder 402, the recording-illumination drive signal switch SW43, and the illumination laser selector SW41 are identical to the corresponding components described in the first embodiment and will not be described in detail in the present embodiment.

### 2.2 Operation of the Optical Disc Apparatus

### 2.2.1 Disc Determination Operation (DVD)

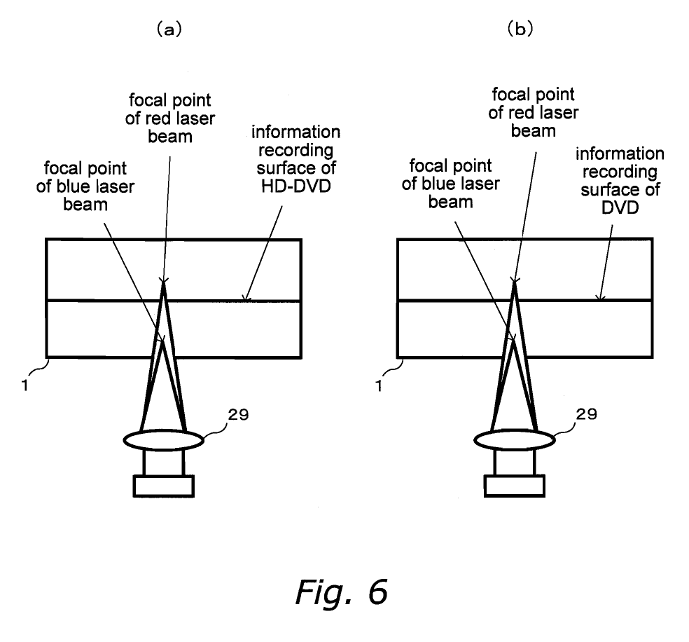

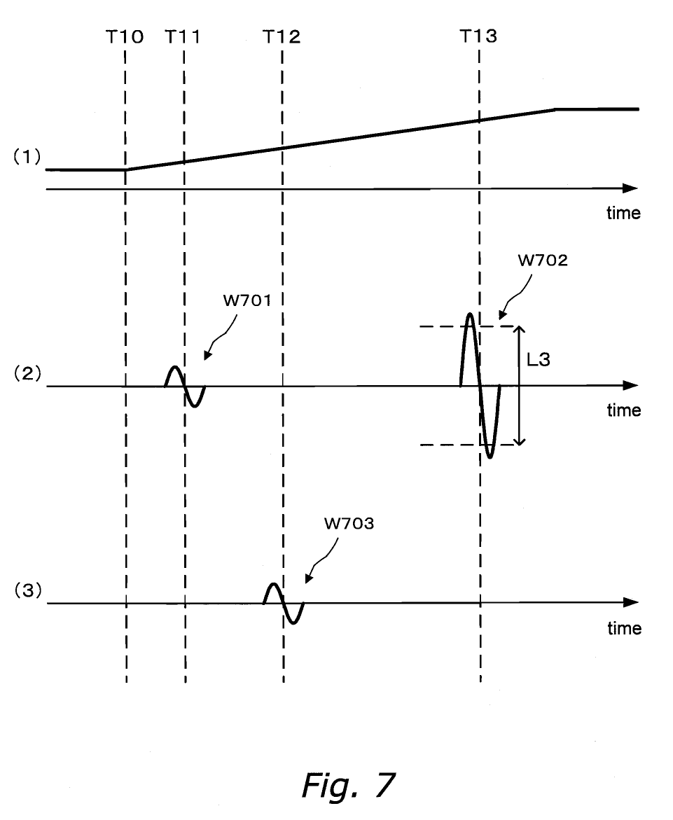

A disc determination operation using simultaneous illumination of a plurality of lasers for determining that a DVD has been mounted on the optical disc apparatus 200 will now be described in detail with reference to FIGS. 6 and 7.

FIG. 6(b) is a schematic view showing an optical disc 1 that is illuminated simultaneously with a blue laser beam and a red laser beam, which are focused on the optical disc 1. The optical disc 1 is a DVD and has an information recording surface at about 0.6 mm from its surface (surface of the optical disc 1 facing the objective lens 29).

FIG. 7 shows the position of the objective lens 29 and the state of a focus error signal in the optical disc apparatus 200 when the objective lens 29 is driven while the DVD is being illuminated simultaneously with a blue laser beam and a red laser beam.

In FIG. 7, line (1) shows the position of the objective lens 29 as a function of time, where the horizontal axis indicates time and the vertical axis indicates the objective lens position. More specifically, line (1) in FIG. 7 represents signals showing the position of the objective lens 29 when the objective lens 29 is moved toward the DVD while the DVD is being illuminated simultaneously with a red laser beam and a blue laser beam.

In FIG. 7, line (2) shows the level of a focus error signal as a function of time, where the horizontal axis indicates time and the vertical axis indicates the focus error signal level. More specifically, line (2) in FIG. 7 represents focus error signals (corresponding to signals transmitted on a signal line P1 in FIG. 5), which are generated by the servo signal generation circuit (servo signal generation unit) 56 based on the output of the red-laser beam detector 24 when the objective lens 29 is moved toward the DVD while the DVD is being illuminated simultaneously with a red laser beam and a blue laser beam.

In FIG. 7, line (3) shows the level of a focus error signal as a function of time, where the horizontal axis indicates time and the vertical axis indicates the focus error signal level. More specifically, line (3) in FIG. 7 represents focus error signals (corresponding to signals transmitted on a signal line P2 in FIG. 5), which are generated by the servo signal generation circuit (servo signal generation unit) 56 based on the output of the blue-laser beam detector 25 when the objective lens 29 is moved toward the DVD while the DVD is being illuminated simultaneously with a red laser beam and a blue laser beam.

At timing T10 to start disc determination, the disc determination controller (disc determination unit) 51 starts its disc determination operation. The disc determination controller (disc determination unit) 51 switches the illumination laser selector SW41 of the LDD 40 in a manner that the LDD 40 outputs a signal for laser driving, which is a signal obtained by amplifying the reproduction-illumination drive signal with the gain of the reproduction-illumination drive signal gain amplifier 42, to the red-laser beam source 12 (switches the illumination laser selector SW41 to the c-side), and switches the recording-illumination drive signal switch SW43 of the LDD 40 in a manner that the LDD 40 outputs a signal for laser driving, which is a signal obtained by amplifying the recording-illumination drive signal with the gain of the simultaneous illumination gain amplifier 44, to the blue-laser beam source 17 (switches the recording-illumination drive signal switch SW43 to the b-side). Here, the disc determination controller 51 selects the b-side of the recording-illumination drive signal switch SW43. Thus, no signal is output from the recording-illumination drive signal gain amplifier 45. As a result, the first adder 401 directly outputs the output of the reproduction-illumination drive signal gain amplifier 42. This is equivalent to the state in which the output of the reproduction-illumination drive signal gain amplifier 42 is directly the input of the illumination laser selector SW41.

The disc determination controller (disc determination unit) 51 further outputs a laser control mode switch signal to the laser controller (laser control unit) 54. When receiving the laser control mode switch signal from the disc determination controller (disc determination unit) 51, the laser controller (laser control unit) 54 outputs, to the LDD 40 (more specifically to the reproduction-illumination drive signal gain amplifier 42 of the LDD 40), a reproduction-illumination drive signal that causes the output level of the red-laser beam source 12 to be a predetermined output level for reproduction laser beams, and outputs, to the LDD 40 (more specifically to the simultaneous illumination gain amplifier 44 via the recording-illumination drive signal switch SW43 of the LDD 40), a recording-illumination drive signal that causes the output level of the blue-laser beam source 17 to be the predetermined output level for reproduction laser beams. As a result, the optical disc 1 is illuminated simultaneously with a red laser beam and a blue laser beam. Further, the disc determination controller (disc determination unit) 51 provides the focus actuator 34 with a drive signal to raise the objective lens 29 (move the objective lens 29 in a direction in which the distance between the objective lens 29 and the optical disc 1 decreases).

As shown in FIG. 6, the objective lens 29 has such optical characteristics that the red laser beam has a greater focal length than the blue laser beam.

At timing T11, the focal point of the red laser beam passes through a surface of the DVD (surface of the optical disc 1 facing the objective lens 29). When the beam passes through the surface, a focus error signal is obtained based on a signal output from the red-laser beam detector 24. More specifically, a focus error signal having a waveform indicated by W701 in FIG. 7 is output at around timing T11.

As shown in FIG. 6(b), the optical disc apparatus 200 uses the objective lens 29 that focuses the red laser beam at a more distant position than the blue laser beam in the direction of the normal to the objective lens 29 (in the optical axis direction of the objective lens 29). Thus, the focal point of the blue laser beam passes through the surface of the DVD (surface of the optical disc 1 facing the objective lens 29) at timing T12. When the beam passes through the surface, a focus error signal is obtained based on a signal output from the blue-laser beam detector 25. More specifically, a focus error signal having a waveform indicated by W703 in FIG. 7 is output at around timing T12.

At timing T13, the focal point of the red laser beam passes through an information recording surface of the DVD (surface on which information is recorded). When the beam passes through the surface, a focus error signal is obtained based on a signal output from the red-laser beam detector 24. More specifically, a focus error signal having a waveform indicated by W702 in FIG. 7 is output at around timing T13. When the amplitude of this focus error signal exceeds a predetermined level L3, the disc determination controller (disc determination unit) 51 determines that the disc that has been mounted on the optical disc apparatus 200 is a DVD.

When determining that the disc mounted is a DVD, the disc determination controller (disc determination unit) 51 ends the disc determination operation.

### 2.2.2 Disc Determination Operation (HD-DVD)

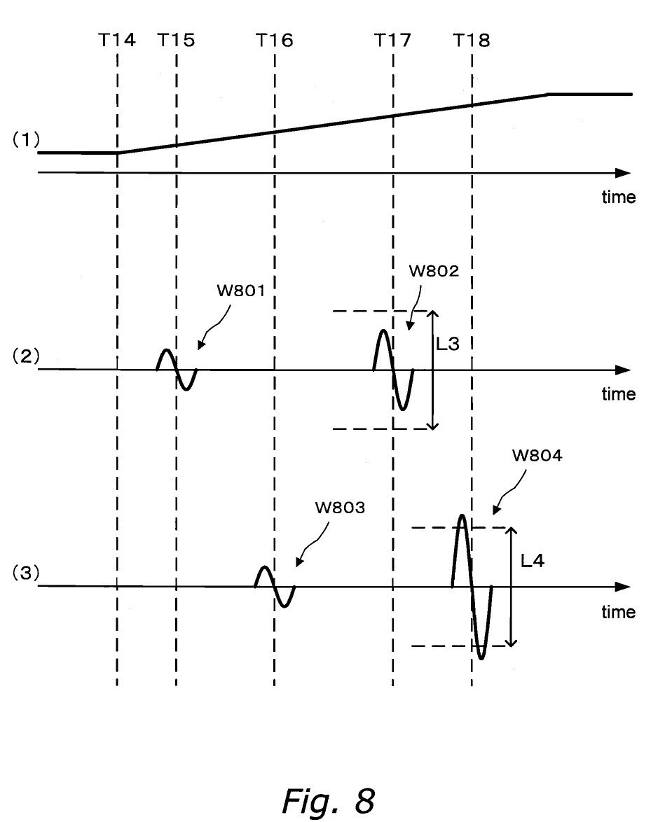

A disc determination operation using simultaneous illumination of a plurality of lasers for determining that an HD-DVD has been mounted on the optical disc apparatus 200 will now be described in detail with reference to FIGS. 6 and 8.

FIG. 6(a) is a schematic view showing an optical disc 1 that is illuminated simultaneously with a blue laser beam and a red laser beam, which are focused on the optical disc 1. The optical disc 1 is an HD-DVD and has an information recording surface at about 0.6 mm from its surface (surface of the optical disc 1 facing the objective lens 29).

FIG. 8 shows the position of the objective lens 29 and the state of a focus error signal when the objective lens 29 is driven while the HD-DVD is being illuminated simultaneously with a blue laser beam and a red laser beam.

In FIG. 8, line (1) shows the position of the objective lens 29 as a function of time, where the horizontal axis indicates time and the vertical axis indicates the objective lens position. More specifically, line (1) in FIG. 8 represents signals showing the position of the objective lens 29 when the objective lens 29 is moved toward the HD-DVD while the HD-DVD is being illuminated simultaneously with a red laser beam and a blue laser beam.

In FIG. 8, line (2) shows the level of a focus error signal as a function of time, where the horizontal axis indicates time and the vertical axis indicates the focus error signal level. More specifically, line (2) in FIG. 8 represents focus error signals, which are generated by the servo signal generation circuit (servo signal generation unit) 56 based on the output of the blue-laser beam detector 25 when the objective lens 29 is moved toward the HD-DVD while the HD-DVD is being illuminated simultaneously with a red laser beam and a blue laser beam.

In FIG. 8, line (3) shows the level of a focus error signal as a function of time, where the horizontal axis indicates time and the vertical axis indicates the focus error signal level. More specifically, line (3) in FIG. 8 represents focus error signals (corresponding to signals transmitted on the signal line P2 in FIG. 5), which are generated by the servo signal generation circuit (servo signal generation unit) 56 based on the output of the red-laser beam detector 24 when the objective lens 29 is moved toward the HD-DVD while the HD-DVD is being illuminated simultaneously with a red laser beam and a blue laser beam.

At timing T14 to start disc determination, the disc determination controller (disc determination unit) 51 starts its disc determination operation. The disc determination controller (disc determination unit) 51 switches the illumination laser selector SW41 of the LDD 40 in a manner that the LDD 40 outputs a signal for laser driving, which is a signal obtained by amplifying the reproduction-illumination drive signal with the gain of the reproduction-illumination drive signal gain amplifier 42, to the red-laser beam source 12 (switches the illumination laser selector SW41 to the c-side), and switches the recording-illumination drive signal switch SW43 of the LDD 40 in a manner that the LDD 40 outputs a signal for laser driving, which is a signal obtained by amplifying the recording-illumination drive signal with the gain of the simultaneous illumination gain amplifier 44, to the blue-laser beam source 17 (switches the recording-illumination drive signal switch SW43 to the b-side). Here, the disc determination controller 51 selects the b-side of the recording-illumination drive signal switch SW43. Thus, no signal is output from the recording-illumination drive signal gain amplifier 45. As a result, the first adder 401 directly outputs the output of the reproduction-illumination drive signal gain amplifier 42. This is equivalent to the state in which the output of the reproduction-illumination drive signal gain amplifier 42 is directly the input of the illumination laser selector SW41.

The disc determination controller (disc determination unit) 51 further outputs a laser control mode switch signal to the laser controller (laser control unit) 54. When receiving the laser control mode switch signal from the disc determination controller (disc determination unit) 51, the laser controller (laser control unit) 54 outputs, to the LDD 40 (more specifically to the reproduction-illumination drive signal gain amplifier 42 of the LDD 40), a reproduction-illumination drive signal that causes the output level of the red-laser beam source 12 to be a predetermined output level for reproduction laser beams, and outputs, to the LDD 40 (more specifically to the simultaneous illumination gain amplifier 44 via the recording-illumination drive signal switch SW43 of the LDD 40), a recording-illumination drive signal that causes the output level of the blue-laser beam source 17 to be the predetermined output level for reproduction laser beams. As a result, the optical disc 1 is illuminated simultaneously with a red laser beam and a blue laser beam. Further, the disc determination controller (disc determination unit) 51 provides the focus actuator 34 with a drive signal to raise the objective lens 29 (move the objective lens 29 in a direction in which the distance between the objective lens 29 and the optical disc 1 decreases).

As shown in FIG. 6, the objective lens 29 has such optical characteristics that the red laser beam has a greater focal length than the blue laser beam.

At timing T15, the focal point of the red laser beam passes through the surface of the HD-DVD (surface of the optical disc 1 facing the objective lens 29). When the beam passes through the surface, a focus error signal is obtained based on a signal output from the red-laser beam detector 24. More specifically, a focus error signal having a waveform indicated by W801 in FIG. 8 is output at around timing T15.

As shown in FIG. 6(a), the optical disc apparatus 200 uses the objective lens 29 that focuses the red laser beam at a more distant position than the blue laser beam in the direction of the normal to the objective lens 29 (in the optical axis direction of the objective lens 29). Thus, the focal point of the blue laser beam passes through the surface of the HD-DVD (surface of the optical disc 1 facing the objective lens 29) at timing T16. When the beam passes through the surface, a focus error signal is obtained based on a signal output from the blue-laser beam detector 25. More specifically, a focus error signal having a waveform indicated by W803 in FIG. 8 is output at around timing T16.

At timing T17, the focal point of the red laser beam passes through the surface of the HD-DVD (surface on which information is recorded). When the beam passes through the surface, a focus error signal is obtained based on a signal output from the red-laser beam detector 24. More specifically, a focus error signal having a waveform indicated by W802 in FIG. 8 is output at around timing T17. The amplitude of this focus error signal does not exceed a predetermined level L3. Thus, the disc determination controller (disc determination unit) 51 continues the disc determination operation.

At timing T18, the focal point of the blue laser beam passes through an information recording surface of the HD-DVD (surface on which information is recorded). When the beam passes through the surface, a focus error signal is obtained based on a signal output from the blue-laser beam detector 25. More specifically, a focus error signal having a waveform indicated by W804 in FIG. 8 is output at around timing T18. When the amplitude of this focus error signal exceeds a predetermined level L4, the disc determination controller (disc determination unit) 51 determines that the disc that has been mounted on the optical disc apparatus 200 is an HD-DVD.

When determining that the disc mounted is an HD-DVD, the disc determination controller (disc determination unit) 51 ends the disc determination operation.

As described above, the optical disc apparatus records or reproduces on a plurality of types of discs that are substantially identical to one another in the thickness of a substrate between the surface of the optical disc 1 (the surface of the optical disc 1 facing the objective lens 29) and the information recording surface of the optical disc 1 and that differ from one another in the corresponding laser wavelength. The optical disc apparatus determines the type of the optical disc to be one of a plurality of disc types through an objective lens operation performed only once (driving operation for moving the objective lens toward or away from the optical disc) while illuminating the optical disc simultaneously with a plurality of laser beams with different wavelengths. This optical disc apparatus requires only a shorter time for its disc type determination.

The optical disc apparatus uses the objective lens 29 that focuses the red laser beam having a long wavelength at a more distant position than the blue laser beam having a short wavelength in the direction of the normal to the objective lens 29 (in the optical axis direction of the objective lens 29). With the objective lens 29 having such optical characteristics, the blue laser beam is out of focus on the information recording surface of the DVD when the red laser beam is in focus on the DVD information recording surface. This prevents information recorded on the DVD information recording surface from being damaged.

The laser beams used should not be limited to a red laser beam and a blue laser beam, and any two laser beams with different wavelengths may be used.

Alternatively, three or more laser beams with different wavelengths may be used.

Although the present embodiment describes the case in which the optical disc apparatus 200 determines the type of a disc that has been mounted on the optical disc apparatus 200, the optical disc apparatus 200 may determine the type of each information recording surface included in the disc when the single disc has a plurality of information recording surfaces that differ from one another in the recording density or in the corresponding laser wavelength.

Although a different front light monitor is used to detect each laser beam with a different wavelength in the present embodiment, one front light monitor may be used commonly for the plurality of laser beams with different wavelengths. In this case, the apparatus may set the output of each laser at a low output.

Although the present embodiment describes the case in which the optical disc apparatus uses the objective lens 29 that focuses the red laser beam at a more distant position than the blue laser beam in the direction of the normal to the objective lens 29 (in the optical axis direction of the objective lens 29), the optical disc apparatus may use the objective lens 29 that focuses the red laser beam at a nearer position than the blue laser beam in the direction of the normal to the objective lens 29 (in the optical axis direction of the objective lens 29). In this case, the objective lens 29 is moved away from the surface vicinity of the optical disc 1 in the disc determination operation.

When the recording-illumination drive signal is used to cause laser illumination in the disc determination operation, a high-frequency element may be superimposed on the recording-illumination drive signal.

Although the laser beam sources that are controlled based on the reproduction-illumination drive signal and the recording-illumination drive signal are fixed for these signals in the disc determination operation in the present embodiment, the laser beam sources to be controlled based on these signals may be selected freely.

### Third Embodiment

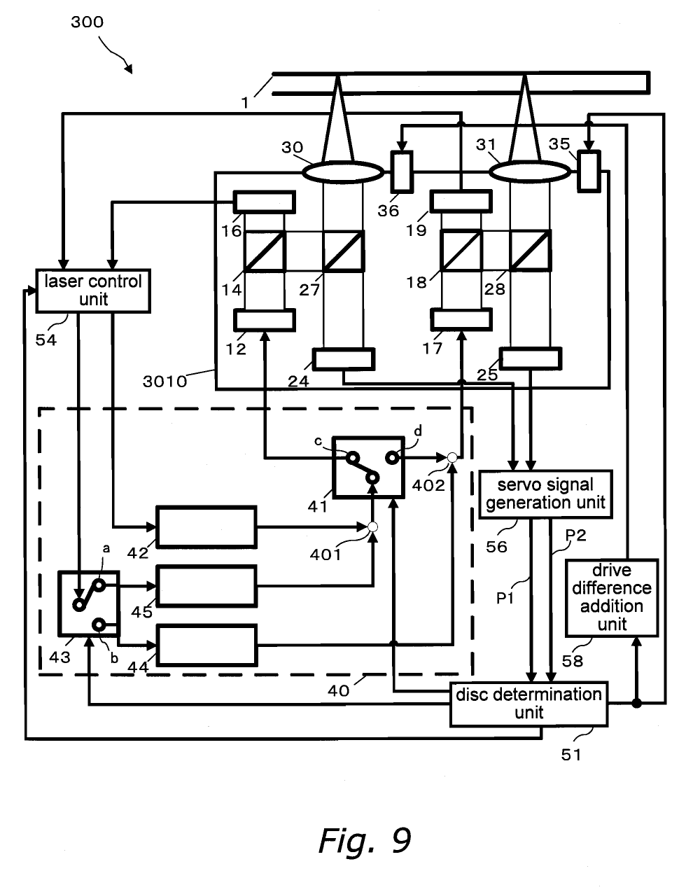

A third embodiment of the present invention will now be described with reference to FIGS. 9 to 12.

### 3.1 Structure of the Optical Disc Apparatus

FIG. 9 is a block diagram showing the structure of an optical disc apparatus 300 according to the third embodiment of the present invention.

The optical disc apparatus 300 includes a red-laser beam source 12, a red-laser beam splitter 14, a red-laser front light monitor 16, a blue-laser beam source 17, a blue-laser beam splitter 18, a blue-laser front light monitor 19, a blue-laser beam detector 25, a red-laser beam detector 24, a servo signal generation circuit (servo signal generation unit) 56, an illumination laser selector SW41, a reproduction-illumination drive signal gain laser controller (laser control unit) 54, a disc determination controller (disc determination unit) 51, a recording-illumination drive signal switch SW43, a simultaneous illumination gain amplifier 44, and a recording-illumination drive signal gain amplifier 45.

The optical disc apparatus 300 further includes a red-laser objective lens 30, a blue-laser objective lens 31, a red-laser illumination beam splitter 27, a blue-laser illumination beam splitter 28, a drive difference addition unit 58, a red-laser focus actuator 36, and a blue-laser focus actuator 35.

In FIG. 9, an optical disc 1, the red-laser beam source 12, the red-laser beam splitter 14, the red-laser front light monitor 16, the blue-laser beam source 17, the blue-laser beam splitter 18, the blue-laser front light monitor 19, the blue-laser beam detector 25, the red-laser beam detector 24, the servo signal generation circuit (servo signal generation unit) 56, the illumination laser selector SW41, the reproduction-illumination drive signal gain laser controller (laser control unit) 54, the disc determination controller (disc determination unit) 51, the recording-illumination drive signal switch SW43, the simultaneous illumination gain amplifier 44, and the recording-illumination drive signal gain amplifier 45 have the same functions as the corresponding components of the conventional optical disc apparatus and the optical disc apparatuses of the embodiments described above and will not be described in detail in the present embodiment.

The optical disc apparatus 300 differs from the conventional optical disc apparatus and the optical disc apparatuses of the embodiments described above in its use of the red-laser objective lens 30, the blue-laser objective lens 31, the red-laser illumination beam splitter 27, the blue-laser illumination beam splitter 28, the drive difference addition unit 58, the red-laser focus actuator 36, and the blue-laser focus actuator 35. The optical disc apparatus 300 determines, in a short time, the type of the optical disc to be one of a plurality of disc types through an objective lens operation performed only once while illuminating the optical disc simultaneously with a plurality of laser beams with different wavelengths, and prevents, in a safer manner, information recorded on the information recording surface of the optical disc from being damaged.

The blue-laser beam source 17 emits a blue laser beam having a wavelength of about 405 μm. The blue-laser beam splitter 18 splits the blue laser beam toward the blue-laser illumination beam splitter 28 and the blue-laser front light monitor 19. The blue-laser front light monitor 19 detects the output power of the blue laser beam that has entered the blue-laser front light monitor 19. The output of the blue-laser front light monitor 19 is input into the laser control unit 54.

The blue laser beam that has been split by the blue-laser illumination beam splitter 28 is reflected by the blue-laser illumination beam splitter 28 in the direction of the blue-laser objective lens 31. The beam is then focused by the blue-laser objective lens 31 onto the information recording surface of the optical disc 1. The blue laser beam is reflected by the optical disc 1, and the reflected beam passes through the blue-laser illumination beam splitter 28, and then enters the blue-laser beam detector 25.

The red-laser beam source 12 emits a red laser beam having a wavelength of about 650 nm. The red-laser beam splitter 14 splits the red laser beam toward the red-laser illumination beam splitter 27 and the red-laser front light monitor 16. The red-laser front light monitor 16 detects the output power of the red laser beam that has entered the red-laser front light monitor 16. The output of the red-laser front light monitor 16 is input into the laser control unit 54.

The red laser beam that has been split by the red-laser illumination beam splitter 27 is reflected by the red-laser illumination beam splitter 27 in the direction of the red-laser objective lens 30. The beam is then focused by the red-laser objective lens 30 onto the information recording surface of the optical disc 1. The red laser beam is reflected by the optical disc 1, and the reflected beam passes through the red-laser illumination beam splitter 27, and then enters the red-laser beam detector 24.

The blue-laser objective lens 31 is driven by the blue-laser focus actuator 35. The red-laser objective lens 30 is driven by the red-laser focus actuator 36.

During reproduction, the laser controller (laser control unit) 54 outputs, to the LDD 40, a reproduction-illumination drive signal that causes the output level of the red laser beam detected by the red-laser front light monitor 16 (the level of the output power of the red laser beam) and the output level of the blue laser beam detected by the blue-laser front light monitor 19 (the level of the output power of the blue laser beam) to be a predetermined output level for reproduction laser beams. During recording, the laser controller (laser control unit) 54 outputs, to the LDD 40, a reproduction-illumination drive signal and a recording-illumination drive signal that cause the output level of the red laser beam detected by the red-laser front light monitor 16 (the level of the output power of the red laser beam) and the output level of the blue laser beam detected by the blue-laser front light monitor 19 (the level of the output power of the blue laser beam) to be a predetermined output level for recording laser beams.

During reproduction, the LDD 40 outputs a signal for laser driving, which is a signal obtained by amplifying the reproduction-illumination drive signal with the gain of the reproduction-illumination drive signal gain amplifier 42, to the blue-laser beam source 17 or to the red-laser beam source 12. During recording, the LDD 40 outputs a signal for laser driving, which is a signal resulting from addition of a laser driving signal obtained by amplifying the reproduction-illumination drive signal with the gain of the reproduction-illumination drive signal gain amplifier 42 and a laser driving signal obtained by amplifying the recording-illumination drive signal with the gain of the recording-illumination drive signal gain amplifier 45, to the blue-laser beam source 17 or to the red-laser beam source 12.

The recording-illumination drive signal switch SW43 of the LDD 40 is normally set in a manner that the recording-illumination drive signal is provided to the recording-illumination drive signal gain amplifier 45. The recording-illumination drive signal switch SW43 receives, as its input, the output of the laser control unit 54, and outputs the received input to the recording-illumination drive signal gain amplifier 45 or to the simultaneous illumination gain amplifier 44 based on a control signal (signal indicating whether the disc determination operation is being performed) output from the disc determination unit 51. More specifically, the recording-illumination drive signal switch SW43 outputs the received input to the simultaneous illumination gain amplifier 44 while the disc determination operation is being performed and outputs the received input to the recording-illumination drive signal gain amplifier 45 in periods other than while the disc determination operation is being performed.

The disc determination controller (disc determination unit) 51 switches the illumination laser selector SW41 of the LDD 40 in a manner that the LDD 40 outputs a signal for laser driving, which is a signal obtained by amplifying the reproduction-illumination drive signal with the gain of the reproduction-illumination drive signal gain amplifier 42, to the red-laser beam source 12, and switches the recording-illumination drive signal switch SW43 of the LDD 40 in a manner that the LDD 40 outputs a signal for laser driving, which is a signal obtained by amplifying the recording-illumination drive signal with the gain of the simultaneous illumination gain amplifier 44, to the blue-laser beam source 17.

To perform the disc determination operation, the disc determination controller (disc determination unit) 51 switches the illumination laser selector SW41 in a manner that the LDD 40 outputs the reproduction-illumination drive signal that has been amplified by the reproduction-illumination drive signal gain amplifier 42 to the red-laser beam source 12 (switches the illumination laser selector SW41 to the c-side), and switches the recording-illumination drive signal switch SW43 in a manner that the LDD 40 outputs the recording-illumination drive signal that has been amplified by the simultaneous illumination gain amplifier 44 to the blue-laser beam source 17 (switches the recording-illumination drive signal switch SW43 to the b-side). This enables the optical disc apparatus 300 to illuminate the optical disc 1 simultaneously with a red laser beam and a blue laser beam.

The disc determination controller (disc determination unit) 51 further outputs a laser control mode switch signal for controlling the output of the red-laser beam source 12 and the output of the blue-laser beam source 17 to the laser controller (laser control unit) 54. When receiving the laser control mode switch signal from the disc determination controller (disc determination unit) 51, the laser controller (laser control unit) 54 outputs, to the LDD 40, a reproduction-illumination drive signal that causes the output level of the red-laser beam source 12 to be a predetermined output level for reproduction laser beams, and outputs, to the LDD 40, a recording-illumination drive signal that causes the output level of the blue-laser beam source 17 to be the predetermined output level for reproduction laser beams. As a result, the optical disc 1 is illuminated simultaneously with a red laser beam and a blue laser beam.

Further, the disc determination controller (disc determination unit) 51 outputs a drive signal for driving the blue-laser objective lens 31 and the red-laser objective lens 30 up and down (driving the objective lenses 31 and 30 toward and away from the optical disc 1) to the drive difference addition unit 58 and the blue-laser focus actuator 35. The drive difference addition unit 58 adds a signal having a predetermined level to the drive output (drive signal) from the disc determination controller (disc determination unit) 51, and outputs the resulting signal to the red-laser focus actuator 36.

The servo signal generation circuit (servo signal generation unit) 56 generates a servo signal based on the output of the red-laser beam detector 24 and the blue-laser beam detector 25 and outputs the generated servo signal to the disc determination unit 51. The disc determination controller (disc determination unit) 51 determines the type of the disc that has been mounted on the optical disc apparatus 300 based on the servo signal, which is generated by the servo signal generation circuit (servo signal generation unit) 56.

The recording-illumination drive signal gain amplifier 45 of the LDD 40 has the amplification factor that is too high and the resolution that is too low for reproduction laser illumination. Thus, the simultaneous illumination gain amplifier 44 of the LDD 40 is used to amplify the recording and reproduction drive signals. In other words, the recording and reproduction drive signals are amplified by the simultaneous illumination gain amplifier 44, which has the amplification factor suitable for reproduction laser illumination, and the amplified recording and reproduction drive signals are then used to drive the blue-laser beam source 17.

The first adder 401, the second adder 402, the recording-illumination drive signal switch SW43, and the illumination laser selector SW41 are identical to the corresponding components in the first embodiment and will not be described in detail in the present embodiment.

### 3.2 Operation of the Optical Disc Apparatus

### 3.2.1 Disc Determination Operation (DVD)

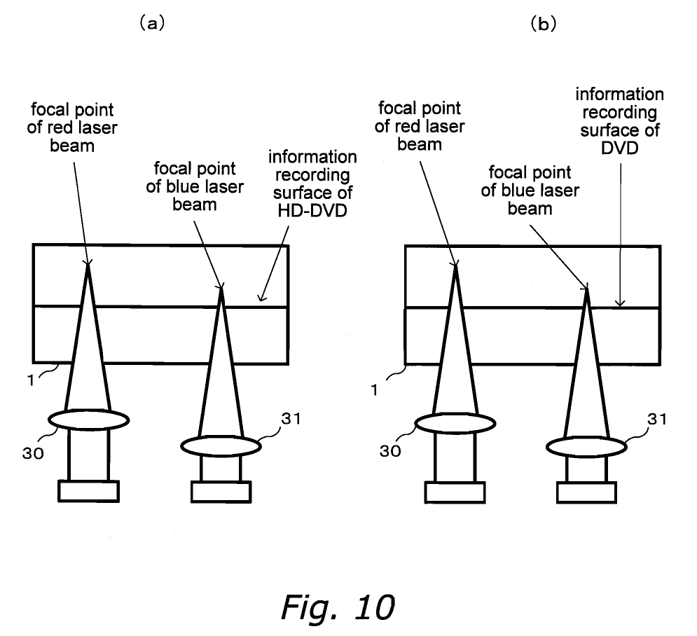

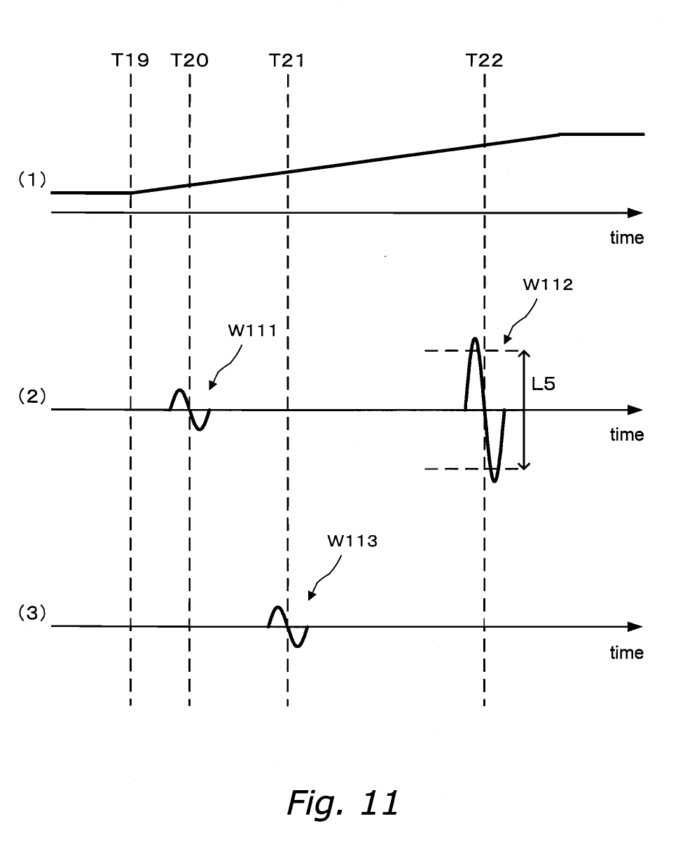

A disc determination operation using simultaneous illumination of a plurality of lasers for determining that a DVD has been mounted on the optical disc apparatus 300 will now be described in detail with reference to FIGS. 10 and 11.

FIG. 10(b) is a schematic view showing an optical disc 1 that is illuminated simultaneously with a blue laser beam and a red laser beam, which are focused on the optical disc 1. The optical disc 1 is a DVD and has an information recording surface at about 0.6 mm from its surface (surface of the optical disc 1 facing the objective lenses 30 and 31).

FIG. 11 shows the position of the red-laser objective lens 30 and the state of a focus error signal in the optical disc apparatus 300 when the blue-laser objective lens 31 and the red-laser objective lens 30 are driven while the DVD is being illuminated simultaneously with a blue laser beam and a red laser beam.

In FIG. 11, line (1) shows the position of the red-laser objective lens 30 as a function of time, where the horizontal axis indicates time and the vertical axis indicates the red-laser objective lens position. More specifically, line (1) in FIG. 11 represents signals showing the position of the red-laser objective lens 30 when the blue-laser objective lens 31 and the red-laser objective lens 30 are moved toward the DVD while the DVD is being illuminated simultaneously with a red laser beam and a blue laser beam.

In FIG. 11, line (2) shows the level of a focus error signal as a function of time, where the horizontal axis indicates time and the vertical axis indicates the focus error signal level. More specifically, line (2) in FIG. 11 represents focus error signals (corresponding to signals transmitted on a signal line P1 in FIG. 9), which are generated by the servo signal generation circuit (servo signal generation unit) 56 based on the output of the red-laser beam detector 24 when the blue-laser objective lens 31 and the red-laser objective lens 30 are moved toward the DVD while the DVD is being illuminated simultaneously with a red laser beam and a blue laser beam.

In FIG. 11, line (3) shows the level of a focus error signal as a function of time, where the horizontal axis indicates time and the vertical axis indicates the focus error signal level. More specifically, line (3) in FIG. 11 represents focus error signals (corresponding to signals transmitted on a signal line P2 in FIG. 9), which are generated by the servo signal generation circuit (servo signal generation unit) 56 based on the output of the blue-laser beam detector 25 when the blue-laser objective lens 31 and the red-laser objective lens 30 are moved toward the DVD while the DVD is being illuminated simultaneously with a red laser beam and a blue laser beam.

At timing T19 to start disc determination, the disc determination controller (disc determination unit) 51 starts its disc determination operation. The disc determination controller (disc determination unit) 51 switches the illumination laser selector SW41 of the LDD 40 in a manner that the LDD 40 outputs a signal for laser driving, which is a signal obtained by amplifying the reproduction-illumination drive signal with the gain of the reproduction-illumination drive signal gain amplifier 42, to the red-laser beam source 12 (switches the illumination laser selector SW41 to the c-side), and switches the recording-illumination drive signal switch SW43 of the LDD 40 in a manner that the LDD 40 outputs a signal for laser driving, which is a signal obtained by amplifying the recording-illumination drive signal with the gain of the simultaneous illumination gain amplifier 44, to the blue-laser beam source 17 (switches the recording-illumination drive signal switch SW43 to the b-side). Here, the disc determination controller 51 selects the b-side of the recording-illumination drive signal switch SW43. Thus, no signal is output from the recording-illumination drive signal gain amplifier 45. As a result, the first adder 401 directly outputs the output of the reproduction-illumination drive signal gain amplifier 42. This is equivalent to the state in which the output of the reproduction-illumination drive signal gain amplifier 42 is directly the input of the illumination laser selector SW41.

The disc determination controller (disc determination unit) 51 further outputs a laser control mode switch signal to the laser controller (laser control unit) 54. When receiving the laser control mode switch signal from the disc determination controller (disc determination unit) 51, the laser controller (laser control unit) 54 outputs, to the LDD 40 (more specifically to the reproduction-illumination drive signal gain amplifier 42 of the LDD 40), a reproduction-illumination drive signal that causes the output level of the red-laser beam source 12 to be a predetermined output level for reproduction laser beams, and outputs, to the LDD 40 (more specifically to the simultaneous illumination gain amplifier 44 via the recording-illumination drive signal switch SW43 of the LDD 40), a recording-illumination drive signal that causes the output level of the blue-laser beam source 17 to be the predetermined output level for reproduction laser beams. As a result, the optical disc 1 is illuminated simultaneously with a red laser beam and a blue laser beam. Further, the disc determination controller (disc determination unit) 51 outputs a drive signal to raise the blue-laser objective lens 31 and the red-laser objective lens 30.

The red-laser focus actuator 36 raises the red-laser objective lens 30 (moves the red-laser objective lens 30 toward the optical disc 1) based on a drive signal that has been obtained by the drive difference addition unit 58 adding a predetermined drive amount to the drive signal output from the disc determination controller (disc determination unit) 51.

The blue-laser focus actuator 35 raises the blue-laser objective lens 31 (moves the blue-laser objective lens 31 toward the optical disc 1) based on the drive signal output from the disc determination controller (disc determination unit) 51.

At timing T20, the focal point of the red laser beam passes through a surface of the DVD (surface of the optical disc 1 facing the objective lenses 30 and 31). When the beam passes through the surface, a focus error signal is obtained based on a signal output from the red-laser beam detector 24. More specifically, a focus error signal having a waveform indicated by W111 in FIG. 11 is output at around timing T20.

As shown in FIG. 10(b), the drive offset value of the drive difference addition unit 58 is set in a manner that the red-laser objective lens 30 focuses the red laser beam at a more distant position than the blue laser beam focused by the blue-laser objective lens 31 in the directions of the normals to the red-laser objective lens 30 and the blue-laser objective lens 31 (in the optical axis directions of the red-laser objective lens 30 and the blue-laser objective lens 31). Thus, the focal point of the blue laser beam passes through the surface of the DVD (surface of the optical disc 1 facing the objective lenses 30 and 31) at timing T21. When the beam passes through the surface, a focus error signal is obtained based on a signal output from the blue-laser beam detector 25. More specifically, a focus error signal having a waveform indicated by W113 in FIG. 11 is output at around timing T21. A time difference between timings T21 and T20 in FIG. 11 is determined by the drive offset value set in the drive difference addition unit 58, the speed at which each of the red-laser objective lens 30 and the blue-laser objective lens 31 is moved toward the optical disc 1, and the focal length of each of the red-laser objective lens 30 and the blue-laser objective lens 31 (the speed at which the red-laser objective lens 30 is moved toward the optical disc 1 and the speed at which the blue-laser objective lens 31 is moved toward the optical disc 1 are normally the same).

At timing T22, the focal point of the red laser beam passes through an information recording surface of the DVD. When the beam passes through the surface, a focus error signal is obtained based on a signal output from the red-laser beam detector 24. More specifically, a focus error signal having a waveform indicated by W112 in FIG. 11 is output at around timing T22. When the amplitude of this focus error signal exceeds a predetermined level L5, the disc determination controller (disc determination unit) 51 determines that the disc that has been mounted on the optical disc apparatus 300 is a DVD.

When determining that the disc mounted is a DVD, the disc determination controller (disc determination unit) 51 ends the disc determination operation.

### 3.2.2 Disc Determination Operation (HD-DVD)

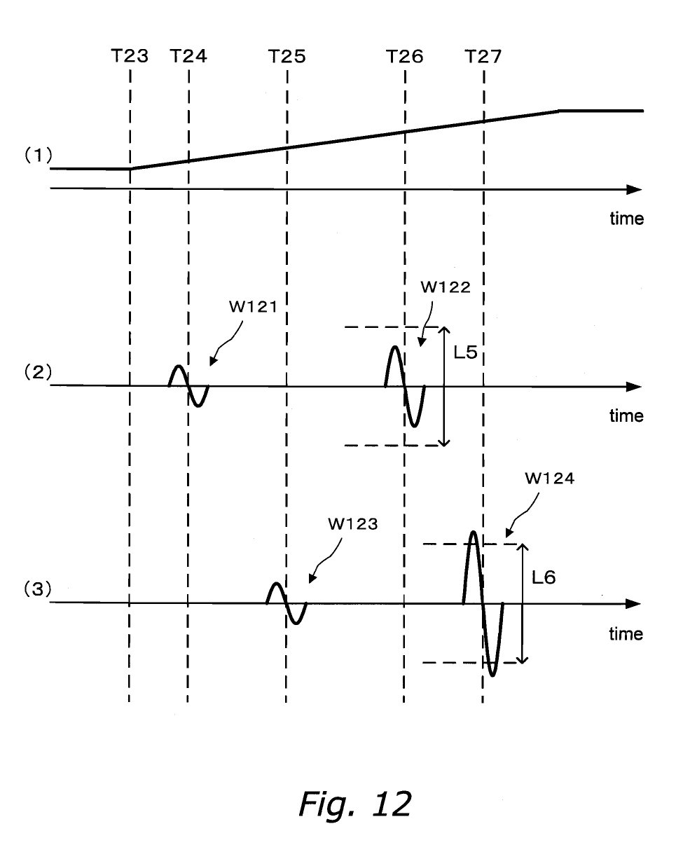

A disc determination operation using simultaneous illumination of a plurality of lasers for determining that an HD-DVD has been mounted on the optical disc apparatus 300 will now be described in detail with reference to FIGS. 10 and 12.

FIG. 10(a) is a schematic view showing an optical disc 1 that is illuminated simultaneously with a blue laser beam and a red laser beam, which are focused on the optical disc 1. The optical disc 1 is an HD-DVD and has an information recording surface at about 0.6 mm from its surface (surface of the optical disc 1 facing the objective lenses 30 and 31).

FIG. 12 shows the position of the red-laser objective lens 30 and the state of a focus error signal when the blue-laser objective lens 31 and the red-laser objective lens 30 are driven while the HD-DVD is being illuminated simultaneously with a blue laser beam and a red laser beam.

In FIG. 12, line (1) shows the position of the red-laser objective lens 30 as a function of time, where the horizontal axis indicates time and the vertical axis indicates the red-laser objective lens position. More specifically, line (1) in FIG. 12 represents signals showing the position of the red-laser objective lens 30 when the blue-laser objective lens 31 and the red-laser objective lens 30 are moved toward the HD-DVD while the HD-DVD is being illuminated simultaneously with a red laser beam and a blue laser beam.

In FIG. 12, line (2) shows the level of a focus error signal as a function of time, where the horizontal axis indicates time and the vertical axis indicates the focus error signal level. More specifically, line (2) in FIG. 12 represents focus error signals (corresponding to signals transmitted on the signal line P1 in FIG. 9), which are generated by the servo signal generation circuit (servo signal generation unit) 56 based on the output of the red-laser beam detector 24 when the blue-laser objective lens 31 and the red-laser objective lens 30 are moved toward the HD-DVD while the HD-DVD is being illuminated simultaneously with a red laser beam and a blue laser beam.

In FIG. 12, line (3) shows the level of a focus error signal as a function of time, where the horizontal axis indicates time and the vertical axis indicates the focus error signal level. More specifically, line (3) in FIG. 12 represents focus error signals (corresponding to signals transmitted on the signal line P2 in FIG. 9), which are generated by the servo signal generation circuit (servo signal generation unit) 56 based on the output of the blue-laser beam detector 25 when the blue-laser objective lens 31 and the red-laser objective lens 30 are moved toward the HD-DVD while the HD-DVD is being illuminated simultaneously with a red laser beam and a blue laser beam.

At timing T23 to start disc determination, the disc determination controller (disc determination unit) 51 starts its disc determination operation. The disc determination controller (disc determination unit) 51 switches the illumination laser selector SW41 of the LDD 40 in a manner that the LDD 40 outputs a signal for laser driving, which is a signal obtained by amplifying the reproduction-illumination drive signal with the gain of the reproduction-illumination drive signal gain amplifier 42, to the red-laser beam source 12 (switches the illumination laser selector SW41 to the c-side), and switches the recording-illumination drive signal switch SW43 of the LDD 40 in a manner that the LDD 40 outputs a signal for laser driving, which is a signal obtained by amplifying the recording-illumination drive signal with the gain of the simultaneous illumination gain amplifier 44, to the blue-laser beam source 17 (switches the recording-illumination drive signal switch SW43 to the b-side). Here, the disc determination controller 51 selects the b-side of the recording-illumination drive signal switch SW43. Thus, no signal is output from the recording-illumination drive signal gain amplifier 45. As a result, the first adder 401 directly outputs the output of the reproduction-illumination drive signal gain amplifier 42. This is equivalent to the state in which the output of the reproduction-illumination drive signal gain amplifier 42 is directly the input of the illumination laser selector SW41.

The disc determination controller (disc determination unit) 51 further outputs a laser control mode switch signal to the laser controller (laser control unit) 54. When receiving the laser control mode switch signal from the disc determination controller (disc determination unit) 51, the laser controller (laser control unit) 54 outputs, to the LDD 40 (more specifically to the reproduction-illumination drive signal gain amplifier 42 of the LDD 40), a reproduction-illumination drive signal that causes the output level of the red-laser beam source 12 to be a predetermined output level for reproduction laser beams, and outputs, to the LDD 40 (more specifically to the simultaneous illumination gain amplifier 44 via the recording-illumination drive signal switch SW43 of the LDD 40), a recording-illumination drive signal that causes the output level of the blue-laser beam source 17 to be the predetermined output level for reproduction laser beams. As a result, the optical disc 1 is illuminated simultaneously with a red laser beam and a blue laser beam.

Further, the disc determination controller (disc determination unit) 51 outputs a drive signal to raise the blue-laser objective lens 31 and the red-laser objective lens 30.

The red-laser focus actuator 36 raises the red-laser objective lens 30 (moves the red-laser objective lens 30 toward the optical disc 1) based on a drive signal that has been obtained by the drive difference addition unit 58 adding a predetermined drive amount to the drive signal output from the disc determination controller (disc determination unit) 51.

The blue-laser focus actuator 35 raises the blue-laser objective lens 31 (moves the blue-laser objective lens 31 toward the optical disc 1) based on the drive signal output from the disc determination controller (disc determination unit) 51.

At timing T24, the focal point of the red laser beam passes through a surface of the HD-DVD (surface of the optical disc 1 facing the objective lenses 30 and 31). When the beam passes through the surface, a focus error signal is obtained based on a signal output from the red-laser beam detector 24. More specifically, a focus error signal having a waveform indicated by W121 in FIG. 12 is output at around timing T24.

As shown in FIG. 10(a), the drive offset value of the drive difference addition unit 58 is set in a manner that the red-laser objective lens 30 focuses the red laser beam at a more distant position than the blue laser beam focused by the blue-laser objective lens 31 in the directions of the normals to the red-laser objective lens 30 and the blue-laser objective lens 31 (in the optical axis directions of the red-laser objective lens 30 and the blue-laser objective lens 31). Thus, the focal point of the blue laser beam passes through the surface of the HD-DVD (surface of the optical disc 1 facing the objective lenses 30 and 31) at timing T25. When the beam passes through the surface, a focus error signal is obtained based on a signal output from the blue-laser beam detector 25. More specifically, a focus error signal having a waveform indicated by W123 in FIG. 12 is output at around timing T25.

At timing T26, the focal point of the red laser beam passes through an information recording surface of the HD-DVD. When the beam passes through the surface, a focus error signal is obtained based on a signal output from the red-laser beam detector 24. More specifically, a focus error signal having a waveform indicated by W122 in FIG. 12 is output at around timing T26. The amplitude of this focus error signal does not exceed a predetermined level L5. Thus, the disc determination controller (disc determination unit) 51 continues the disc determination operation.

At timing T27, the focal point of the blue laser beam passes through the information recording surface of the HD-DVD. When the beam passes through the surface, a focus error signal is obtained based on a signal output from the blue-laser beam detector 25. More specifically, a focus error signal having a waveform indicated by W124 in FIG. 12 is output at around timing T27. When the amplitude of this focus error signal exceeds a predetermined level L6, the disc determination controller (disc determination unit) 51 determines that the disc that has been mounted on the optical disc apparatus 300 is an HD-DVD.

When determining that the disc mounted is an HD-DVD, the disc determination controller (disc determination unit) 51 ends the disc determination operation.

As described above, the optical disc apparatus records or reproduces on a plurality of types of discs that are substantially identical to one another in the thickness of a substrate between the surface of the optical disc 1 (the surface of the optical disc 1 facing the objective lenses 30 and 31) and the information recording surface of the optical disc 1 and that differ from one another in the corresponding laser wavelength. The optical disc apparatus determines the type of the optical disc to be one of a plurality of disc types through an objective lens operation performed only once (driving operation for moving the objective lenses toward or away from the optical disc) while illuminating the optical disc simultaneously with a plurality of laser beams with different wavelengths. This optical disc apparatus requires only a shorter time for its disc type determination.

The optical disc apparatus includes the two objective lenses (the red-laser objective lens 30 and the blue-laser objective lens 31), which can be driven separately. The two objective lenses have a drive difference between them that causes the red laser beam having a long wavelength to be focused at a more distant position than the blue laser beam having a short wavelength in the directions of the normals to the objective lenses 30 and 31 (in the optical axis directions of the red-laser objective lens 30 and the blue-laser objective lens 31). With the objective lenses having such optical characteristics, the blue laser beam is out of focus on the information recording surface of the DVD when the red laser beam is in focus on the DVD information recording surface. This prevents information recorded on the DVD information recording surface from being damaged.

The optical disc apparatus includes the two objective lenses (the objective lenses 30 and 31) that can be driven separately, and can freely set a difference in the focal point between the two objective lenses (freely set the focal point positions of the two objective lenses). The optical disc apparatus with this structure prevents information recorded on the information recording surface from being damaged in a more safe manner than the structure including only a single objective lens.

The laser beams used should not be limited to a red laser beam and a blue laser beam, and any two laser beams with different wavelengths may be used.

Alternatively, three or more laser beams with different wavelengths may be used.

Although the present embodiment describes the case in which the optical disc apparatus 300 determines the type of a disc that has been mounted on the optical disc apparatus 300, the optical disc apparatus 300 may determine the type of each information recording surface included in the disc when the single disc has a plurality of information recording surfaces that differ from one another in the recording density or in the corresponding laser wavelength.

Although a different front light monitor is used to detect each laser beam with a different wavelength in the present embodiment, one front light monitor may be used commonly for the plurality of laser beams with different wavelengths. In this case, the apparatus may set the output of each laser at a low output.

Although the present embodiment describes the case in which the drive offset value of the drive difference addition unit 58 is set in a manner that the objective lens 30 focuses the red laser beam at a more distant position than the blue laser beam focused by the objective lens 31 in the directions of the normals to the objective lenses 30 and 31 (in the optical axis directions of the red-laser objective lens 30 and the blue-laser objective lens 31), the drive offset value of the drive difference addition unit 58 may be set in a manner that the objective lens 30 focuses the red laser beam at a nearer position than the blue laser beam focused by the objective lens 31 in the directions of the normals to the objective lenses 30 and 31 (in the optical axis directions of the red-laser objective lens 30 and the blue-laser objective lens 31). In this case, the blue-laser objective lens 31 and the red-laser objective lens 30 are moved away from the surface vicinity of the optical disc 1 in the disc determination operation.

When the recording-illumination drive signal is used to cause laser illumination in the disc determination operation, a high-frequency element may be superimposed on the recording-illumination drive signal.

Although the laser beam sources that are controlled based on the reproduction-illumination drive signal and the recording-illumination drive signal are fixed for these signals in the disc determination operation in the present embodiment, the laser beam sources to be controlled based on these signals may be selected freely.

### Fourth Embodiment

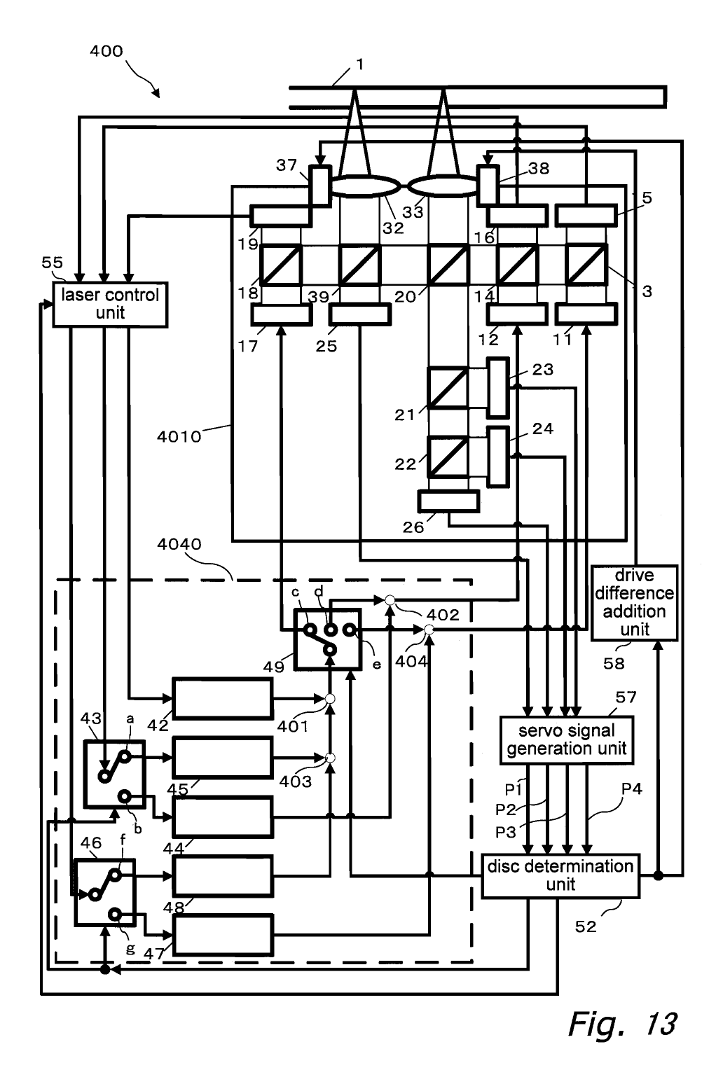

A fourth embodiment of the present invention will now be described with reference to FIGS. 13 to 16.

### 4.1 Structure of the Optical Disc Apparatus

FIG. 13 is a block diagram showing the structure of an optical disc apparatus 400 according to the fourth embodiment of the present invention.

The optical disc apparatus 400 is mainly made of an optical head 4010, an LDD 4040, a laser control unit 55, a servo signal generation unit 57, a disc determination unit 52, and a drive difference addition unit 58.

The optical head 4010 is mainly made of an infrared-laser beam source 11, an infrared-laser beam splitter 13, an infrared-laser front light monitor 15, a red-laser beam source 12, a red-laser beam splitter 14, a red-laser front light monitor 16, a blue-laser beam source 17, a blue-laser beam splitter 18, a blue-laser front light monitor 19, an illumination beam splitter 20, a detector beam splitter 21, a detector beam splitter 22, an optical path switch 39, an infrared-laser beam detector 23, a red-laser beam detector 24, a blue-laser beam detector 25, a blue-laser beam detector 26, a high-NA objective lens 32, a low-NA objective lens 33, a high-NA focus actuator 37, and a low-NA focus actuator 38.

The LDD 4040 is mainly made of a reproduction-illumination drive signal gain amplifier 42, a recording-illumination drive signal gain amplifier 45, a simultaneous illumination gain amplifier 44, a recording-illumination drive signal switch SW43, a simultaneous illumination gain amplifier 47, a recording-illumination drive signal gain amplifier 48, a recording-illumination drive signal switch SW46, an illumination laser selector SW49, a first adder 401, a second adder 402, a third adder 403, and a fourth adder 404.

The components of the optical disc apparatus 400 that have the same functions as the corresponding components of the conventional optical disc apparatus and the optical disc apparatuses of the embodiments described above are given the same numerals as those components and will not be described in detail in the present embodiment.

The optical disc apparatus 400 of the present embodiment differs from the conventional optical disc apparatus and the optical disc apparatuses of the embodiments described above in its use of the laser controller (laser control unit) 55, the servo signal generation unit 57, the disc determination unit 52, the optical head 4010, and the LDD 4040. The optical disc apparatus 400 determines, in a short time, the type of an optical disc to be one of a plurality of disc types through an objective lens operation performed only a small number of times (driving operation for moving the objective lenses toward or away from the optical disc 1) while simultaneously illuminating the optical disc with a plurality of laser beams with different wavelengths, and more reliably prevents information recorded on the information recording surface of the optical disc from being damaged. In particular, the optical disc apparatus 400 uses the high-NA objective lens 32 and the low-NA objective lens 33 included in the optical head 4010 to determine, in a short time, the type of the optical disc to be one of a plurality of disc types through the objective lens operation performed only a small number of times (driving operation for moving the objective lenses 32 and 33 toward or away from the optical disc) while simultaneously illuminating the optical disc with a plurality of laser beams with different wavelengths, and more reliably prevents information recorded on the information recording surface of the optical disc from being damaged.

The blue-laser beam source 17 emits a blue laser beam having a wavelength of about 405 nm. The blue-laser beam splitter 18 splits the blue laser beam toward the optical path switch 39 and the blue-laser front light monitor 19. The blue-laser front light monitor 19 detects the output power of the blue laser beam that has entered the blue-laser front light monitor 19. The output of the blue-laser front light monitor 19 is input into the laser control unit 55.

When the optical path switch 39 is on, the blue laser beam that has entered the optical path switch 39 enters the high-NA objective lens 32. Through the high-NA objective lens 32, the blue laser beam is focused onto the information recording surface of the optical disc 1. The blue laser beam is reflected by the optical disc 1, and the reflected beam passes through the optical path switch 39 and enters the blue-laser beam detector 25.

When the optical path switch 39 is off, the blue laser beam that has entered the optical path switch 39 enters the illumination beam splitter 20. Through the illumination beam splitter 20, the blue laser beam that has entered the illumination beam splitter 20 next enters the low-NA objective lens 33. Through the low-NA objective lens 33, the blue laser beam is focused onto the information recording surface of the optical disc 1. The blue laser beam is reflected by the optical disc 1, and the reflected beam passes through the illumination beam splitter 20 and the detector beam splitter 21, and enters the blue-laser beam detector 26.

When, for example, the optical path switch 39 is on, the beam splitter is set on the optical path of the laser beam (position indicated by numeral 39 in FIG. 13). When, for example, the optical path switch 39 is off, the beam splitter is removed out of the optical path of the laser beam (this is equivalent to the state in which no element is at position indicated by numeral 39 in FIG. 13).

The red-laser beam source 12 emits a red laser beam having a wavelength of about 650 nm. The red-laser beam splitter 14 splits the red laser beam toward the illumination beam splitter 20 and the red-laser front light monitor 16. The red-laser front light monitor 16 detects the output power of the red laser beam that has entered the red-laser front light monitor 16. The output of the red-laser front light monitor 16 is input into the laser control unit 55.

The red laser beam split by the illumination beam splitter 20 enters the low-NA objective lens 33. Through the low-NA objective lens 33, the red laser beam is focused onto the information recording surface of the optical disc 1. The red laser beam is reflected by the optical disc 1, and the reflected beam passes through the illumination beam splitter 20. The red laser beam is then split by the detector beam splitter 22 and enters the red-laser beam detector 24.

The infrared-laser beam source 11 emits an infrared laser beam having a wavelength of about 780 nm. The infrared-laser beam splitter 13 splits the infrared laser beam toward the illumination beam splitter 20 and the infrared-laser front light monitor 15. The infrared-laser front light monitor 15 detects the output power of the infrared laser beam that has entered the infrared-laser front light monitor 15. The output of the infrared-laser front light monitor 15 is input into the laser control unit 55.

The infrared laser beam split by the illumination beam splitter 20 is reflected by the illumination beam splitter 20 and enters the low-NA objective lens 33. Through the low-NA objective lens 33, the infrared laser beam is focused onto the information recording surface of the optical disc 1. The infrared laser beam is reflected by the optical disc 1, and the reflected beam passes through the illumination beam splitter 20. The infrared laser beam is then split by the detector beam splitter 21 and enters the infrared-laser beam detector 23.

The high-NA objective lens 32 is driven by the high-NA focus actuator 37.

The low-NA objective lens 33 is driven by the low-NA focus actuator 38.

During reproduction, the laser controller (laser control unit) 55 outputs, to the LDD 4040, a reproduction-illumination drive signal that causes the output level of the blue laser beam detected by the blue-laser front light monitor 19 (the level of the output power of the blue laser beam), the output level of the red laser beam detected by the red-laser front light monitor 16 (the level of the output power of the red laser beam), and the output level of the infrared laser beam detected by the infrared-laser front light monitor 15 (the level of the output power of the infrared laser beam) to be a predetermined output level for reproduction laser beams. During recording, the laser controller unit 55 outputs, to the LDD 4040, a reproduction-illumination drive signal, a first recording-illumination drive signal, and a second recording-illumination drive signal that cause the output level of the blue laser beam detected by the blue-laser front light monitor 19, the output level of the red laser beam detected by the red-laser front light monitor 16, and the output level of the infrared laser beam detected by the infrared-laser front light monitor 15 to be a predetermined output level for recording laser beams.

During reproduction, the LDD 4040 outputs a signal for laser driving, which is a signal obtained by amplifying the reproduction-illumination drive signal with the gain of the reproduction-illumination drive signal gain amplifier 42, to the blue-laser beam source 17, to the red-laser beam source 12, or to the infrared-laser beam source 11 (the LDD 4040 outputs the laser driving signal to the blue-laser beam source when the c-side of the illumination laser selector SW49 is selected, to the red-laser beam source when the d-side of the illumination laser selector SW49 is selected, and to the infrared-laser beam source when the e-side of the illumination laser selector SW49 is selected).

During recording, the LDD 4040 outputs a signal for laser driving, which is a signal resulting from addition of a laser driving signal obtained by amplifying the reproduction illumination drive signal with the gain of the reproduction-illumination drive signal gain amplifier 42, a laser driving signal obtained by amplifying the first recording-illumination drive signal with the gain of the recording-illumination drive signal gain amplifier 45, a laser driving signal obtained by amplifying the second recording-illumination drive signal with the gain of the recording-illumination drive signal gain amplifier 48, to the blue-laser beam source 17, to the red-laser beam source 12, or to the infrared-laser beam source 11 (the LDD 4040 outputs the laser driving signal to the blue-laser beam source when the c-side of the illumination laser selector SW49 is selected, to the red-laser beam source when the d-side of the illumination laser selector SW49 is selected, and to the infrared-laser beam source when the e-side of the illumination laser selector SW49 is selected). In this case, the a-side of the recording-illumination drive signal switch SW43 is selected, and the f-side of the recording-illumination drive signal switch SW46 is selected.

The recording-illumination drive signal switch SW43 of the LDD 4040 is normally set in a manner that the first recording-illumination drive signal is provided to the recording-illumination drive signal gain amplifier 45 (the a-side is selected). The recording-illumination drive signal switch SW46 is normally set in a manner that the second recording-illumination drive signal is provided to the recording-illumination drive signal gain amplifier 48 (the f-side is selected).

The disc determination controller (disc determination unit) 52 switches the illumination laser selector SW49 of the LDD 4040 in a manner that the LDD 4040 outputs a signal for laser driving, which is a signal obtained by amplifying the reproduction-illumination drive signal with the gain of the reproduction-illumination drive signal gain amplifier 42, to the blue-laser beam source 17, switches the recording-illumination drive signal switch SW43 of the LDD 4040 in a manner that the LDD 4040 outputs a signal for laser driving, which is a signal obtained by amplifying the first recording-illumination drive signal with the gain of the simultaneous illumination gain amplifier 44, to the red-laser beam source 12, and switches the recording-illumination drive signal switch SW46 of the LDD 4040 in a manner that the LDD 4040 outputs a signal for laser driving, which is a signal obtained by amplifying the second recording-illumination drive signal with the gain of the simultaneous illumination gain amplifier 47, to the infrared-laser beam source 11.

To perform the disc determination operation, the disc determination controller (disc determination unit) 52 switches the illumination laser selector SW49 in a manner that the LDD 4040 outputs the reproduction-illumination drive signal that has been amplified by the reproduction-illumination drive signal gain amplifier 42 to the blue-laser beam source 17 (switches the illumination laser selector SW49 to the c-side), switches the recording-illumination drive signal switch SW43 in a manner that the LDD 4040 outputs the first recording-illumination drive signal that has been amplified by the simultaneous illumination gain amplifier 44 to the red-laser beam source 12 (switches the recording-illumination drive signal switch SW43 to the b-side), and switches the recording-illumination drive signal switch SW46 in a manner that the LDD 4040 outputs the second recording-illumination drive signal that has been amplified by the simultaneous illumination gain amplifier 47 to the infrared-laser beam source 11 (switches the recording-illumination drive signal switch SW46 to the g-side). This enables the optical disc apparatus 400 to illuminate the optical disc 1 simultaneously with an infrared laser beam, a red laser beam, and a blue laser beam.

The disc determination controller (disc determination unit) 52 further outputs a laser control mode switch signal for controlling the output of the blue-laser beam source 17, the output of the red-laser beam source 12, and the output of the infrared-laser beam source 11 to the laser controller (laser control unit) 55. When receiving the laser control mode switch signal from the disc determination controller (disc determination unit) 52, the laser controller (laser control unit) 55 outputs, to the LDD 4040 (more specifically to the reproduction-illumination drive signal gain amplifier 42 of the LDD 4040), a reproduction-illumination drive signal that causes the output level of the blue-laser beam source 17 to be a predetermined output level for reproduction laser beams, outputs, to the LDD 4040 (more specifically to the simultaneous illumination gain amplifier 44 via the recording-illumination drive signal switch SW43 of the LDD 4040), a first recording-illumination drive signal that causes the output level of the red-laser beam source 12 to be the predetermined output level for reproduction laser beams, and outputs, to the LDD 4040 (more specifically to the simultaneous illumination gain amplifier 47 via the recording-illumination drive signal switch SW46 of the LDD 4040), a second recording-illumination drive signal that causes the output level of the infrared-laser beam source 11 to be the predetermined output level for reproduction laser beams. As a result, the optical disc 1 is illuminated simultaneously with a blue laser beam, a red laser beam, and an infrared laser beam.

Further, the disc determination controller (disc determination unit) 52 outputs a drive signal for driving the high-NA objective lens 32 and the low-NA objective lens 33 up and down (driving the objective lenses 32 and 33 toward and away from the optical disc 1) to the drive difference addition unit 58 and the high-NA focus actuator 37. The drive difference addition unit 58 adds a signal having a predetermined level (adds an offset value) to the drive output (drive signal output) from the disc determination controller (disc determination unit) 52, and outputs the resulting signal to the low-NA focus actuator 38.

The disc determination controller (disc determination unit) 52 outputs an optical path switch signal for switching the state of the optical path switch 39 between the on and off states (input and output paths and connection details are not shown). The optical path switch is switched between the on and off states based on the optical path switch signal, which is output from the disc determination unit 52.

The servo signal generation circuit (servo signal generation unit) 57 generates a servo signal based on the output of the blue-laser beam detector 25, the blue-laser beam detector 26, the red-laser beam detector 24, and the infrared-laser beam detector 23, and outputs the generated servo signal to the disc determination unit 52.

The disc determination controller (disc determination unit) 52 determines the type of the disc that has been mounted on the optical disc apparatus 400 based on the servo signal, which is generated by the servo signal generation circuit (servo signal generation unit) 57.

The recording-illumination drive signal gain amplifiers 45 and 48 of the LDD 4040 have the amplification factor that is too high and the resolution that is too low for reproduction laser illumination. Thus, the simultaneous illumination gain amplifiers 44 and 47 of the LDD 4040 are used to amplify the first recording-illumination drive signal and the second recording-illumination drive signal. In other words, the first recording-illumination drive signal and the second recording-illumination drive signal are amplified by the simultaneous illumination gain amplifiers 44 and 47, which have the amplification factor suitable for reproduction laser illumination, and the amplified first and second recording-illumination drive signals are then used to drive the red-laser beam source 12 and the infrared-laser beam source 11.

The first adder 401, the second adder 402, and the recording-illumination drive signal switch SW43 are identical to the corresponding components in the first embodiment and will not be described in detail in the present embodiment.

The third adder 403 is identical to the first adder. The fourth adder 404 is identical to the second adder. The recording-illumination drive signal switch SW46 is identical to the recording-illumination drive signal switch SW43. The illumination laser selector SW49 has the same function as the illumination laser selector SW41 (a 1-input and 2-output selector), and differs from the illumination laser selector SW41 only in that the illumination laser selector SW49 is a 1-input and 3-output selector.

### 4.2 Operation of the Optical Disc Apparatus

### 4.2.1 Disc Determination Operation (HD-DVD)

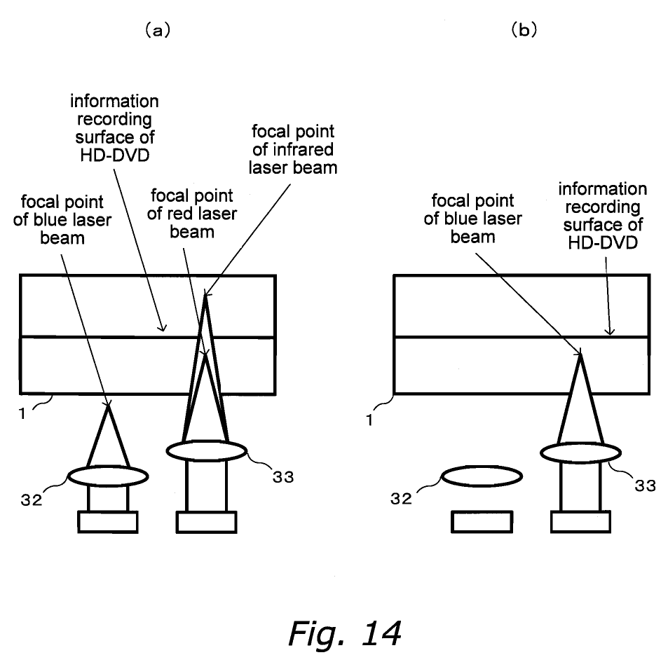

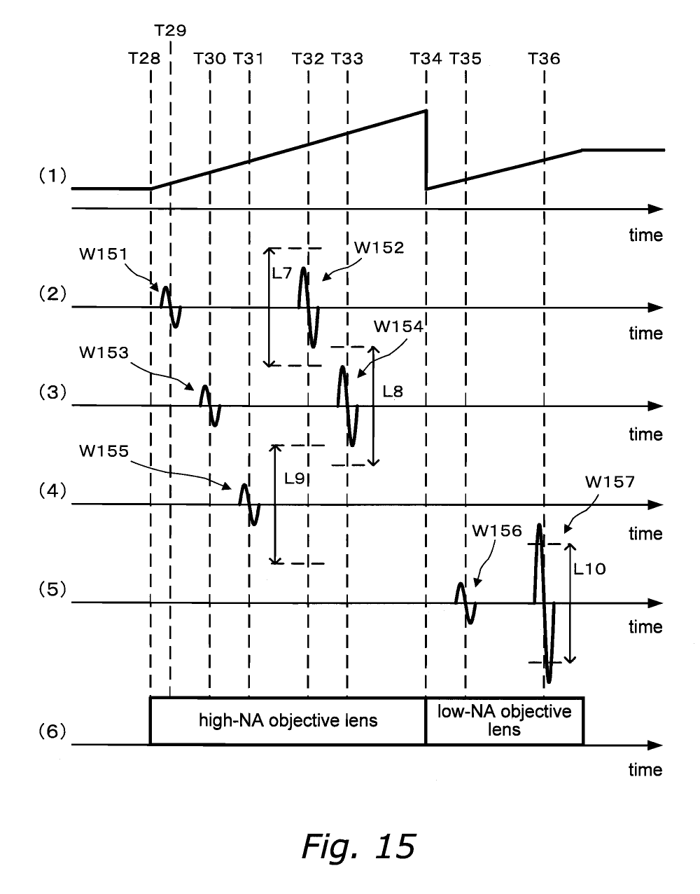

A disc determination operation using simultaneous illumination of a plurality of lasers for determining that an HD-DVD has been mounted on the optical disc apparatus 400 will now be described in detail with reference to FIGS. 14 and 15.

FIG. 14(a) is a schematic view showing an optical disc 1 that is illuminated simultaneously with a blue laser beam through the high-NA objective lens 32, which is focused on the optical disc 1, and a red laser beam and an infrared laser beam through the low-NA objective lens 33, which are focused on the optical disc 1. The optical disc 1 is an HD-DVD and has an information recording surface at about 0.6 mm from its surface (surface of the optical disc 1 facing the objective lenses 32 and 33).

FIG. 14(b) is a schematic view showing an optical disc 1 that is illuminated with a blue laser beam through the low-NA objective lens 33, which is focused on the optical disc 1. The optical disc 1 is an HD-DVD and has an information recording surface at about 0.6 mm from its surface (surface of the optical disc 1 facing the objective lenses 32 and 33).

FIG. 15 shows the position of the high-NA objective lens 32 and the state of a focus error signal when the high-NA objective lens 32 and the low-NA objective lens 33 are driven while the HD-DVD is being illuminated simultaneously with a blue laser beam through the high-NA objective lens 32 and a red laser beam and an infrared laser beam through the low-NA objective lens 33, and also shows the position of the high-NA objective lens 32 and the state of a focus error signal when the high-NA objective lens 32 and the low-NA objective lens 33 are driven while the HD-DVD is being illuminated with a blue laser beam through the low-NA objective lens 33 after the HD-DVD is illuminated simultaneously with the blue laser beam through the high-NA objective lens 32 and the red and infrared laser beams through the low-NA objective lens 33.

In FIG. 15, line (1) shows the position of the high-NA objective lens 32 as a function of time, where the horizontal axis indicates time and the vertical axis indicates the high-NA objective lens position. More specifically, line (1) in FIG. 15 represents signals showing the position of the high-NA objective lens 32 when the high-NA objective lens 32 and the low-NA objective lens 33 are moved toward the HD-DVD while the HD-DVD is being illuminated simultaneously with a blue laser beam through the high-NA objective lens 32 and a red laser beam and an infrared laser beam through the low-NA objective lens 33.

In FIG. 15, line (2) shows the level of a focus error signal as a function of time, where the horizontal axis indicates time and the vertical axis indicates the focus error signal level. More specifically, line (2) in FIG. 15 represents focus error signals (corresponding to signals transmitted on a signal line P1 in FIG. 13), which are generated by the servo signal generation circuit (servo signal generation unit) 57 based on the output of the infrared-laser beam detector 23 when the high-NA objective lens 32 and the low-NA objective lens 33 are moved toward the HD-DVD while the HD-DVD is being illuminated simultaneously with a blue laser beam through the high-NA objective lens 32 and a red laser beam and an infrared laser beam through the low-NA objective lens 33.

In FIG. 15, line (3) shows the level of a focus error signal as a function of time, where the horizontal axis indicates time and the vertical axis indicates the focus error signal level. More specifically, line (3) in FIG. 15 represents focus error signals (corresponding to signals transmitted on a signal line P2 in FIG. 13), which are generated by the servo signal generation circuit (servo signal generation unit) 57 based on the output of the red-laser beam detector 24 when the high-NA objective lens 32 and the low-NA objective lens 33 are moved toward the HD-DVD while the HD-DVD is being illuminated simultaneously with a blue laser beam through the high-NA objective lens 32 and a red laser beam and an infrared laser beam through the low-NA objective lens 33.

In FIG. 15, line (4) shows the level of a focus error signal as a function of time, where the horizontal axis indicates time and the vertical axis indicates the focus error signal level. More specifically, line (4) in FIG. 15 represents focus error signals corresponding to signals transmitted on a signal line P3 in FIG. 13), which are generated by the servo signal generation circuit (servo signal generation unit) 57 based on the output of the blue-laser beam detector 25 when the high-NA objective lens 32 and the low-NA objective lens 33 are moved toward the HD-DVD while the HD-DVD is being illuminated simultaneously with a blue laser beam through the high-NA objective lens 32 and a red laser beam and an infrared laser beam through the low-NA objective lens 33.

In FIG. 15, line (5) shows the level of a focus error signal as a function of time, where the horizontal axis indicates time and the vertical axis indicates the focus error signal level. More specifically, line (5) in FIG. 15 represents focus error signals (corresponding to signals transmitted on a signal line P4 in FIG. 13), which are generated by the servo signal generation circuit (servo signal generation unit) 57 based on the output of the blue-laser beam detector 26 when the high-NA objective lens 32 and the low-NA objective lens 33 are moved toward the HD-DVD while the HD-DVD is being illuminated with a blue laser beam through the low-NA objective lens 33.

In FIG. 15, line (6) shows the level of an optical path switch signal as a function of time, where the horizontal axis indicates time and the vertical axis indicates the optical path switch signal level. More specifically, line (6) in FIG. 15 indicates either the high-NA objective lens 32 or the low-NA objective lens 33 through which a blue laser beam is illuminating the HD-DVD when the high-NA objective lens 32 and the low-NA objective lens 33 are driven while the HD-DVD is first being illuminated simultaneously with a blue laser beam through the high-NA objective lens 32 and a red laser beam and an infrared laser beam through the low-NA objective lens 33 and then is next being illuminated with a blue laser beam through the low-NA objective lens 33. More specifically, line (6) in FIG. 15 indicates that a blue laser beam is being output through the high-NA objective lens 32 between timing T28 and T34 and a blue laser beam is being output through the low-NA objective lens 33 at and after timing T34.

At timing T28 to start disc determination, the disc determination controller (disc determination unit) 52 starts its disc determination operation. The disc determination controller (disc determination unit) 52 switches the illumination laser selector SW49 of the LDD 4040 in a manner that the LDD 4040 outputs a signal for laser driving, which is a signal obtained by amplifying the reproduction-illumination drive signal with the gain of the reproduction-illumination drive signal gain amplifier 42, to the blue-laser beam source 17 (switches the illumination laser selector SW49 to the c-side), switches the recording-illumination drive signal switch SW43 of the LDD 4040 in a manner that the LDD 4040 outputs a signal for laser driving, which is a signal obtained by amplifying the first recording-illumination drive signal with the gain of the simultaneous illumination gain amplifier 44, to the red-laser beam source 12 (switches the recording-illumination drive signal switch SW43 to the b-side), and switches the recording-illumination drive signal switch SW46 of the LDD 4040 in a manner that the LDD 4040 outputs a signal for laser driving, which is a signal obtained by amplifying the second recording-illumination drive signal with the gain of the simultaneous illumination gain amplifier 47, to the infrared-laser beam source 11 (switches the recording-illumination drive signal switch SW43 to the g-side). Here, the disc determination controller 52 selects the b-side of the recording-illumination drive signal switch SW43 and the g-side of the recording-illumination drive signal switch SW46. Thus, no signal is output from the recording-illumination drive signal gain amplifiers 45 and 48. As a result, the first adder 401 directly outputs the output of the reproduction-illumination drive signal gain amplifier 42. This is equivalent to the state in which the output of the reproduction-illumination drive signal gain amplifier 42 is directly the input of the illumination laser selector SW49.

The disc determination controller (disc determination unit) 52 further outputs a laser control mode switch signal to the laser controller (laser control unit) 55. When receiving the laser control mode switch signal from the disc determination controller (disc determination unit) 52, the laser controller (laser control unit) 55 outputs, to the LDD 4040 (more specifically to the reproduction-illumination drive signal gain amplifier 42 of the LDD 4040), a reproduction-illumination drive signal that causes the output level of the blue-laser beam source 17 to be a predetermined output level for reproduction laser beams, outputs, to the LDD 4040 (more specifically to the simultaneous illumination gain amplifier 44 via the recording-illumination drive signal switch SW43 of the LDD 4040), a first recording-illumination drive signal that causes the output level of the red-laser beam source 12 to be the predetermined output level for reproduction laser beams, and outputs, to the LDD 4040 (more specifically to the simultaneous illumination gain amplifier 47 via the recording-illumination drive signal switch SW46 of the LDD 4040), a second recording-illumination drive signal that causes the output level of the infrared-laser beam source 11 to be the predetermined output level for reproduction laser beams. As a result, the optical disc 1 is illuminated simultaneously with a blue laser beam, a red laser beam, and an infrared laser beam.

Further, the disc determination controller (disc determination unit) 52 outputs a drive signal to raise the high-NA objective lens 32 and the low-NA objective lens 33. The high-NA focus actuator 37 raises the high-NA objective lens 32 (moves the high-NA objective lens 32 toward the optical disc 1) based on the drive signal output from the disc determination controller (disc determination unit) 52. The low-NA focus actuator 38 raises the low-NA objective lens 33 (moves the low-NA objective lens 33 toward the optical disc 1) based on a drive signal that has been obtained by the drive difference addition unit 58 adding a predetermined drive amount to the drive signal output from the disc determination controller (disc determination unit) 52.

At timing T29, the focal point of the infrared laser beam passes through a surface of the HD-DVD (surface of the optical disc 1 facing the objective lenses 32 and 33). When the beam passes through the surface, a focus error signal is obtained based on a signal output from the infrared-laser beam detector 23. More specifically, a focus error signal having a waveform indicated by W151 in FIG. 15 is output at around timing T29.

As shown in FIG. 14(a), the optical disc apparatus uses the low-NA objective lens 33 that focuses the infrared laser beam at a more distant position than the red laser beam in the direction of the normal to the low-NA objective lens 33 (in the optical axis direction of the low-NA objective lens 33), and the drive offset value of the drive difference addition unit 58 is set in a manner that the low-NA objective lens 33 focuses the red laser beam at a more distant position than the blue laser beam focused by the high-NA objective lens 32 in the directions of the normals to the objective lenses 32 and 33 (in the optical axis directions of the objective lenses 32 and 33). Thus, the focal point of the red laser beam passes through the surface of the HD-DVD (surface of the optical disc 1 facing the objective lenses 32 and 33) at timing T30. When the beam passes through the surface, a focus error signal is obtained based on a signal output from the red-laser beam detector 24. More specifically, a focus error signal having a waveform indicated by W153 in FIG. 15 is output at around timing T30.

At timing T31, the focal point of the blue laser beam passes through the surface of the HD-DVD (surface of the optical disc 1 facing the objective lenses 32 and 33). When the beam passes through the surface, a focus error signal is obtained based on a signal output from the blue-laser beam detector 25. More specifically, a focus error signal having a waveform indicated by W155 in FIG. 15 is output at around timing T31. The amplitude of this focus error signal does not exceed a predetermined level L9. Thus, the disc determination controller (disc determination unit) 52 continues the disc determination operation.

At timing T32, the focal point of the infrared laser beam passes through the information recording surface of the HD-DVD. When the beam passes through the surface, a focus error signal is obtained based on a signal output from the infrared-laser beam detector 23. More specifically, a focus error signal having a waveform indicated by W152 in FIG. 15 is output at around timing T32. The amplitude of this focus error signal does not exceed a predetermined level L7. Thus, the disc determination controller (disc determination unit) 52 continues the disc determination operation.

At timing T33, the focal point of the red laser beam passes through the information recording surface of the HD-DVD. When the beam passes through the surface, a focus error signal is obtained based on a signal output from the red-laser beam detector 24. More specifically, a focus error signal having a waveform indicated by W154 in FIG. 15 is output at around timing T33. The amplitude of this focus error signal does not exceed a predetermined level L8. Thus, the disc determination controller (disc determination unit) 52 continues the disc determination operation.

The disc determination controller (disc determination unit) 52 continues raising the high-NA objective lens 32 and the low-NA objective lens 33. Thus, the high-NA objective lens 32 or the low-NA objective lens 33 reaches its preset positional limit at timing T34. In this case, the disc determination controller (disc determination unit) 52 stops raising the high-NA objective lens 32 and the low-NA objective lens 33 (stops the operation for driving the lenses toward the optical disc 1), and lowers the high-NA objective lens 32 and the low-NA objective lens 33 (drives the lenses away from the optical disc 1). The disc determination controller (disc determination unit) 52 then moves the high-NA objective lens 32 and the low-NA objective lens 33 until the high-NA objective lens 32 and the low-NA objective lens 33 return to their positions corresponding to timing T28 in FIG. 15.

The disc determination controller (disc determination unit) 52 then turns off the red laser beam and the infrared laser beam with which the optical disc 1 has been illuminated, and outputs an optical path switch signal to switch off the optical path switch 39.

In other words, the disc determination controller (disc determination unit) 52 switches the illumination state when the objective lenses reach their positional limits from the state in which the optical disc 1 is being illuminated simultaneously with a blue laser beam through the high-NA objective lens 32 and a red laser beam and an infrared laser beam through the low-NA objective lens 33 to the state in which the optical disc 1 is being illuminated with a blue laser beam through the low-NA objective lens 33.

While the optical disc 1 is being illuminated with a blue laser beam through the low-NA objective lens 33, the disc determination controller (disc determination unit) 52 again raises the high-NA objective lens 32 and the low-NA objective lens 33 (drives the lenses toward the optical disc 1).

At timing T35, the focal point of the blue laser beam passes through the surface of the HD-DVD (surface of the optical disc 1 facing the objective lenses 32 and 33). When the beam passes through the surface, a focus error signal is obtained based on a signal output from the blue-laser beam detector 26. More specifically, a focus error signal having a waveform indicated by W156 in FIG. 15 is output at around timing T35.

At timing T36, the focal point of the blue laser beam passes through an information recording surface of the HD-DVD. When the beam passes through the surface, a focus error signal is obtained based on a signal output from the blue-laser beam detector 26. More specifically, a focus error signal having a waveform indicated by W157 in FIG. 15 is output at around timing T36. When the amplitude of this focus error signal exceeds a predetermined level Li0, the disc determination controller (disc determination unit) 52 determines that the disc that has been mounted on the optical disc apparatus 400 is an HD-DVD.

As described above, the optical disc apparatus records or reproduces on a plurality of types of discs that are substantially identical to one another or different from one another in the thickness of a substrate between the surface of the optical disc 1 (the surface of the optical disc 1 facing the objective lenses 32 and 33) and the information recording surface of the optical disc 1 and that differ from one another in the corresponding laser wavelength. The optical disc apparatus determines the type of the optical disc to be one of a plurality of disc types through an objective lens operation performed only a small number of times (driving operation for moving the objective lenses toward or away from the optical disc) while illuminating the optical disc simultaneously with a plurality of laser beams with different wavelengths. This optical disc apparatus requires only a shorter time for its disc type determination.

The optical disc apparatus determines whether the optical disc is a BD, a DVD, or a CD simultaneously in the first part of its disc determination operation, and next determines whether the optical disc is an HD-DVD in the later part of the disc determination operation. The optical disc apparatus having this structure more reliably prevents information recorded on the DVD recording surface from being damaged by a blue laser beam, which is a laser beam to be used for an HD-DVD.

Although the present embodiment describes the case in which the optical disc apparatus 400 determines the type of a disc that has been mounted on the optical disc apparatus 400, the optical disc apparatus 400 may determine the type of each information recording surface included in the disc when the single disc has a plurality of information recording surfaces that differ from one another in the recording density or in the corresponding laser wavelength.

Although a different front light monitor is used to detect each laser beam with a different wavelength in the present embodiment, one front light monitor may be used commonly for the plurality of laser beams with different wavelengths. In this case, the apparatus may set the output of each laser at a low output.

Although the present embodiment describes the case in which the optical disc apparatus uses the low-NA objective lens 33 that focuses the infrared laser beam at a more distant position than the red laser beam in the direction of the normal to the objective lens 33 (in the optical axis direction of the objective lens 33), the optical disc apparatus may use the low-NA objective lens 33 that focuses the infrared laser beam at a nearer position than the red laser beam in the direction of the normal to the objective lens 33 (in the optical axis direction of the objective lens). In this case, the low-NA objective lens 33 is moved away from the surface vicinity of the optical disc 1 in the disc determination operation.

When the recording-illumination drive signal is used to cause laser illumination in the disc determination operation, a high-frequency element may be superimposed on the recording-illumination drive signal.

Although the laser beam sources that are controlled based on the reproduction-illumination drive signal and the recording-illumination drive signal are fixed for these signals in the disc determination operation in the present embodiment, the laser beam sources to be controlled based on these signals may be selected freely.

### 4.2.2 Disc Determination Operation (BD)

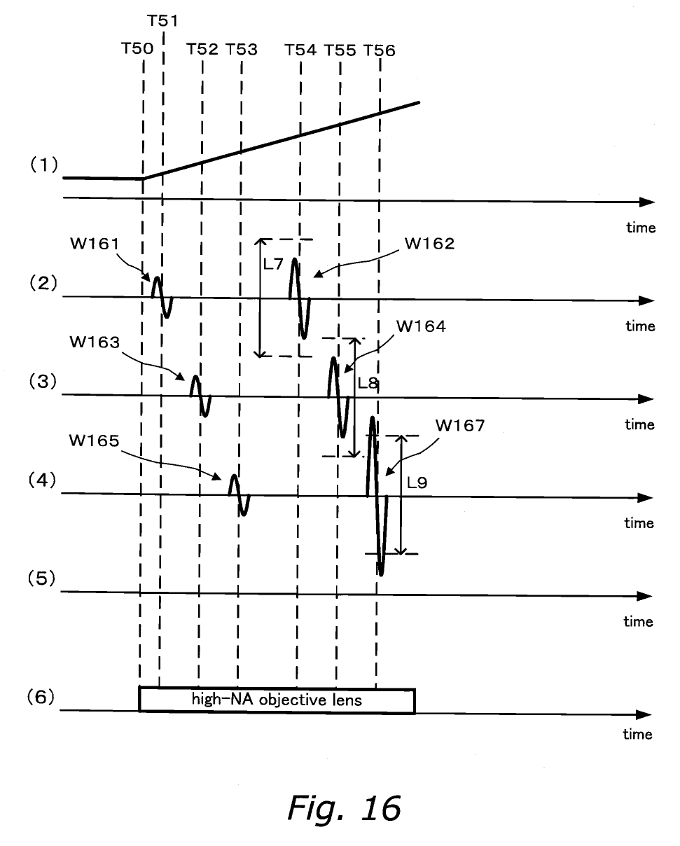

A disc determination operation using simultaneous illumination of a plurality of lasers for determining that a BD has been mounted on the optical disc apparatus 400 will now be described in detail with reference to FIG. 16.

The optical disc 1 is a BD and has an information recording surface at about 0.1 mm from its surface (surface of the optical disc 1 facing the objective lenses 32 and 33).

FIG. 16 shows the position of the high-NA objective lens 32 and the state of a focus error signal when the high-NA objective lens 32 and the low-NA objective lens 33 are driven while the BD is being illuminated simultaneously with a blue laser beam through the high-NA objective lens 32 and a red laser beam and an infrared laser beam through the low-NA objective lens 33.

In FIG. 16, line (1) shows the position of the high-NA objective lens 32 as a function of time, where the horizontal axis indicates time and the vertical axis indicates the high-NA objective lens position. More specifically, line (1) in FIG. 16 represents signals showing the position of the high-NA objective lens 32 when the high-NA objective lens 32 and the low-NA objective lens 33 are moved toward the BD while the BD is being illuminated simultaneously with a blue laser beam through the high-NA objective lens 32 and a red laser beam and an infrared laser beam through the low-NA objective lens 33.

In FIG. 16, line (2) shows the level of a focus error signal as a function of time, where the horizontal axis indicates time and the vertical axis indicates the focus error signal level. More specifically, line (2) in FIG. 16 represents focus error signals (corresponding to signals transmitted on the signal line P1 in FIG. 13), which are generated by the servo signal generation circuit (servo signal generation unit) 57 based on the output of the infrared-laser beam detector 23 when the high-NA objective lens 32 and the low-NA objective lens 33 are moved toward the BD while the BD is being illuminated simultaneously with a blue laser beam through the high-NA objective lens 32 and a red laser beam and an infrared laser beam through the low-NA objective lens 33.

In FIG. 16, line (3) shows the level of a focus error signal as a function of time, where the horizontal axis indicates time and the vertical axis indicates the focus error signal level. More specifically, line (3) in FIG. 16 represents focus error signals (corresponding to signals transmitted on the signal line P2 in FIG. 13), which are generated by the servo signal generation circuit (servo signal generation unit) 57 based on the output of the red-laser beam detector 24 when the high-NA objective lens 32 and the low-NA objective lens 33 are moved toward the BD while the BD is being illuminated simultaneously with a blue laser beam through the high-NA objective lens 32 and a red laser beam and an infrared laser beam through the low-NA objective lens 33.

In FIG. 16, line (4) shows the level of a focus error signal as a function of time, where the horizontal axis indicates time and the vertical axis indicates the focus error signal level. More specifically, line (4) in FIG. 16 represents focus error signals (corresponding to signals transmitted on the signal line P3 in FIG. 13), which are generated by the servo signal generation circuit (servo signal generation unit) 57 based on the output of the blue-laser beam detector 25 when the high-NA objective lens 32 and the low-NA objective lens 33 are moved toward the BD while the BD is being illuminated simultaneously with a blue laser beam through the high-NA objective lens 32 and a red laser beam and an infrared laser beam through the low-NA objective lens 33.

In FIG. 16, line (6) shows the level of an optical path switch signal as a function of time in the same manner as line (6) in FIG. 15. The level of the optical path switch signal as a function of time is the same as described above and will not be described in detail.

At timing T50 to start disc determination, the disc determination controller (disc determination unit) 52 starts its disc determination operation. The subsequent operation up to raising the high-NA objective lens and the low-NA objective lens is the same as the operation described above, and will not be described.

At timing T51, the focal point of the infrared laser beam passes through a surface of the BD (surface of the optical disc 1 facing the objective lenses 32 and 33). When the beam passes through the surface, a focus error signal is obtained based on a signal output from the infrared-laser beam detector 23. More specifically, a focus error signal having a waveform indicated by W161 in FIG. 16 is output at around timing T51.

As shown in FIG. 14(a), the optical disc apparatus uses the low-NA objective lens 33 that focuses the infrared laser beam at a more distant position than the red laser beam in the direction of the normal to the low-NA objective lens 33 (in the optical axis direction of the low-NA objective lens 33), and the drive offset value of the drive difference addition unit 58 is set in a manner that the low-NA objective lens 33 focuses the red laser beam at a more distant position than the blue laser beam focused by the high-NA objective lens 32 in the directions of the normals to the objective lenses 32 and 33 (in the optical axis directions of the objective lenses 32 and 33). Thus, the focal point of the red laser beam passes through the surface of the BD (surface of the optical disc 1 facing the objective lenses 32 and 33) at timing T52. When the beam passes through the surface, a focus error signal is obtained based on a signal output from the red-laser beam detector 24. More specifically, a focus error signal having a waveform indicated by W163 in FIG. 16 is output at around timing T52.

At timing T53, the focal point of the blue laser beam passes through the surface of the BD (surface of the optical disc 1 facing the objective lenses 32 and 33). When the beam passes through the surface, a focus error signal is obtained based on a signal output from the blue-laser beam detector 25. More specifically, a focus error signal having a waveform indicated by W165 in FIG. 16 is output at around timing T53. The amplitude of this focus error signal does not exceed a predetermined level L9. Thus, the disc determination controller (disc determination unit) 52 continues the disc determination operation.

At timing T54, the focal point of the infrared laser beam passes through the information recording surface of the BD. When the beam passes through the surface, a focus error signal is obtained based on a signal output from the infrared-laser beam detector 23. More specifically, a focus error signal having a waveform indicated by W162 in FIG. 16 is output at around timing T54. The amplitude of this focus error signal does not exceed the predetermined level L7. Thus, the disc determination controller (disc determination unit) 52 continues the disc determination operation.

At timing T55, the focal point of the red laser beam passes through the information recording surface of the BD. When the beam passes through the surface, a focus error signal is obtained based on a signal output from the red-laser beam detector 24. More specifically, a focus error signal having a waveform indicated by W164 in FIG. 16 is output at around timing T55. The amplitude of this focus error signal does not exceed a predetermined level L8. Thus, the disc determination controller (disc determination unit) 52 continues the disc determination operation.

At timing T56, the focal point of the red laser beam passes through the information recording surface of the BD. When the beam passes through the surface, a focus error signal is obtained based on a signal output from the blue-laser beam detector 25. More specifically, a focus error signal having a waveform indicated by W167 in FIG. 16 is output at around timing T56. The amplitude of this focus error signal exceeds the predetermined level L9. Thus, the disc determination controller (disc determination unit) 52 determines that the disc that has been mounted on the optical disc apparatus 400 is a BD.

As described above, the optical disc apparatus 400 promptly determines that the disc that has been mounted is a BD while reliably preventing information recorded on the DVD recording surface from being damaged by a blue laser beam.

### Fifth Embodiment

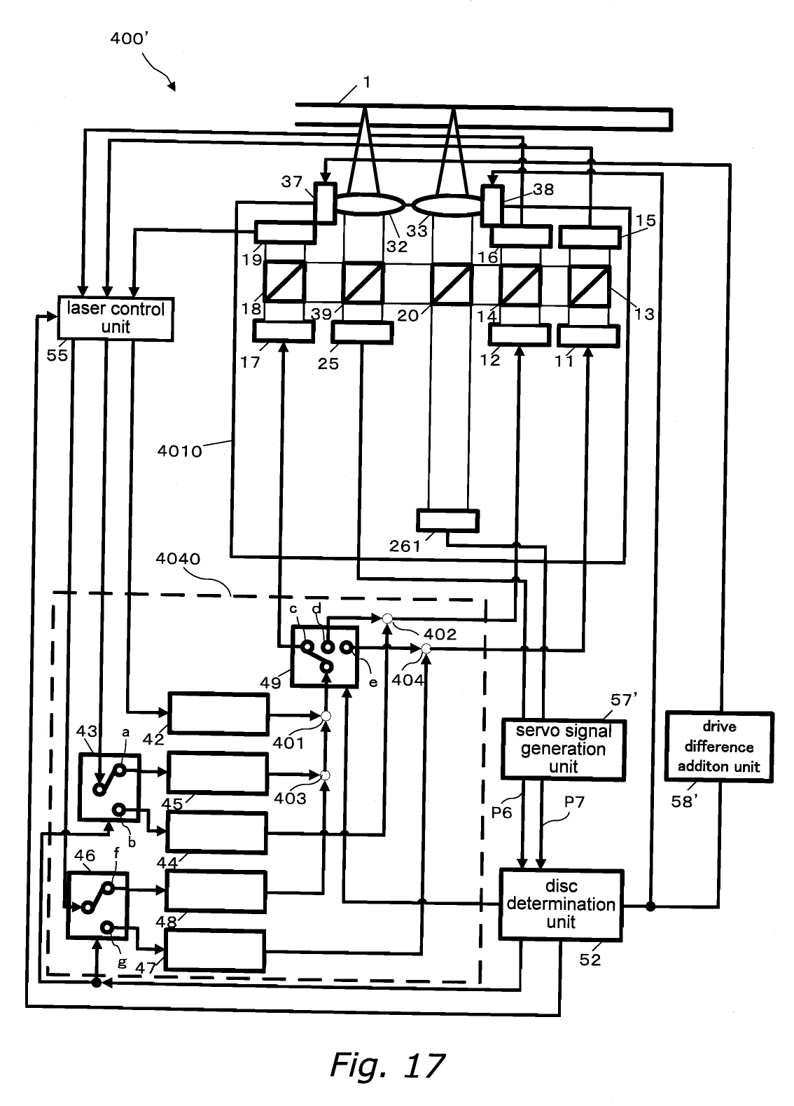

A fifth embodiment of the present invention will now be described with reference to FIGS. 17 to 20.

### 5.1 Structure of the Optical Disc Apparatus

FIG. 17 is a block diagram showing the structure of an optical disc apparatus 400′ according to the fifth embodiment of the present invention. The optical disc apparatus 400′ of the fifth embodiment differs from the optical disc apparatus 400 of the fourth embodiment in the following points.

First, the optical disc apparatus 400′ includes a multiple-laser beam detector 261 instead of the red-laser beam detector 24 and the blue-laser beam detector 26 of the optical disc apparatus 400.

Second, the optical disc apparatus 400′ includes a servo signal generation unit 57′ instead of the servo signal generation unit 57 of the optical disc apparatus 400.

Third, the optical disc apparatus 400′ does not include the drive difference addition unit 58 of the optical disc apparatus 400 and additionally includes a drive difference addition unit 58′ arranged at a position shown in FIG. 17.

The other structure of the optical disc apparatus 400′ is identical to the corresponding structure of the optical disc apparatus 400, and will not be described in the present embodiment.

When the optical path switch 39 is on, the multiple-laser beam detector 261 is illuminated with an infrared laser beam that is emitted from the infrared-laser beam source 11 and reflected from the optical disc 1, and with a red laser beam that is emitted from the red-laser beam source 12 and reflected from the optical disc 1. The multiple-laser beam detector 261 outputs an output signal corresponding to the intensity of the infrared laser beam and the intensity of the red laser beam to the servo signal generation unit 57′.

When the optical path switch 39 is off, the multiple-laser beam detector 261 is illuminated with a blue laser beam that is emitted from the blue-laser beam source 17 and reflected from the optical disc 1. The multiple-laser beam detector 261 outputs an output signal corresponding to the intensity of the blue laser beam to the servo signal generation unit 57′.

The servo signal generation unit 57′ generates a servo signal based on the output from the blue-laser beam detector 25 and the output from the multiple-laser beam detector 261, and outputs the servo signal to the disc determination unit 52.

The drive difference addition unit 58′ adds a signal having a predetermined level (adds an offset value) to the drive output (drive signal output) from the disc determination controller (disc determination unit) 52, and outputs the resulting signal to the high-NA focus actuator 37.

With this structure, the optical disc apparatus 400′ controls driving of the high-NA objective lens 32 and the low-NA objective lens 33 while maintaining the high-NA objective lens 32 at a position nearer to the optical disc 1 than the low-NA objective lens 33 by a distance corresponding to the offset. The optical disc apparatus 400′ differs from the optical disc apparatus 400 in this point.

The positional relationship between the high-NA objective lens 32 and the low-NA objective lens 33 may be reversed with respect to the positional relationship described above. However, the optical disc apparatus 400′ with the reversed relationship of the high-NA objective lens 32 and the low-NA objective lens 33 consumes more power when a blue laser beam is illuminated through the high-NA objective lens 32. To reduce power consumption of the optical disc apparatus 400′, it is more preferable that the driving of the high-NA objective lens 32 is controlled using the offset value so that the high-NA objective lens 32 is positioned nearer to the optical disc 1.

### 5.2 Operation of the Optical Disc Apparatus

The basic operation of the optical disc apparatus 400′ is identical to the basic operation of the optical disc apparatus 400 of the fourth embodiment. The operation of the optical disc apparatus 400′ will be described focusing only on its differences from the operation of the optical disc apparatus 400.

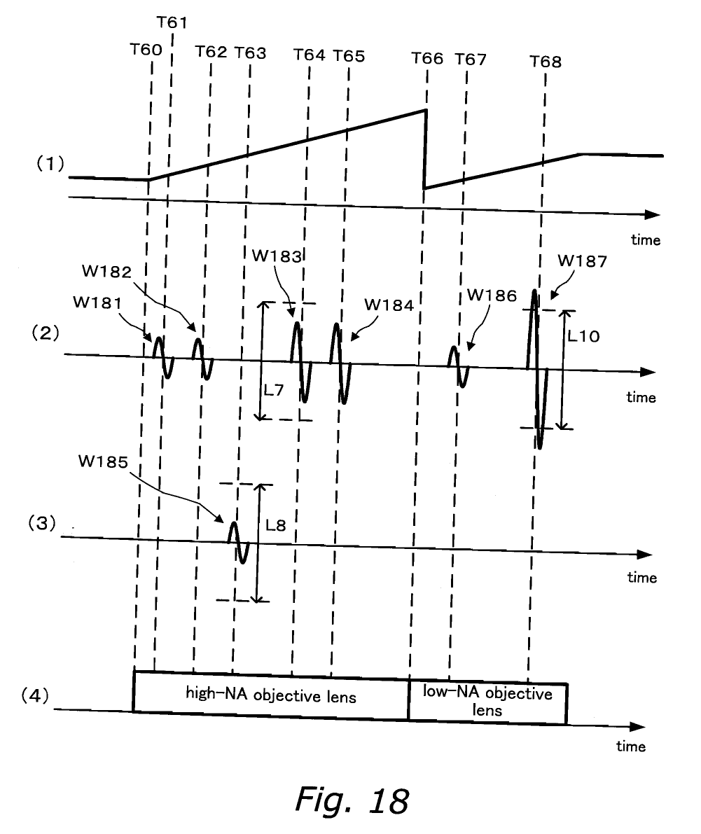

5.2.1 Disc Determination Operation (HD-DVD) A disc determination operation using simultaneous illumination of a plurality of lasers for determining that an HD-DVD has been mounted on the optical disc apparatus 400′ will now be described with reference to FIG. 18.

FIG. 18 shows the position of the high-NA objective lens 32 and the state of a focus error signal when the high-NA objective lens 32 and the low-NA objective lens 33 are driven while the HD-DVD is being illuminated simultaneously with a blue laser beam through the high-NA objective lens 32 and a red laser beam and an infrared laser beam through the low-NA objective lens 33, and also shows the position of the low-NA objective lens 33 and the state of a focus error signal when the high-NA objective lens 32 and the low-NA objective lens 33 are driven while the HD-DVD is being illuminated with a blue laser beam through the low-NA objective lens 33 after the HD-DVD is illuminated simultaneously with the blue laser beam through the high-NA objective lens 32 and the red and infrared laser beams through the low-NA objective lens 33.

In FIG. 18, line (1) shows the position of the low-NA objective lens 33 as a function of time, where the horizontal axis indicates time and the vertical axis indicates the low-NA objective lens position. More specifically, line (1) in FIG. 18 represents signals showing the position of the low-NA objective lens 33 when the high-NA objective lens 32 and the low-NA objective lens 33 are moved toward the HD-DVD while the HD-DVD is being illuminated simultaneously with a blue laser beam through the high-NA objective lens 32 and a red laser beam and an infrared laser beam through the low-NA objective lens 33.

In FIG. 18, line (2) shows the level of a focus error signal as a function of time, where the horizontal axis indicates time and the vertical axis indicates the focus error signal level. More specifically, line (2) in FIG. 18 represents focus error signals (corresponding to signals transmitted on a signal line P7 in FIG. 17), which are generated by the servo signal generation circuit (servo signal generation unit) 57′ based on the output of the multiple-laser beam detector 261 when the high-NA objective lens 32 and the low-NA objective lens 33 are moved toward the HD-DVD while the HD-DVD is being illuminated simultaneously with a blue laser beam through the high-NA objective lens 32 and a red laser beam and an infrared laser beam through the low-NA objective lens 33.

In FIG. 18, line (3) shows the level of a focus error signal as a function of time, where the horizontal axis indicates time and the vertical-axis indicates the focus error signal level. More specifically, line (3) in FIG. 18 represents focus error signals (corresponding to signals transmitted on a signal line P6 in FIG. 17), which are generated by the servo signal generation circuit (servo signal generation unit) 57′ based on the output of the blue-laser beam detector 25 when the high-NA objective lens 32 and the low-NA objective lens 33 are moved toward the HD-DVD while the HD-DVD is being illuminated simultaneously with a blue laser beam through the high-NA objective lens 32 and a red laser beam and an infrared laser beam through the low-NA objective lens 33.

In FIG. 18, line (4) shows the level of an optical path switch signal as a function of time, where the horizontal axis indicates time and the vertical axis indicates the optical path switch signal level. More specifically, line (4) in FIG. 18 indicates either the high-NA objective lens 32 or the low-NA objective lens 33 through which a blue laser beam is illuminating the HD-DVD when the high-NA objective lens 32 and the low-NA objective lens 33 are driven while the HD-DVD is first being illuminated simultaneously with a blue laser beam through the high-NA objective lens 32 and a red laser beam and an infrared laser beam through the low-NA objective lens 33 and then is next being illuminated with a blue laser beam through the low-NA objective lens 33. More specifically, line (4) in FIG. 18 indicates that a blue laser beam is being output through the high-NA objective lens 32 between timings T60 and T66 and a blue laser beam is being output through the low-NA objective lens 33 at and after timing T66.

At timing T60 to start disc determination, the disc determination controller (disc determination unit) 52 starts its disc determination operation. The subsequent operation up to illuminating the optical disc 1 with laser beams is the same as the operation described above, and will not be described.

The disc determination controller (disc determination unit) 52 outputs a drive signal to raise the high-NA objective lens 32 and the low-NA objective lens 33. The low-NA focus actuator 38 raises the low-NA objective lens 33 (moves the low-NA objective lens 33 toward the optical disc 1) based on the drive signal output from the disc determination controller (disc determination unit) 52. The high-NA focus actuator 37 raises the high-NA objective lens 32 (moves the high-NA objective lens 32 toward the optical disc 1) based on a drive signal that has been obtained by the drive difference addition unit 58′ adding a predetermined drive amount to the drive signal output from the disc determination controller (disc determination unit) 52.

At timing T61, the focal point of the infrared laser beam passes through a surface of the HD-DVD (surface of the optical disc 1 facing the objective lenses 32 and 33). When the beam passes through the surface, a focus error signal is obtained based on a signal output from the multiple-laser beam detector 261. More specifically, a focus error signal having a waveform indicated by W181 in FIG. 18 is output at around timing T61.

The optical disc apparatus uses the low-NA objective lens 33 that focuses the infrared laser beam at a more distant position than the red laser beam in the direction of the normal to the low-NA objective lens 33 (in the optical axis direction of the low-NA objective lens 33), and the drive offset value of the drive difference addition unit 58′ is set in a manner that the low-NA objective lens 33 focuses the red laser beam at a more distant position than the blue laser beam focused by the high-NA objective lens 32 in the directions of the normals to the objective lenses 32 and 33 (in the optical axis directions of the objective lenses 32 and 33). Thus, the focal point of the red laser beam passes through the surface of the HD-DVD (surface of the optical disc 1 facing the objective lenses 32 and 33) at timing T62. When the beam passes through the surface, a focus error signal is obtained based on a signal output from the multiple-laser beam detector 261. More specifically, a focus error signal having a waveform indicated by W182 in FIG. 18 is output at around timing T62.

At timing T63, the focal point of the blue laser beam passes through the surface of the HD-DVD (surface of the optical disc 1 facing the objective lenses 32 and 33). When the beam passes through the surface, a focus error signal is obtained based on a signal output from the blue-laser beam detector 25. More specifically, a focus error signal having a waveform indicated by W185 in FIG. 18 is output at around timing T63. The amplitude of this focus error signal does not exceed a predetermined level L8. Thus, the disc determination controller (disc determination unit) 52 continues the disc determination operation.

At timing T64, the focal point of the infrared laser beam passes through the information recording surface of the HD-DVD. When the beam passes through the surface, a focus error signal is obtained based on a signal output from the multiple-laser beam detector 261. More specifically, a focus error signal having a waveform indicated by W183 in FIG. 18 is output at around timing T64. The amplitude of this focus error signal does not exceed a predetermined level L7. Thus, the disc determination controller (disc determination unit) 52 continues the disc determination operation.

At timing T65, the focal point of the red laser beam passes through the information recording surface of the HD-DVD. When the beam passes through the surface, a focus error signal is obtained based on a signal output from the multiple-laser beam detector 261. More specifically, a focus error signal having a waveform indicated by W184 in FIG. 18 is output at around timing T65. The amplitude of this focus error signal does not exceed the predetermined level L7. Thus, the disc determination controller (disc determination unit) 52 continues the disc determination operation.

The disc determination controller (disc determination unit) 52 continues raising the high-NA objective lens 32 and the low-NA objective lens 33. Thus, the high-NA objective lens 32 or the low-NA objective lens 33 reaches its preset positional limit at timing T66. In this case, the disc determination controller (disc determination unit) 52 stops raising the high-NA objective lens 32 and the low-NA objective lens 33 (stops the operation for driving the lenses toward the optical disc 1), and lowers the high-NA objective lens 32 and the low-NA objective lens 33 (drives the lenses away from the optical disc 1). The disc determination controller (disc determination unit) 52 then moves the high-NA objective lens 32 and the low-NA objective lens 33 until the high-NA objective lens 32 and the low-NA objective lens 33 return to their positions corresponding to timing T60 in FIG. 18.

The disc determination controller (disc determination unit) 52 then turns off the red laser beam and the infrared laser beam with which the optical disc 1 has been illuminated, and outputs an optical path switch signal to switch off the optical path switch 39.

In other words, the disc determination controller (disc determination unit) 52 switches the illumination state when the objective lenses reach their positional limits from the state in which the optical disc 1 is being illuminated simultaneously with a blue laser beam through the high-NA objective lens 32 and a red laser beam and an infrared laser beam through the low-NA objective lens 33 to the state in which the optical disc 1 is being illuminated with a blue laser beam through the low-NA objective lens 33.

While the optical disc 1 is being illuminated with a blue laser beam through the low-NA objective lens 33, the disc determination controller (disc determination unit) 52 again raises the high-NA objective lens 32 and the low-NA objective lens 33 (drives the lenses toward the optical disc 1).

At timing T67, the focal point of the blue laser beam passes through the surface of the HD-DVD (surface of the optical disc 1 facing the objective lenses 32 and 33). When the beam passes through the surface, a focus error signal is obtained based on a signal output from the multiple-laser beam detector 261. More specifically, a focus error signal having a waveform indicated by W186 in FIG. 18 is output at around timing T67.

At timing T68, the focal point of the blue laser beam passes through an information recording surface of the HD-DVD. When the beam passes through the surface, a focus error signal is obtained based on a signal output from the multiple-laser beam detector 261. More specifically, a focus error signal having a waveform indicated by W187 in FIG. 18 is output at around timing T68. Here, the amplitude of this focus error signal exceeds a predetermined level L10. Thus, the disc determination controller (disc determination unit) 52 determines that the disc that has been mounted on the optical disc apparatus 400′ is an HD-DVD.

As described above, the optical disc apparatus 400′ promptly determines that the disc that has been mounted is an HD-DVD while reliably preventing information recorded on the DVD recording surface from being damaged by a blue laser beam.

### 5.2.2 Disc Determination Operation (BD)

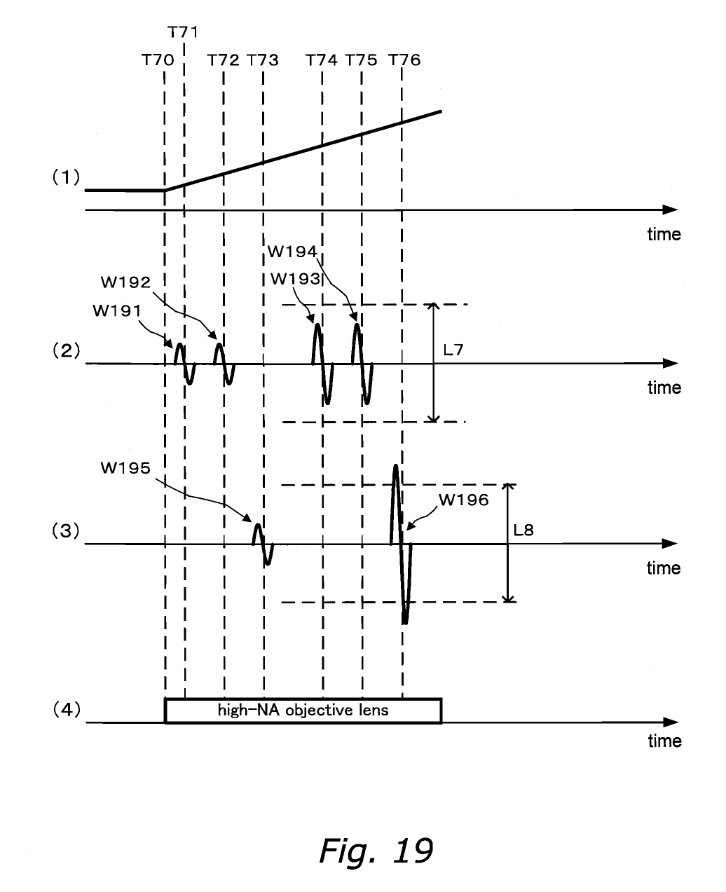

A disc determination operation using simultaneous illumination of a plurality of lasers for determining that a BD has been mounted on the optical disc apparatus 400′ will now be described in detail with reference to FIG. 19.

FIG. 19 shows the position of the high-NA objective lens 32 and the state of a focus error signal when the high-NA objective lens 32 and the low-NA objective lens 33 are driven while the BD is being illuminated simultaneously with a blue laser beam through the high-NA objective lens 32 and a red laser beam and an infrared laser beam through the low-NA objective lens 33.

In FIG. 19, line (1) shows the position of the high-NA objective lens 32 as a function of time, where the horizontal axis indicates time and the vertical axis indicates the high-NA objective lens position. More specifically, line (1) in FIG. 19 represents signals showing the position of the low-NA objective lens 33 when the high-NA objective lens 32 and the low-NA objective lens 33 are moved toward the BD while the BD is being illuminated simultaneously with a blue laser beam through the high-NA objective lens 32 and a red laser beam and an infrared laser beam through the low-NA objective lens 33.

In FIG. 19, line (2) shows the level of a focus error signal as a function of time, where the horizontal axis indicates time and the vertical axis indicates the focus error signal level. More specifically, line (2) in FIG. 19 represents focus error signals (corresponding to signals transmitted on the signal line P7 in FIG. 17), which are generated by the servo signal generation circuit (servo signal generation unit) 57′ based on the output of the multiple-laser beam detector 261 when the high-NA objective lens 32 and the low-NA objective lens 33 are moved toward the BD while the BD is being illuminated simultaneously with a blue laser beam through the high-NA objective lens 32 and a red laser beam and an infrared laser beam through the low-NA objective lens 33.

In FIG. 19, line (3) shows the level of a focus error signal as a function of time, where the horizontal axis indicates time and the vertical axis indicates the focus error signal level. More specifically, line (3) in FIG. 19 represents focus error signals (corresponding to signals transmitted on the signal line P6 in FIG. 17), which are generated by the servo signal generation circuit (servo signal generation unit) 57′ based on the output of the blue-laser beam detector 25 when the high-NA objective lens 32 and the low-NA objective lens 33 are moved toward the BD while the BD is being illuminated simultaneously with a blue laser beam through the high-NA objective lens 32 and a red laser beam and an infrared laser beam through the low-NA objective lens 33.

In FIG. 19, line (4) shows the level of an optical path switch signal as a function of time in the same manner as line (4) in FIG. 18. The level of the optical path switch signal as a function of time is the same as described above and will not be described.

At timing T70 to start disc determination, the disc determination controller (disc determination unit) 52 starts its disc determination operation. The subsequent operation up to raising the high-NA objective lens and the low-NA objective lens is the same as described in 5.2.1 above, and will not be described.

At timing T71, the focal point of the infrared laser beam passes through a surface of the BD (surface of the optical disc 1 facing the objective lenses 32 and 33). When the beam passes through the surface, a focus error signal is obtained based on a signal output from the infrared-laser beam detector 23. More specifically, a focus error signal having a waveform indicated by W191 in FIG. 19 is output at around timing T71.

The optical disc apparatus uses the low-NA objective lens 33 that focuses the infrared laser beam at a more distant position than the red laser beam in the direction of the normal to the low-NA objective lens 33 (in the optical axis direction of the low-NA objective lens 33), and the drive offset value of the drive difference addition unit 58′ is set in a manner that the low-NA objective lens 33 focuses the red laser beam at a more distant position than the blue laser beam focused by the high-NA objective lens 32 in the directions of the normals to the objective lenses 32 and 33 (in the optical axis directions of the objective lenses 32 and 33). Thus, the focal point of the red laser beam passes through the surface of the BD (surface of the optical disc 1 facing the objective lenses 32 and 33) at timing T72. When the beam passes through the surface, a focus error signal is obtained based on a signal output from the multiple-laser beam detector 261. More specifically, a focus error signal having a waveform indicated by W192 in FIG. 19 is output at around timing T72.

At timing T73, the focal point of the blue laser beam passes through the surface of the BD (surface of the optical disc 1 facing the objective lenses 32 and 33). When the beam passes through the surface, a focus error signal is obtained based on a signal output from the blue-laser beam detector 25. More specifically, a focus error signal having a waveform indicated by W195 in FIG. 19 is output at around timing T73. The amplitude of this focus error signal does not exceed a predetermined level L8. Thus, the disc determination controller (disc determination unit) 52 continues the disc determination operation.

At timing T74, the focal point of the infrared laser beam passes through the information recording surface of the BD. When the beam passes through the surface, a focus error signal is obtained based on a signal output from the multiple-laser beam detector 261. More specifically, a focus error signal having a waveform indicated by W193 in FIG. 19 is output at around timing T74. The amplitude of this focus error signal does not exceed a predetermined level L7. Thus, the disc determination controller (disc determination unit) 52 continues the disc determination operation.

At timing T75, the focal point of the red laser beam passes through the information recording surface of the BD. When the beam passes through the surface, a focus error signal is obtained based on a signal output from the multiple-laser beam detector 261. More specifically, a focus error signal having a waveform indicated by W194 in FIG. 19 is output at around timing T75. The amplitude of this focus error signal does not exceed the predetermined level L7. Thus, the disc determination controller (disc determination unit) 52 continues the disc determination operation.

At timing T76, the focal point of the blue laser beam passes through the information recording surface of the BD. When the beam passes through the surface, a focus error signal is obtained based on a signal output from the blue-laser beam detector 25. More specifically, a focus error signal having a waveform indicated by W196 in FIG. 19 is output at around timing T76. The amplitude of this focus error signal exceeds the predetermined level L8. Thus, the disc determination controller (disc determination unit) 52 determines that the disc that has been mounted on the optical disc apparatus 400′ is a BD.

As described above, the optical disc apparatus 400′ promptly determines that the disc that has been mounted is a BD while reliably preventing information recorded on the DVD recording surface from being damaged by a blue laser beam.

### Other Embodiments

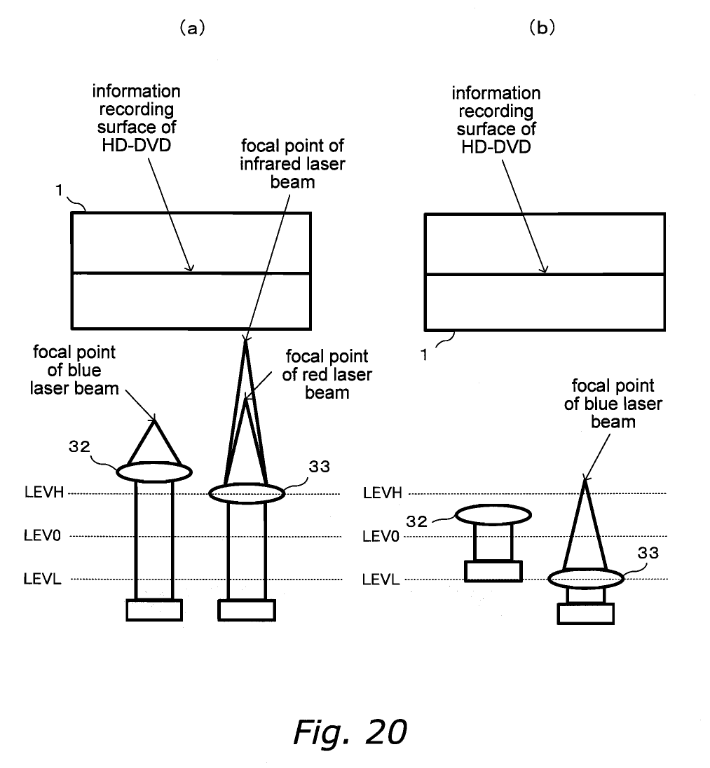

(1) The drive control of the low-NA objective lens 33 and the high-NA objective lens 32 in the fourth and fifth embodiments may be modified as shown in FIG. 20. The modified drive control of the low-NA objective lens 33 and the high-NA objective lens 32 will now be described with reference to FIG. 20.

The optical disc apparatus 400 (or the optical disc apparatus 400′) sets a default value of the low-NA objective lens 33 at position LEVO shown in FIG. 20(a) (as well as sets a default value of the high-NA objective lens 32 at a position deviating from position LEVO by a distance corresponding to an offset value). When the optical path switch 39 is on, the low-NA objective lens 33 and the high-NA objective lens 32 are moved so that the low-NA objective lens 33 will be at LEVH position in FIG. 20(a). In that state, the optical disc 1 starts being illuminated with laser beams by controlling driving of the low-NA objective lens 33 and the high-NA objective lens 32. When the optical path switch 39 is off, the high-NA objective lens 32, which is not driven, is moved to its default value position as shown in FIG. 20(b), and the low-NA objective lens 33, which is driven, is moved to LEVL position shown in FIG. 20(b). In that state, the optical disc 1 starts being illuminated by controlling driving of the low-NA objective lens 33.

When employing such driving control in the optical disc apparatus 400 (or the optical disc apparatus 400′), power consumption of the high-NA focus actuator 37 becomes lower in emitting a blue laser beam from the high-NA objective lens 32. As a result, the optical disc apparatus 400 (or the optical disc apparatus 400′) consumes less power.

Although the fourth and fifth embodiments describe the case in which the high-NA focus actuator 37 and the low-NA focus actuator 38 are arranged separately and the high-NA objective lens 32 and the low-NA objective lens 33 are controlled to be driven independently of each other, the high-NA objective lens 32 and the low-NA objective lens 33 may be fixed at positions different from each other by a distance corresponding to an offset value, and the high-NA objective lens 32 and the low-NA objective lens 33 may be controlled to be driven using a single actuator. In this case, the drive difference addition unit 58 (the drive difference addition unit 58′) can be eliminated.

(2) Although the above embodiments describe the case in which the optical disc apparatus determines the type of a disc that has been mounted on the optical disc apparatus by comparing the amplitude of a focus error signal with a predetermined level, the present invention should not be limited to this structure. For example, the disc determination operation may be performed using a signal that has been used to reproduce information on the disc instead of using a focus error signal.

The peak-to-peak value of a focus error signal may be compared with a predetermined level, or the amplitude of a focus error signal may be compared with a predetermined level.

Different types of discs (such as a CD, a DVD, a DVD-ROM, and a DVD-RAM) have different refractivity values. The predetermined level with which a focus error signal is to be compared may be changed depending on the refractivity of each different optical disc.

After obtaining a normalized focus error signal by normalizing a focus error signal by an AS (all sum) signal (a signal indicating a total amount of light output from the laser-beam detector) (for example a signal obtained by dividing a focus error signal value by an AS signal value), such a normalized focus error signal may be compared with a predetermined level. In this case, the optical disc apparatus will absorb differences between individual discs mounted on the optical disc apparatus and perform an appropriate detection operation.

(3) In the above embodiments, each block of the optical disc apparatus may be formed by a single chip with a semiconductor device technology, such as LSI (large-scale integration), or some or all of the blocks of the optical disc apparatus may be formed by a single chip.

Although the semiconductor device technology is referred to as LSI as above, the technology may be instead referred to as IC (integrated circuit), system LSI, super LSI, or ultra LSI depending on the degree of integration of the circuit.

The circuit integration technology employed should not be limited to LSI, but the circuit integration may be achieved using a dedicated circuit or a general-purpose processor. An FPGA (field programmable gate array), which is an LSI circuit programmable after manufactured, or a reconfigurable processor, which is an LSI circuit in which internal circuit cells are reconfigurable or more specifically the internal circuit cells can be reconnected or reset, may be used.

Further, if any circuit integration technology that can replace LSI emerges as an advancement of the semiconductor technology or as a derivative of the semiconductor technology, the technology may be used to integrate the functional blocks of the optical disc apparatus. Biotechnology is potentially applicable.

The processes described in the above embodiments may be realized using either hardware or software, or may be realized using both software and hardware.

The structures described in detail in the above embodiments are mere examples of the present invention, and may be changed and modified variously without departing from the scope and spirit of the invention.

### APPENDIXES

The present invention may also be expressed as follows.

### Appendix 14

An optical disc determination method used in an optical disc apparatus that includes a first laser beam source operable to emit a first laser beam, a second laser beam source operable to emit a second laser beam that has a shorter wavelength than the first laser beam, a laser beam mixing and separating unit operable to mix and separate the first laser beam and the second laser beam, and an objective lens operable to illuminate an optical disc simultaneously with the first laser beam and the second laser beam that have been mixed by the laser beam mixing and separating unit, the method comprising:

changing a distance between the objective lens and the optical disc by driving the objective lens toward and away from the optical disc;

detecting an intensity of the first laser beam that has been reflected from the optical disc;

detecting an intensity of the second laser beam that has been reflected from the optical disc,

generating a first laser beam detection signal corresponding to a result of detection performed in the first laser beam detection step and a second laser beam detection signal corresponding to a result of detection performed in the second laser beam detection step; and

determining a type of the optical disc based on the first laser beam detection signal and the second laser beam detection signal.

### Appendix 15

An optical disc determination method used in an optical disc apparatus that includes a first laser beam source operable to emit a first laser beam, a second laser beam source operable to emit a second laser beam that has a shorter wavelength than the first laser beam, a first laser beam objective lens operable to illuminate an optical disc with the first laser beam, and a second laser beam objective lens operable to illuminate the optical disc with the second laser beam, the method comprising:

changing a distance between the first laser beam objective lens and the optical disc by driving the first laser beam objective lens toward and away from the optical disc;

changing a distance between the second laser beam objective lens and the optical disc by driving the second laser beam objective lens toward and away from the optical disc;

detecting an intensity of the first laser beam that has been reflected from the optical disc;

detecting an intensity of the second laser beam that has been reflected from the optical disc;

generating a first laser beam detection signal corresponding to a result of detection performed in the first laser beam detection step and a second laser beam detection signal corresponding to a result of detection performed in the second laser beam detection step;

outputting a second laser beam objective lens drive control signal for driving the second laser beam objective lens and determining a type of the optical disc based on the first laser beam detection signal and the second laser beam detection signal; and

generating a first laser beam objective lens drive control signal for driving the first laser beam objective lens by adding an offset value to the second laser beam objective lens drive control signal,

wherein in the step of changing a distance between the first laser beam objective lens and the optical disc, the first laser beam objective lens is driven based on the first laser beam objective lens drive control signal, and in the step of changing a distance between the second laser beam objective lens and the optical disc, the second laser beam objective lens is driven based on the second laser beam objective lens drive control signal.

### Appendix 16

An optical disc determination method used in an optical disc apparatus that includes a first laser beam source operable to emit a first laser beam, a second laser beam source operable to emit a second laser beam that has a shorter wavelength than the first laser beam, a third laser beam source operable to emit a third laser beam that has a shorter wavelength than the second laser beam, a laser control unit operable to control driving of the first laser beam source, the second laser beam source, and the third laser beam source, a laser beam mixing and separating unit operable to mix and separate the first laser beam and the second laser beam, a low-NA objective lens operable to illuminate an optical disc simultaneously with the first laser beam and the second laser beam that have been mixed by the laser beam mixing and separating unit, a high-NA objective lens having a higher numerical aperture than the low-NA objective lens, and an optical path switch unit operable to set an optical path that directs the third laser beam to the high-NA objective lens when the optical path switch unit is on and set an optical path that directs the third laser beam to the low-NA objective lens when the optical path switch unit is off, the method comprising:

changing a distance between the low-NA objective lens and the optical disc by driving the low-NA objective lens toward and away from the optical disc;

changing a distance between the high-NA objective lens and the optical disc by driving the high-NA objective lens toward and away from the optical disc;

detecting an intensity of the first laser beam that has been reflected from the optical disc;

detecting an intensity of the second laser beam that has been reflected from the optical disc;

detecting an intensity of the third laser beam that has been reflected from the optical disc;

generating a first laser beam detection signal corresponding to a result of detection performed in the first laser beam detection step, a second laser beam detection signal corresponding to a result of detection performed in the second laser beam detection step, and a third laser beam detection signal corresponding to a result of detection performed in the third laser beam detection step;

outputting a high-NA objective lens drive control signal for driving the high-NA objective lens and determining a type of the optical disc based on the first laser beam detection signal, the second laser beam detection signal, and the third laser beam detection signal; and

generating a low-NA objective lens drive control signal for driving the low-NA objective lens by adding an offset value to the high-NA objective lens drive control signal,

wherein in the step of changing a distance between the low-NA objective lens and the optical disc, the low-NA objective lens is driven based on the low-NA objective lens drive control signal, and in the step of changing a distance between the high-NA objective lens and the optical disc, the high-NA objective lens is driven based on the high-NA objective lens drive control signal.

### Appendix 17

An optical disc determination method used in an optical disc apparatus that includes a first laser beam source operable to emit a first laser beam, a second laser beam source operable to emit a second laser beam that has a shorter wavelength than the first laser beam, a third laser beam source operable to emit a third laser beam that has a shorter wavelength than the second laser beam, a laser control unit operable to control driving of the first laser beam source, the second laser beam source, and the third laser beam source, a laser beam mixing and separating unit operable to mix and separate the first laser beam and the second laser beam, a low-NA objective lens operable to illuminate an optical disc simultaneously with the first laser beam and the second laser beam that have been mixed by the laser beam mixing and separating unit, a high-NA objective lens having a higher numerical aperture than the low-NA objective lens, and an optical path switch unit operable to set an optical path that directs the third laser beam to the high-NA objective lens when the optical path switch unit is on and set an optical path that directs the third laser beam to the low-NA objective lens when the optical path switch unit is off, the method comprising:

changing a distance between the low-NA objective lens and the optical disc by driving the low-NA objective lens toward and away from the optical disc;

changing a distance between the high-NA objective lens and the optical disc by driving the high-NA objective lens toward and away from the optical disc;

detecting an intensity of the first laser beam that has been reflected from the optical disc and an intensity of the second laser beam that has been reflected from the optical disc;

detecting an intensity of the third laser beam that has been reflected from the optical disc;

generating a multiple laser beam detection signal corresponding to a result of detection performed in the multiple laser beam detection step and generating a third laser beam detection signal corresponding to a result of detection performed in the third laser beam detection step;

outputting a low-NA objective lens drive control signal for driving the low-NA objective lens and determining a type of the optical disc based on the multiple laser beam detection signal and the third laser beam detection signal; and

generating a high-NA objective lens drive control signal for driving the high-NA objective lens by adding an offset value to the low-NA objective lens drive control signal,

wherein in the step of changing a distance between the low-NA objective lens and the optical disc, the low-NA objective lens is driven based on the low-NA objective lens drive control signal, and in the step of changing a distance between the high-NA objective lens and the optical disc, the high-NA objective lens is driven based on the high-NA objective lens drive control signal.

### Appendix 18

A computer-readable recording medium on which a program used in an optical disc apparatus is recorded, wherein the optical disc apparatus includes a first laser beam source operable to emit a first laser beam, a second laser beam source operable to emit a second laser beam that has a shorter wavelength than the first laser beam, a laser beam mixing and separating unit operable to mix and separate the first laser beam and the second laser beam, and an objective lens operable to illuminate an optical disc simultaneously with the first laser beam and the second laser beam that have been mixed by the laser beam mixing and separating unit, the program enabling a computer to function as:

an objective lens driving unit operable to change a distance between the objective lens and the optical disc by driving the objective lens toward and away from the optical disc;

a first laser beam detection unit operable to detect an intensity of the first laser beam that has been reflected from the optical disc;

a second laser beam detection unit operable to detect an intensity of the second laser beam that has been reflected from the optical disc;

a servo signal generation unit operable to generate a first laser beam detection signal corresponding to a result of detection of the first laser beam detection unit and a second laser beam detection signal corresponding to a result of detection of the second laser beam detection unit; and

a disc determination unit operable to determine a type of the optical disc based on the first laser beam detection signal and the second laser beam detection signal.

### Appendix 19

A computer-readable recording medium on which a program used in an optical disc apparatus is recorded, wherein the optical disc apparatus includes a first laser beam source operable to emit a first laser beam, a second laser beam source operable to emit a second laser beam that has a shorter wavelength than the first laser beam, a first laser beam objective lens operable to illuminate an optical disc with the first laser beam, and a second laser beam objective lens operable to illuminate the optical disc with the second laser beam, the program enabling a computer to function as:

a first laser beam objective lens drive unit operable to change a distance between the first laser beam objective lens and the optical disc by driving the first laser beam objective lens toward and away from the optical disc;

a second laser beam objective lens drive unit operable to change a distance between the second laser beam objective lens and the optical disc by driving the second laser beam objective lens toward and away from the optical disc;

a first laser beam detection unit operable to detect an intensity of the first laser beam that has been reflected from the optical disc;

a second laser beam detection unit operable to detect an intensity of the second laser beam that has been reflected from the optical disc;

a servo signal generation unit operable to generate a first laser beam detection signal corresponding to a result of detection of the first laser beam detection unit and a second laser beam detection signal corresponding to a result of detection of the second laser beam detection unit;

a disc determination unit operable to output a second laser beam objective lens drive control signal for driving the second laser beam objective lens and determine a type of the optical disc based on the first laser beam detection signal and the second laser beam detection signal; and

a drive difference addition unit operable to generate a first laser beam objective lens drive control signal for driving the first laser beam objective lens by adding an offset value to the second laser beam objective lens drive control signal,

wherein the first laser beam objective lens drive unit drives the first laser beam objective lens based on the first laser beam objective lens drive control signal, and the second laser beam objective lens drive unit drives the second laser beam objective lens based on the second laser beam objective lens drive control signal.

### Appendix 20

A computer-readable recording medium on which a program used in an optical disc apparatus is recorded, wherein the optical disc apparatus includes a first laser beam source operable to emit a first laser beam, a second laser beam source operable to emit a second laser beam that has a shorter wavelength than the first laser beam, a third laser beam source operable to emit a third laser beam that has a shorter wavelength than the second laser beam, a laser control unit operable to control driving of the first laser beam source, the second laser beam source, and the third laser beam source, a laser beam mixing and separating unit operable to mix and separate the first laser beam and the second laser beam, a low-NA objective lens operable to illuminate an optical disc simultaneously with the first laser beam and the second laser beam that have been mixed by the laser beam mixing and separating unit, a high-NA objective lens having a higher numerical aperture than the low-NA objective lens, and an optical path switch unit operable to set an optical path that directs the third laser beam to the high-NA objective lens when the optical path switch unit is on and set an optical path that directs the third laser beam to the low-NA objective lens when the optical path switch unit is off, the program enabling a computer to function as:

a low-NA objective lens drive unit operable to change a distance between the low-NA objective lens and the optical disc by driving the low-NA objective lens toward and away from the optical disc;

a high-NA objective lens drive unit operable to change a distance between the high-NA objective lens and the optical disc by driving the high-NA objective lens toward and away from the optical disc;

a first laser beam detection unit operable to detect an intensity of the first laser beam that has been reflected from the optical disc;

a second laser beam detection unit operable to detect an intensity of the second laser beam that has been reflected from the optical disc;

a third laser beam detection unit operable to detect an intensity of the third laser beam that has been reflected from the optical disc;

a servo signal generation unit operable to detect a first laser beam detection signal corresponding to a result of detection of the first laser beam detection unit, a second laser beam detection signal corresponding to a result of detection of the second laser beam detection unit, and a third laser beam detection signal corresponding to a result of detection of the third laser beam detection unit;

a disc determination unit operable to output a high-NA objective lens drive control signal for driving the high-NA objective lens and determine a type of the optical disc based on the first laser beam detection signal, the second laser beam detection signal, and the third laser beam detection signal; and

a drive difference addition unit operable to generate a low-NA objective lens drive control signal for driving the low-NA objective lens by adding an offset value to the high-NA objective lens drive control signal,

wherein the low-NA objective lens drive unit drives the low-NA objective lens based on the low-NA objective lens drive control signal, and the high-NA objective lens drive unit drives the high-NA objective lens based on the high-NA objective lens drive control signal.

### Appendix 21

A computer-readable recording medium on which a program used in an optical disc apparatus is recorded, wherein the optical disc apparatus includes a first laser beam source operable to emit a first laser beam, a second laser beam source operable to emit a second laser beam that has a shorter wavelength than the first laser beam, a third laser beam source operable to emit a third laser beam that has a shorter wavelength than the second laser beam, a laser control unit operable to control driving of the first laser beam source, the second laser beam source, and the third laser beam source, a laser beam mixing and separating unit operable to mix and separate the first laser beam and the second laser beam, a low-NA objective lens operable to illuminate an optical disc simultaneously with the first laser beam and the second laser beam that have been mixed by the laser beam mixing and separating unit, a high-NA objective lens having a higher numerical aperture than the low-NA objective lens, and an optical path switch unit operable to set an optical path that directs the third laser beam to the high-NA objective lens when the optical path switch unit is on and set an optical path that directs the third laser beam to the low-NA objective lens when the optical path switch unit is off, the program enabling a computer to function as:

a low-NA objective lens drive unit operable to change a distance between the low-NA objective lens and the optical disc by driving the low-NA objective lens toward and away from the optical disc;

a high-NA objective lens drive unit operable to change a distance between the high-NA objective lens and the optical disc by driving the high-NA objective lens toward and away from the optical disc;

a multiple laser beam detection unit operable to detect an intensity of the first laser beam that has been reflected from the optical disc and an intensity of the second laser beam that has been reflected from the optical disc;

a third laser beam detection unit operable to detect an intensity of the third laser beam that has been reflected from the optical disc;

a servo signal generation unit operable to generate a multiple laser beam detection signal corresponding to a result of detection of the multiple laser beam detection unit and generate a third laser beam detection signal corresponding to a result of detection of the third laser beam detection unit;

a disc determination unit operable to output a low-NA objective lens drive control signal for driving the low-NA objective lens and determine a type of the optical disc based on the multiple laser beam detection signal and the third laser beam detection signal; and

a drive difference addition unit operable to generate a high-NA objective lens drive control signal for driving the high-NA objective lens by adding an offset value to the low-NA objective lens drive control signal,

wherein the low-NA objective lens drive unit drives the low-NA objective lens based on the low-NA objective lens drive control signal, and the high-NA objective lens drive unit drives the high-NA objective lens based on the high-NA objective lens drive control signal.

### Appendix 22

An integrated circuit used in an optical disc apparatus that includes a first laser beam source operable to emit a first laser beam, a second laser beam source operable to emit a second laser beam that has a shorter wavelength than the first laser beam, a laser beam mixing and separating unit operable to mix and separate the first laser beam and the second laser beam, an objective lens operable to illuminate an optical disc simultaneously with the first laser beam and the second laser beam that have been mixed by the laser beam mixing and separating unit, an objective lens driving unit operable to change a distance between the objective lens and the optical disc by driving the objective lens toward and away from the optical disc, a first laser beam detection unit operable to detect an intensity of the first laser beam that has been reflected from the optical disc, and a second laser beam detection unit operable to detect an intensity of the second laser beam that has been reflected from the optical disc, the integrated circuit comprising:

a servo signal generation unit operable to generate a first laser beam detection signal corresponding to a result of detection of the first laser beam detection unit and a second laser beam detection signal corresponding to a result of detection of the second laser beam detection unit; and

a disc determination unit operable to determine a type of the optical disc based on the first laser beam detection signal and the second laser beam detection signal.

### Appendix 23

An integrated circuit used in an optical disc apparatus that includes a first laser beam source operable to emit a first laser beam, a second laser beam source operable to emit a second laser beam that has a shorter wavelength than the first laser beam, a first laser beam objective lens operable to illuminate an optical disc with the first laser beam, a second laser beam objective lens operable to illuminate the optical disc with the second laser beam, a first laser beam objective lens drive unit operable to change a distance between the first laser beam objective lens and the optical disc by driving the first laser beam objective lens toward and away from the optical disc, a second laser beam objective lens drive unit operable to change a distance between the second laser beam objective lens and the optical disc by driving the second laser beam objective lens toward and away from the optical disc, a first laser beam detection unit operable to detect an intensity of the first laser beam that has been reflected from the optical disc, and a second laser beam detection unit operable to detect an intensity of the second laser beam that has been reflected from the optical disc, the integrated circuit comprising:

a servo signal generation unit operable to generate a first laser beam detection signal corresponding to a result of detection of the first laser beam detection unit and a second laser beam detection signal corresponding to a result of detection of the second laser beam detection unit;

a disc determination unit operable to output a second laser beam objective lens drive control signal for driving the second laser beam objective lens and determine a type of the optical disc based on the first laser beam detection signal and the second laser beam detection signal; and

a drive difference addition unit operable to generate a first laser beam objective lens drive control signal for driving the first laser beam objective lens by adding an offset value to the second laser beam objective lens drive control signal,

wherein the first laser beam objective lens drive unit drives the first laser beam objective lens based on the first laser beam objective lens drive control signal, and the second laser beam objective lens drive unit drives the second laser beam objective lens based on the second laser beam objective lens drive control signal.

### Appendix 24

An integrated circuit used in an optical disc apparatus that includes a first laser beam source operable to emit a first laser beam, a second laser beam source operable to emit a second laser beam that has a shorter wavelength than the first laser beam, a third laser beam source operable to emit a third laser beam that has a shorter wavelength than the second laser beam, a laser control unit operable to control driving of the first laser beam source, the second laser beam source, and the third laser beam source, a laser beam mixing and separating unit operable to mix and separate the first laser beam and the second laser beam, a low-NA objective lens operable to illuminate an optical disc simultaneously with the first laser beam and the second laser beam that have been mixed by the laser beam mixing and separating unit, a high-NA objective lens having a higher numerical aperture than the low-NA objective lens, an optical path switch unit operable to set an optical path that directs the third laser beam to the high-NA objective lens when the optical path switch unit is on and set an optical path that directs the third laser beam to the low-NA objective lens when the optical path switch unit is off, a low-NA objective lens drive unit operable to change a distance between the low-NA objective lens and the optical disc by driving the low-NA objective lens toward and away from the optical disc, a high-NA objective lens drive unit operable to change a distance between the high-NA objective lens and the optical disc by driving the high-NA objective lens toward and away from the optical disc, a first laser beam detection unit operable to detect an intensity of the first laser beam that has been reflected from the optical disc, a second laser beam detection unit operable to detect an intensity of the second laser beam that has been reflected from the optical disc, and a third laser beam detection unit operable to detect an intensity of the third laser beam that has been reflected from the optical disc, the integrated circuit comprising:

a servo signal generation unit operable to detect a first laser beam detection signal corresponding to a result of detection of the first laser beam detection unit;

a disc determination unit operable to output a high-NA objective lens drive control signal for driving the high-NA objective lens and determine a type of the optical disc based on the first laser beam detection signal, the second laser beam detection signal, and the third laser beam detection signal; and

a drive difference addition unit operable to generate a low-NA objective lens drive control signal for driving the low-NA objective lens by adding an offset value to the high-NA objective lens drive control signal,

wherein the low-NA objective lens drive unit drives the low-NA objective lens based on the low-NA objective lens drive control signal, and the high-NA objective lens drive unit drives the high-NA objective lens based on the high-NA objective lens drive control signal.

### Appendix 25

An integrated circuit used in an optical disc apparatus that includes a first laser beam source operable to emit a first laser beam, a second laser beam source operable to emit a second laser beam that has a shorter wavelength than the first laser beam, a third laser beam source operable to emit a third laser beam that has a shorter wavelength than the second laser beam, a laser control unit operable to control driving of the first laser beam source, the second laser beam source, and the third laser beam source, a laser beam mixing and separating unit operable to mix and separate the first laser beam and the second laser beam, a low-NA objective lens operable to illuminate an optical disc simultaneously with the first laser beam and the second laser beam that have been mixed by the laser beam mixing and separating unit, a high-NA objective lens having a higher numerical aperture than the low-NA objective lens, and an optical path switch unit operable to set an optical path that directs the third laser beam to the high-NA objective lens when the optical path switch unit is on and set an optical path that directs the third laser beam to the low-NA objective lens when the optical path switch unit is off, a low-NA objective lens drive unit operable to change a distance between the low-NA objective lens and the optical disc by driving the low-NA objective lens toward and away from the optical disc, a high-NA objective lens drive unit operable to change a distance between the high-NA objective lens and the optical disc by driving the high-NA objective lens toward and away from the optical disc, a multiple laser beam detection unit operable to detect an intensity of the first laser beam that has been reflected from the optical disc and an intensity of the second laser beam that has been reflected from the optical disc, and a third laser beam detection unit operable to detect an intensity of the third laser beam that has been reflected from the optical disc, the integrated circuit comprising:

a servo signal generation unit operable to generate a multiple laser beam detection signal corresponding to a result of detection of the multiple laser beam detection unit and generate a third laser beam detection signal corresponding to a result of detection of the third laser beam detection unit;

a disc determination unit operable to output a low-NA objective lens drive control signal for driving the low-NA objective lens and determine a type of the optical disc based on the multiple laser beam detection signal and the third laser beam detection signal; and

a drive difference addition unit operable to generate a high-NA objective lens drive control signal for driving the high-NA objective lens by adding an offset value to the low-NA objective lens drive control signal,

wherein the low-NA objective lens drive unit drives the low-NA objective lens based on the low-NA objective lens drive control signal, and the high-NA objective lens drive unit drives the high-NA objective lens based on the high-NA objective lens drive control signal.

The optical disc apparatus, the optical disc determination method, the program, and the integrated circuit of the present invention enable determination as to which one of a plurality of discs with different specifications has been mounted on the optical disc apparatus in a short time as well as in a safe manner without damaging information recorded on the disc, and therefore are useful in the optical disc-related industry. The optical disc apparatus, the optical disc determination method, the program, and the integrated circuit of the present invention are applicable to the optical disc-related industry.

What is claimed is:

1. An optical disc apparatus, comprising:
a first laser beam source operable to emit a first laser beam;
a second laser beam source operable to emit a second laser beam that has a shorter wavelength than the first laser beam;
a laser beam mixing and separating unit operable to mix and separate the first laser beam and the second laser beam;
an objective lens operable to illuminate an optical disc simultaneously with the first laser beam and the second laser beam that have been mixed by the laser beam mixing and separating unit;
an objective lens driving unit operable to change a distance between the objective lens and the optical disc by driving the objective lens toward and away from the optical disc;
a first laser beam detection unit operable to detect an intensity of the first laser beam that has been reflected from the optical disc;
a second laser beam detection unit operable to detect an intensity of the second laser beam that has been reflected from the optical disc;
a servo signal generation unit operable to generate a first laser beam detection signal corresponding to a result of detection of the first laser beam detection unit and a second laser beam detection signal corresponding to a result of detection of the second laser beam detection unit; and
a disc determination unit operable to determine a type of the optical disc based on the first laser beam detection signal and the second laser beam detection signal.

2. The optical disc apparatus according to claim 1, wherein the objective lens focuses the first laser beam and the second laser beam in a manner that a focal length of the first laser beam is longer than a focal length of the second laser beam, and the objective lens is arranged at an initial position at which a distance between the objective lens and a surface of the optical disc facing the objective lens is longer than the focal length of the first laser beam in an initial state of an operation for determining the type of the optical disc,
the objective lens drive unit drives the objective lens from the initial position in a direction in which the distance between the objective lens and the optical disc decreases, and
the disc determination unit determines the type of the optical disc by comparing a signal level of the first laser beam detection signal and a signal level of the second laser beam detection signal with a predetermined threshold while the objective lens is being driven by the objective lens drive unit from the initial position in the direction in which the distance between the objective lens and the optical disc decreases.

3. An optical disc apparatus, comprising:
a first laser beam source operable to emit a first laser beam;
a second laser beam source operable to emit a second laser beam that has a shorter wavelength than the first laser beam;
a first laser beam objective lens operable to illuminate an optical disc with the first laser beam;
a second laser beam objective lens operable to illuminate the optical disc with the second laser beam;
a first laser beam objective lens drive unit operable to change a distance between the first laser beam objective lens and the optical disc by driving the first laser beam objective lens toward and away from the optical disc;
a second laser beam objective lens drive unit operable to change a distance between the second laser beam objective lens and the optical disc by driving the second laser beam objective lens toward and away from the optical disc;
a first laser beam detection unit operable to detect an intensity of the first laser beam that has been reflected from the optical disc;
a second laser beam detection unit operable to detect an intensity of the second laser beam that has been reflected from the optical disc;
a servo signal generation unit operable to generate a first laser beam detection signal corresponding to a result of detection of the first laser beam detection unit and a second laser beam detection signal corresponding to a result of detection of the second laser beam detection unit;
a disc determination unit operable to output a second laser beam objective lens drive control signal for driving the second laser beam objective lens and determine a type of the optical disc based on the first laser beam detection signal and the second laser beam detection signal; and
a drive difference addition unit operable to generate a first laser beam objective lens drive control signal for driving the first laser beam objective lens by adding an offset value to the second laser beam objective lens drive control signal,
wherein the first laser beam objective lens drive unit drives the first laser beam objective lens based on the first laser beam objective lens drive control signal, and
the second laser beam objective lens drive unit drives the second laser beam objective lens based on the second laser beam objective lens drive control signal.

4. The optical disc apparatus according to claim 3, wherein the first laser beam objective lens is arranged at an initial position of the first laser beam objective lens at which a distance between the first laser beam objective lens and a surface of the optical disc facing the first laser beam objective lens is longer than a focal length with which the first laser beam objective lens focuses the first laser beam in an initial state of an operation for determining the type of the optical disc,
the first laser beam objective lens drive unit drives the first laser beam objective lens from the initial position of the first laser beam objective lens in a direction in which the distance between the first laser beam objective lens and the optical disc decreases,
the second laser beam objective lens drive unit drives the second laser beam objective lens from an initial position of the second laser beam objective lens in a direction in which the distance between the second laser beam objective lens and the optical disc decreases at a speed that is identical to a speed at which the first laser beam objective lens drive unit drives the first laser beam objective lens, and the initial position of the second laser beam objective lens is a position of the second laser beam objective lens when the first laser beam objective lens is at the initial position of the first laser beam objective position, and
the disc determination unit determines the type of the optical disc by comparing a signal level of the first laser beam detection signal and a signal level of the second laser beam detection signal with a predetermined threshold while the first laser beam objective lens and the second laser beam objective lens are being driven by the first laser beam objective lens drive unit and the second laser beam objective lens drive unit from the initial position of the first objective laser beam objective lens and the initial position of the second laser beam objective lens in a direction in which the distance between the first laser beam objective lens and the optical disc and the distance between the second laser beam objective lens and the optical disc decrease.

5. An optical disc apparatus, comprising:
a first laser beam source operable to emit a first laser beam;
a second laser beam source operable to emit a second laser beam that has a shorter wavelength than the first laser beam;
a third laser beam source operable to emit a third laser beam that has a shorter wavelength than the second laser beam;
a laser control unit operable to control driving of the first laser beam source, the second laser beam source, and the third laser beam source;
a laser beam mixing and separating unit operable to mix and separate the first laser beam and the second laser beam;
a low-NA objective lens operable to illuminate an optical disc simultaneously with the first laser beam and the second laser beam that have been mixed by the laser beam mixing and separating unit;
a high-NA objective lens that has a higher numerical aperture than the low-NA objective lens;
an optical path switch unit operable to set an optical path that directs the third laser beam to the high-NA objective lens when the optical path switch unit is on, and set an optical path that directs the third laser beam to the low-NA objective lens when the optical path switch unit is off;
a low-NA objective lens drive unit operable to change a distance between the low-NA objective lens and the optical disc by driving the low-NA objective lens toward and away from the optical disc;
a high-NA objective lens drive unit operable to change a distance between the high-NA objective lens and the optical disc by driving the high-NA objective lens toward and away from the optical disc;
a first laser beam detection unit operable to detect an intensity of the first laser beam that has been reflected from the optical disc;
a second laser beam detection unit operable to detect an intensity of the second laser beam that has been reflected from the optical disc;
a third laser beam detection unit operable to detect an intensity of the third laser beam that has been reflected from the optical disc;
a servo signal generation unit operable to generate a first laser beam detection signal corresponding to a result of detection of the first laser beam detection unit, a second laser beam detection signal corresponding to a result of detection of the second laser beam detection unit, and a third laser beam detection signal corresponding to a result of detection of the third laser beam detection unit;
a disc determination unit operable to output a high-NA objective lens drive control signal for driving the high-NA objective lens and determine a type of the optical disc based on the first laser beam detection signal, the second laser beam detection signal, and the third laser beam detection signal; and
a drive difference addition unit operable to generate a low-NA objective lens drive control signal for driving the low-NA objective lens by adding an offset value to the high-NA objective lens drive control signal,
wherein the high-NA objective lens illuminates the optical disc with the third laser beam when the optical path switch unit is on,
the low-NA objective lens drive unit drives the low-NA objective lens based on the low-NA objective lens drive control signal, and
the high-NA objective lens drive unit drives the high-NA objective lens based on the high-NA objective lens drive control signal.

6. The optical disc apparatus according to claim 5, wherein the low-NA objective lens is arranged at an initial position of the low-NA objective lens at which a distance between the low-NA objective lens and a surface of the optical disc facing the low-NA objective lens is longer than a focal length with which the low-NA objective lens focuses the first laser beam in an initial state of an operation for determining the type of the optical disc,
the low-NA objective lens drive unit drives the low-NA objective lens from the initial position of the low-NA objective lens in a direction in which the distance between the low-NA objective lens and the optical disc decreases,
the high-NA objective lens drive unit drives the high-NA objective lens from an initial position of the high-NA objective lens in a direction in which the distance between the high-NA objective lens and the optical disc decreases at a speed that is identical to a speed at which the low-NA objective lens drive unit drives the low-NA objective lens, and the initial position of the high-NA objective lens is a position of the high-NA objective lens when the low-NA objective lens is at the initial position of the low-NA objective lens, and
the disc determination unit determines the type of the optical disc by comparing a signal level of the first laser beam detection signal, a signal level of the second laser beam detection signal, and a signal level of the third laser beam detection signal with a predetermined threshold while the low-NA objective lens and the high-NA objective lens are being driven by the low-NA objective lens drive unit and the high-NA objective lens drive unit from the initial position of the low-NA objective lens and the initial position of the high-NA objective lens in a direction in which the distance between the low-NA objective lens and the optical disc and the distance between the high-NA objective lens and the optical disc decrease.

7. The optical disc apparatus according to claim 5, wherein the drive control unit controls driving in a first stage in a manner that the first laser beam is emitted from the first laser beam source, the second laser beam is emitted from the second laser beam source, and
the third laser beam is emitted from the third laser beam source, and controls driving in a second stage in a manner that only the third laser beam is emitted from the third laser beam source,
the optical path switch unit is on in the first stage and is off in the second stage,
the high-NA objective lens drive unit drives the high-NA objective lens from the initial position of the high-NA objective lens in the direction in which the distance between the high-NA objective lens and the optical disc decreases in the first stage, and does not drive the high-NA objective lens in the second stage,
the low-NA objective lens drive unit drives the low-NA objective lens from the initial position of the low-NA objective lens in the direction in which the distance between the low-NA objective lens and the optical disc decreases in the first stage at the speed that is identical to the speed at which the high-NA objective lens drive unit drives the high-NA objective lens, and drives the low-NA objective lens from the initial position of the low-NA objective lens in the direction in which the distance between the low-NA objective lens and the optical disc decreases in the second stage, and
the disc determination unit determines the type of the optical disc based on the first laser beam detection signal, the second laser beam detection signal, and the third laser beam detection signal in the first stage, and determines the type of the optical disc based on the third laser beam detection signal in the second stage.

8. The optical disc apparatus according to claim 7, wherein the disc determination unit determines the type of the optical disc by comparing a signal level of the first laser beam detection signal, a signal level of the second laser beam detection signal, and a signal level of the third laser beam detection signal with a predetermined threshold while the low-NA objective lens and the high-NA objective lens are being driven by the low-NA objective lens drive unit and the high-NA objective lens drive unit from the initial position of the low-NA objective lens and the initial position of the high-NA objective lens in the direction in which the distance between the low-NA objective lens and the optical disc and the distance between the high-NA objective lens and the optical disc decrease in the first stage, and
the disc determination unit determines the type of the optical disc by comparing the signal level of the third laser beam detection signal with the predetermined threshold while the low-NA objective lens is being driven by the low-NA objective lens drive unit from the initial position of the low-NA objective lens in the direction in which the distance between the low-NA objective lens and the optical disc decreases in the second stage.

9. An optical disc apparatus, comprising:
a first laser beam source operable to emit a first laser beam;
a second laser beam source operable to emit a second laser beam that has a shorter wavelength than the first laser beam;
a third laser beam source operable to emit a third laser beam that has a shorter wavelength than the second laser beam;
a laser control unit operable to control driving of the first laser beam source, the second laser beam source, and the third laser beam source;
a laser beam mixing and separating unit operable to mix and separate the first laser beam and the second laser beam;
an optical path switch unit operable to set an optical path that directs the third laser beam to the high-NA objective lens when the optical path switch unit is on, and set an optical path that directs the third laser beam to the low-NA objective lens when the optical path switch unit is off;
a low-NA objective lens operable to illuminate an optical disc simultaneously with the first laser beam and the second laser beam that have been mixed by the laser beam mixing and separating unit;
a high-NA objective lens that has a higher numerical aperture than the low-NA objective lens, and operable to illuminate the optical disc with the third laser beam when the optical path switch unit is on;
a low-NA objective lens drive unit operable to change a distance between the low-NA objective lens and the optical disc by driving the low-NA objective lens toward and away from the optical disc;
a high-NA objective lens drive unit operable to change a distance between the high-NA objective lens and the optical disc by driving the high-NA objective lens toward and away from the optical disc;
a multiple laser beam detection unit operable to detect an intensity of the first laser beam that has been reflected from the optical disc and an intensity of the second laser beam that has been reflected from the optical disc;
a third laser beam detection unit operable to detect an intensity of the third laser beam that has been reflected from the optical disc;
a servo signal generation unit operable to generate a multiple laser beam detection signal corresponding to a result of detection of the multiple laser beam detection unit and generate a third laser beam detection signal corresponding to a result of detection of the third laser beam detection unit;
a disc determination unit operable to output a low-NA objective lens drive control signal for driving the low-NA objective lens and determine a type of the optical disc based on the multiple laser beam detection signal and the third laser beam detection signal; and
a drive difference addition unit operable to generate a high-NA objective lens drive control signal for driving the high-NA objective lens by adding an offset value to the low-NA objective lens drive control signal,
wherein the low-NA objective lens drive unit drives the low-NA objective lens based on the low-NA objective lens drive control signal, and
the high-NA objective lens drive unit drives the high-NA objective lens based on the high-NA objective lens drive control signal.

10. The optical disc apparatus according to claim 9, wherein the low-NA objective lens is arranged at an initial position of the low-NA objective lens at which a distance between the low-NA objective lens and a first disc surface of the optical disc facing the low-NA objective lens is longer than a focal length with which the low-NA objective lens focuses the first laser beam in an initial state of an operation for determining the type of the optical disc, and the initial position of the low-NA objective lens is a position distant from the first disc surface by a distance LEN0 in a direction of the low-NA objective lens,
the high-NA objective lens is at an initial position of the high-NA objective lens that is a position distant from the first disc surface by a value obtained by subtracting the offset value Offset from the distance LEN0, where Offset>0, in the initial state of the operation for determining the type of the optical disc,
the low-NA objective lens drive unit drives the low-NA objective lens from the initial position of the low-NA objective lens in a direction in which the distance between the low-NA objective lens and the optical disc decreases,
the high-NA objective lens drive unit drives the high-NA objective lens from the initial position of the high-NA objective lens in a direction in which the distance between the high-NA objective lens and the optical disc decreases at a speed that is identical to a speed at which the low-NA objective lens drive unit drives the low-NA objective lens, and
the disc determination unit determines the type of the optical disc by comparing a signal level of the multiple laser beam detection signal and a signal level of the third laser beam detection signal with a predetermined threshold while the low-NA objective lens and the high-NA objective lens are being driven by the low-NA objective lens drive unit and the high-NA objective lens drive unit from the initial position of the low-NA objective lens and the initial position of the high-NA objective lens in a direction in which the distance between the low-NA objective lens and the optical disc and the distance between the high-NA objective lens and the optical disc decrease.

11. The optical disc apparatus according to claim 10, wherein the high-NA objective lens is arranged in the initial state at the initial position of the high-NA objective lens that is a position distant from the first disc surface by a value obtained by subtracting the offset value Offset from the distance LEN0, where Offset>0, and the offset value Offset is determined to satisfy
LEN1>LEN2>LEN3,
where LEN1 is a distance between a focal point position of the first laser beam that is focused by the low-NA objective lens and the first disc surface, LEN2 is a distance between a focal point position of the second laser beam that is focused by the low-NA objective lens and the first disc surface, and LEN3 is a distance between a focal point position of the third laser beam that is focused by the high-NA objective lens and the first disc surface.

12. The optical disc apparatus according to claim 9, wherein the drive control unit controls driving in a first stage in a manner that the first laser beam is emitted from the first laser beam source, the second laser beam is emitted from the second laser beam source, and the third laser beam is emitted from the third laser beam source, and controls driving in a second stage in a manner that only the third laser beam is emitted from the third laser beam source,
the optical path switch unit is on in the first stage and is off in the second stage,
the low-NA objective lens drive unit drives the low-NA objective lens from the initial position of the low-NA objective lens in the direction in which the distance between the low-NA objective lens and the optical disc decreases in the first stage, and drives the low-NA objective lens from the initial position of the low-NA objective lens in the direction in which the distance between the low-NA objective lens and the optical disc decreases in the second stage,
the high-NA objective lens drive unit drives the high-NA objective lens from the initial position of the high-NA objective lens in the direction in which the distance between the high-NA objective lens and the optical disc decreases at a speed that is identical to a speed at which the low-NA objective lens drive unit drives the low-NA objective lens in the first stage, and does not drive the high-NA objective lens in the second stage, and
the disc determination unit determines the type of the optical disc based on the multiple laser beam detection signal and the third laser beam detection signal in the first stage, and determines the type of the optical disc based on the third laser beam detection signal in the second stage.

13. The optical disc apparatus according to claim 12, wherein the disc determination unit determines the type of the optical disc by comparing the signal level of the multiple laser beam detection signal and the signal level of the third laser beam detection signal with the predetermined threshold while the low-NA objective lens and the high-NA objective lens are being driven by the low-NA objective lens drive unit and the high-NA objective lens drive unit from the initial position of the low-NA objective lens and the initial position of the high-NA objective lens in the direction in which the distance between the low-NA objective lens and the optical disc and the distance between the high-NA objective lens and the optical disc decrease in the first stage, and
the disc determination unit determines the type of the optical disc by comparing the signal level of the multiple laser beam detection signal with the predetermined threshold while the low-NA objective lens is being driven by the low-NA objective lens drive unit from the initial position of the low-NA objective lens in the direction in which the distance between the low-NA objective lens and the optical disc decreases in the second stage.
